(19) United States
(12) Patent Application Publication
(10) Pub. No.: US 2002/0194322 A1
(43) Pub. Date: Dec. 19, 2002

(54) Information distribution device, information distribution system, system, medium, information aggregate, and program

(76) Inventors: Shinichiro Nagata, Hyogo (JP); Shinji Wakura, Nara (JP); Wataru Michizeki, Nara (JP)

Correspondence Address: Allan Ratner, Ratner & Prestia, One Westlakes Berwyn Suite 301, PO Box 980, Valley Forge, PA, 19482-0980, US

(21) Appl. No.: 10/070,894

(22) PCT Filed: Jul. 6, 2001
(86) PCT No.: PCT/JP01/05871

(30) Foreign Application Priority Data
Jul. 10, 2000 (JP) 2000-209111
Nov. 7, 2000 (JP) 2000-339741
Jun. 7, 2001 (JP) 2001-173277

(51) Int. Cl. G06F 15/173

(52) U.S. Cl. 709/223

(57) ABSTRACT

Finding the URL of a Web page providing desired information is laborious and takes time. Further, when the URL of a Web page providing desired information is not known, the desired information cannot be obtained from the Internet Web pages via a portable telephone terminal.

The invention comprises: a portable telephone terminal 2 capable of being connected to the Internet 6; and a guidance apparatus 1 for distributing guidance information of an information providing site 3 to the portable telephone terminal 2. When the portable telephone terminal 2 makes a telephone call to a predetermined telephone number, the guidance apparatus 1 replies guidance information describing the address of the information providing site 3 to the portable telephone terminal 2 by e-mail. The replied e-mail is used by the portable telephone terminal 2 in order to access the information providing site 3.

### TECHNICAL FIELD

The present invention relates to: a system for distributing information to an information communications terminal; an information distribution method; an information distribution system; a third apparatus; a medium; an information set; and a program.

### BACKGROUND ART

The use of portable telephones has spread widely in recent years. The services available in portable telephone terminals include: ordinary voice communications; transmission and reception of e-mails; and connection to the Internet in order to access and browse Internet Web pages prepared in HDML, compact HTML, or the like.

Even in the outside of the home or office, a user can input a URL (uniform resource locator) in a portable telephone terminal in order to access an Internet Web page. The Web page is then displayed on the display of the portable telephone terminal. For example, when inputting an appropriate URL and thereby accessing a Web page providing bargain sale information, one can obtain the bargain sale information even in the outside of the home.

As such, by virtue of a portable telephone terminal, a user can access Internet Web pages and thereby obtain necessary information even in the outside of the home or office.

Further, in case of a serious natural disaster such as an earthquake, sufferers obtain information on refuge sites from radio broadcasting or other sufferers, and thereby go to safe refuge sites.

When a user desires to obtain bargain sale information, but does not know the URL of a Web page providing the bargain sale information, the user cannot obtain the bargain sale information. That is, when the URL of a Web page providing desired information is not known, the desired information cannot be obtained.

Even in the cases other than Web pages, when certain information is desired to obtain, but when the method to obtain the information is not known, the desired information is difficult to obtain.

That is, there has been the problem (a first problem) that when certain information is desired to obtain via a mobile info-communication terminal such as a portable telephone terminal, but when the method to obtain the information is not known, the desired information is difficult and laborious to obtain.

A mobile info-communication terminal, such as a portable telephone terminal, is provided with a menu prepared by a telecommunications company. Thus, even when the URL of a Web page providing desired information is not known, the hierarchy of the menu can be traced to a Web page providing the desired information in some cases. Nevertheless, the search for the desired information is laborious, and the desired information is not always found.

Further, in case that an information distributing company or the like desires the guide of the information distributing company's Web page to be incorporated into the menu provided by the telecommunications company, the information distributing company needs to request the telecommunications company for the incorporation and await the order of processing, since the menu is managed solely by the telecommunications company. Thus, it takes substantially long time for the guide of the information distributing company's Web page to be incorporated into the menu. Further, in some cases, the incorporation is not in the desired manner.

That is, there has been the problem (a second problem) that the menu provided by such a telecommunications company needs to be improved in the usability both for users who use mobile info-communication terminals in order to obtain desired information and for information distributors who provide information onto the mobile info-communication terminals.

Further, when information on the Umeda area in Osaka is desired to obtain in the menu provided by a telecommunications company, the hierarchy of the menu needs to be searched and thereby traced to the information on the Umeda area in Osaka. As such, area specific information is laborious to obtain, and the area-specific information is not always found.

That is, there has been the problem (a third problem) that in the menu provided by a telecommunications company, area-specific information is laborious to obtain, and that the area-specific information is not always found.

Further, in case of a serious natural disaster such as an earthquake, it takes long time for sufferers to obtain information on safe refuge sites from radio broadcasting. Further, information obtained from other sufferers may be incorrect in some cases, because the information is based on oral communications.

That is, there has been the problem (a fourth problem) that in case of a serious natural disaster, it is difficult to transmit information for the safety of sufferers accurately and rapidly to the sufferers.

### DISCLOSURE OF INVENTION

With considering the above-mentioned first problem, an object of the present invention is to provide: a system for providing desired information easily; an information distribution method; an information distribution system; a third apparatus; a medium; an information set; and a program.

With considering the second problem, an object of the invention is to provide: a system having good usability for users and information distributors; an information distribution method; an information distribution system; a third apparatus; a medium; an information set; and a program.

With considering the third problem, an object of the invention is to provide: a system capable of distributing area-specific information; an information distribution method; an information distribution system; a third apparatus; a medium; an information set; and a program.

With considering the fourth problem, an object of the invention is to provide: a system capable of transmitting information for the safety of sufferers accurately and rapidly to the sufferers in case of a serious natural disaster; an information distribution method; an information distribution system; a third apparatus; a medium; an information set; and a program.

To solve the problems mentioned above, the 1st invention of the present invention (corresponding to claim 1) is an information distribution method comprising the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said user has terminated said telephone call before the elapse of said predetermined time duration, searching said database on the basis of said telephone number of said caller, and thereby transmitting e-mail information to the obtained e-mail address.

The 2nd invention of the present invention (corresponding to claim 2) is an information distribution method comprising the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

The 3rd invention of the present invention (corresponding to claim 3) is an information distribution method comprising the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

The 4th invention of the present invention (corresponding to claim 4) is an information distribution method comprising the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, without any predetermined time duration for causing said user to terminate said telephone call, carrying out registration change guidance for causing said user to notify a new e-mail address for registration change;

when said telephone number of said caller is determined as registered, and when said user has terminated said telephone call, searching said database on the basis of said telephone number of said caller, and thereby transmitting e-mail information to the obtained e-mail address; and

when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

The present invention may be an information distribution method according to any one of the above-mentioned inventions, wherein:

in said initial registration guidance, when said e-mail address to be notified from said user can be generated from said telephone number of said caller according to a predetermined rule, guidance for termination of voice communication is carried out in order to notify the timing of termination of the voice communication of said telephone call; and

in contrast, when said e-mail address to be notified from said user cannot be generated from said telephone number of said caller according to said predetermined rule, guidance for e-mail address input is carried out in order to cause said user to notify said e-mail address by a predetermined method.

The present invention may be an information distribution method according to any one of the above-mentioned inventions, wherein said guidance means:

in said registration change guidance, when said e-mail address to be notified from said user can be generated from said telephone number of said caller according to a predetermined rule, guidance for termination of voice communication is carried out in order to notify the timing of termination of the voice communication of said telephone call; and

in contrast, when said e-mail address to be notified from said user cannot be generated from said telephone number of said caller according to said predetermined rule, guidance for e-mail address input is carried out in order to cause said user to notify said e-mail address by a predetermined method.

The present invention may be an information distribution method according to any one of the above-mentioned inventions, wherein when said e-mail address to be notified from said user can be generated from said telephone number of said caller according to said predetermined rule, a confirmation e-mail is transmitted to said e-mail address depending on the information on said timing.

The present invention may be an information distribution method according to any one of the above-mentioned inventions, wherein when said e-mail address to be notified from said user can be generated from said telephone number of said caller according to said predetermined rule, no confirmation e-mail is transmitted, then said e-mail address is generated from said telephone number of said caller according to said predetermined rule, and thereby said telephone number of said caller and said generated e-mail address are registered into said database.

The present invention may be an information distribution method according to any one of the above-mentioned inventions, wherein when registering into said database, said e-mail information also is transmitted to said e-mail address.

The present invention may be an information distribution method according to any one of the above-mentioned inventions, wherein said initial registration guidance is carried out in order to inform that when said e-mail address to be notified from said user can be generated from said telephone number of said caller according to a predetermined rule, said e-mail address is not necessary to be notified.

The present invention may be an information distribution method according to any one of the above-mentioned inventions, wherein said registration change guidance is carried out in order to inform that when said e-mail address to be notified from said user can be generated from said telephone number of said caller according to a predetermined rule, said e-mail address is not necessary to be notified.

The present invention may be an information distribution method according to any one of the above-mentioned inventions, wherein regardless of whether said e-mail address to be notified from said user can be generated from said telephone number of said caller according to said predetermined rule or not, an e-mail address is generated from said telephone number of said caller according to said predetermined rule, and thereby a confirmation e-mail is transmitted to the generated e-mail address.

The present invention may be an information distribution method according to any one of the above-mentioned inventions, wherein said initial registration guidance is carried out in order to cause said user to notify said e-mail address according to a predetermined method, regardless of whether said e-mail address to be notified from said user can be generated from said telephone number of said caller according to a predetermined rule or not.

The present invention may be an information distribution method according to any one of the above-mentioned inventions, wherein said registration change guidance is carried out in order to cause said user to notify said e-mail address according to a predetermined method, regardless of whether said e-mail address to be notified from said user can be generated from said telephone number of said caller according to a predetermined rule or not.

The present invention may be an information distribution method according to any one of the above-mentioned inventions, wherein when receiving said e-mail address notified according to said guidance, said e-mail information is transmitted to the notified e-mail address.

The present invention may be an information distribution method according to any one of the above-mentioned inventions, wherein in said transmission of said confirmation e-mail, when a plurality of e-mail addresses can be generated from said telephone number of said caller according to said predetermined rule, said confirmation e-mail is transmitted to said plurality of e-mail addresses.

The present invention may be an information distribution method according to any one of the above-mentioned inventions, wherein in said transmission of said confirmation e-mail, said confirmation e-mail is transmitted, and said e-mail information is also transmitted before or after the completion of the confirmation based on said confirmation e-mail.

The present invention may be an information distribution method according to any one of the above-mentioned inventions, wherein said guidance is carried out using at least one or more of a voice message, an e-mail, and a Web page.

The present invention may be an information distribution method according to any one of the above-mentioned inventions, wherein said predetermined method is the method of receiving said e-mail address by voice recognition of a voice message from said user.

The present invention may be an information distribution method according to any one of the above-mentioned inventions, wherein said predetermined method is the method of receiving said e-mail address by e-mail and/or Web page.

The present invention may be an information distribution method according to any one of the above-mentioned inventions, wherein said predetermined method is the method in which: a first e-mail address is notified to said user; and then, when said user has transmitted a first e-mail having blank contents or arbitrary contents to said first e-mail address, a second e-mail is transmitted to the e-mail address of the sender added in the received first e-mail.

The present invention may be an information distribution method according to any one of the above-mentioned inventions, wherein said second e-mail contains, as an attachment, the address of a predetermined Web page corresponding to said e-mail address of said sender of said first e-mail, and wherein

said predetermined method is the method in which: after said transmission of said second e-mail, when said user having received said second e-mail inputs a telephone number by accessing said predetermined Web page according to said address of said predetermined Web page, said e-mail address of said sender is identified on the basis of said address of said predetermined Web page contained in the access request issued for said access; and then

said input telephone number and said e-mail address of said sender are registered into said database.

The present invention may be an information distribution method according to any one of the above-mentioned inventions, wherein said predetermined method is the method in which after said transmission of said second e-mail, when said user having received said second e-mail replies an e-mail to which a telephone number is attached, said telephone number attached to said replied e-mail and the e-mail address of the sender added in said replied e-mail are registered in a form corresponded to each other into said database.

The present invention may be an information distribution method according to any one of the above-mentioned inventions wherein:

in said transmission of said confirmation e-mail, said confirmation e-mail is transmitted with attaching the address of a predetermined Web page corresponding to said telephone number of said caller; and then

when said user having received said confirmation e-mail issues an access request to said predetermined Web page, said telephone number of said caller is identified on the basis of said address of said predetermined Web page contained in said access request, and then said identified telephone number of said caller and an e-mail address generated from said telephone number of said caller according to a predetermined rule are registered in a form corresponded to each other into said database.

The present invention may be an information distribution method according to any one of the above-mentioned inventions, wherein after said transmission of said confirmation e-mail, when said user having received said confirmation e-mail transmits a reply e-mail in response to said confirmation e-mail, said telephone number of said caller is identified from the e-mail address of the sender added in said reply e-mail, according to said predetermined rule, and then

said identified telephone number and said e-mail address of said sender are registered into said database.

The 5th invention of the present invention (corresponding to claim 5) is an information distribution method according to any of the 1st to 4th inventions wherein:

when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; and

when said telephone number of said caller is determined as unregistered, and when said e-mail address has been already notified according to said predetermined method on the basis of said guidance, said telephone number of said telephone destination corresponding to the telephone number corresponding to said notified e-mail address is identified by searching said second database, whereby e-mail information depending on said telephone number of said telephone destination is transmitted to said notified e-mail address.

The 6th invention of the present invention (corresponding to claim 6) is an information distribution system comprising:

a first apparatus for storing a database generated in advance for corresponding telephone numbers and e-mail addresses to each other;

a second apparatus, on receiving a telephone call from a user, for searching said database of said first apparatus on the basis of the telephone number of the caller of said telephone call, and thereby determining whether said telephone number of said caller is registered or unregistered; and

a third apparatus, when said telephone number of said caller is determined as unregistered, for carrying out initial registration guidance for causing said user to notify an e-mail address, further

when said telephone number of said caller is determined as registered, after a predetermined time duration for causing said user to terminate said telephone call, carrying out registration change guidance for causing said user to notify a new e-mail address for registration change, and further

when said user has terminated said telephone call before the elapse of said predetermined time duration, searching said database on the basis of said telephone number of said caller, and thereby transmitting e-mail information to the obtained e-mail address.

The 7th invention of the present invention (corresponding to claim 7) is an information distribution system comprising:

a first apparatus for storing a database generated in advance for corresponding telephone numbers and e-mail addresses to each other;

a second apparatus, on receiving a telephone call from a user, for searching said database on the basis of the telephone number of the caller of said telephone call, and thereby determining whether said telephone number of said caller is registered or unregistered; and

a third apparatus, when said telephone number of said caller is determined as unregistered, for carrying out initial registration guidance for causing said user to notify an e-mail address, further

when said telephone number of said caller is determined as registered, after a predetermined time duration for causing said user to terminate said telephone call, carrying out registration change guidance for causing said user to notify a new e-mail address for registration change, and further

when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

The 8th invention of the present invention (corresponding to claim 8) is an information distribution system comprising:

a first apparatus for storing a database generated in advance for corresponding telephone numbers and e-mail addresses to each other;

a second apparatus, on receiving a telephone call from a user, for searching said database on the basis of the telephone number of the caller of said telephone call, and thereby determining whether said telephone number of said caller is registered or unregistered; and

a third apparatus, when said telephone number of said caller is determined as unregistered, for carrying out initial registration guidance for causing said user to notify an e-mail address, further

when said telephone number of said caller is determined as registered, after a predetermined time duration for causing said user to terminate said telephone call, carrying out registration change guidance for causing said user to notify a new e-mail address for registration change, and further

when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

The 9th invention of the present invention (corresponding to claim 9) is an information distribution system comprising:

a first apparatus for storing a database generated in advance for corresponding telephone numbers and e-mail addresses to each other;

a second apparatus, on receiving a telephone call from a user, for searching said database on the basis of the telephone number of the caller of said telephone call, and thereby determining whether said telephone number of said caller is registered or unregistered; and

a third apparatus, when said telephone number of said caller is determined as unregistered, for carrying out initial registration guidance for causing said user to notify an e-mail address, further

when said telephone number of said caller is determined as registered, without any predetermined time duration for causing said user to terminate said telephone call, carrying out registration change guidance for causing said user to notify a new e-mail address for registration change, further

when said telephone number of said caller is determined as registered, and when said user has terminated said telephone call, searching said database on the basis of said telephone number of said caller, and thereby transmitting e-mail information to the obtained e-mail address, and further

when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

The present invention may be an information distribution system according to any one of the above-mentioned inventions, wherein said third apparatus:

in said initial registration guidance, when said e-mail address to be notified from said user can be generated from said telephone number of said caller according to a predetermined rule, carries out guidance for termination of voice communication in order to notify the timing of termination of the voice communication of said telephone call; and

in contrast, when said e-mail address to be notified from said user cannot be generated from said telephone number of said caller according to said predetermined rule, carries out guidance for e-mail address input in order to cause said user to notify said e-mail address by a predetermined method.

The present invention may be an information distribution system according to any one of the above-mentioned inventions, wherein said third apparatus:

in said registration change guidance, when said e-mail address to be notified from said user can be generated from said telephone number of said caller according to a predetermined rule, carries out guidance for termination of voice communication in order to notify the timing of termination of the voice communication of said telephone call; and

in contrast, when said e-mail address to be notified from said user cannot be generated from said telephone number of said caller according to said predetermined rule, carries out guidance for e-mail address input in order to cause said user to notify said e-mail address by a predetermined method.

The present invention may be an information distribution system according to any one of the above-mentioned inventions, wherein when said e-mail address to be notified from said user can be generated from said telephone number of said caller according to said predetermined rule, said third apparatus transmits a confirmation e-mail to said e-mail address depending on the information on said timing.

The present invention may be an information distribution system according to any one of the above-mentioned inventions, wherein when said e-mail address to be notified from said user can be generated from said telephone number of said caller according to said predetermined rule, said third apparatus does not transmit any confirmation e-mail, but generates said e-mail address from said telephone number of said caller according to said predetermined rule, and thereby registers said telephone number of said caller and said generated e-mail address into said database.

The present invention may be an information distribution system according to any one of the above-mentioned inventions, wherein when registering into said database, said third apparatus further transmits said e-mail information to said e-mail address.

The present invention may be an information distribution system according to any one of the above-mentioned inventions, wherein said initial registration guidance is carried out in order to inform that when said e-mail address to be notified from said user can be generated from said telephone number of said caller according to a predetermined rule, said e-mail address is not necessary to be notified.

The present invention may be an information distribution system according to any one of the above-mentioned inventions, wherein said registration change guidance is carried out in order to inform that when said e-mail address to be notified from said user can be generated from said telephone number of said caller according to a predetermined rule, said e-mail address is not necessary to be notified.

The present invention may be an information distribution system according to any one of the above-mentioned inventions, wherein regardless of whether said e-mail address to be notified from said user can be generated from said telephone number of said caller according to said predetermined rule or not, said third apparatus generates an e-mail address from said telephone number of said caller according to said predetermined rule, and thereby transmits a confirmation e-mail to the generated e-mail address.

The present invention may be an information distribution system according to any one of the above-mentioned inventions, wherein said initial registration guidance is carried out in order to cause said user to notify said e-mail address according to a predetermined method, regardless of whether said e-mail address to be notified from said user can be generated from said telephone number of said caller according to a predetermined rule or not.

The present invention may be an information distribution system according to any one of the above-mentioned inventions, wherein said registration change guidance is carried out in order to cause said user to notify said e-mail address according to a predetermined method, regardless of whether said e-mail address to be notified from said user can be generated from said telephone number of said caller according to a predetermined rule or not.

The present invention may be an information distribution system according to any one of the above-mentioned inventions, wherein when receiving said e-mail address notified according to said guidance, said third apparatus transmits said e-mail information to the notified e-mail address.

The present invention may be an information distribution system according to any one of the above-mentioned inventions, wherein in said transmission of said confirmation e-mail, when a plurality of e-mail addresses can be generated from said telephone number of said caller according to said predetermined rule, said third apparatus transmits said confirmation e-mail to said plurality of e-mail addresses.

The present invention may be an information distribution system according to any one of the above-mentioned inventions, wherein in said transmission of said confirmation e-mail, said third apparatus transmits said confirmation e-mail, and further transmits said e-mail information before or after the completion of the confirmation based on said confirmation e-mail.

The present invention may be an information distribution system according to any one of the above-mentioned inventions, wherein said guidance is carried out using at least one or more of a voice message, an e-mail, and a Web page.

The present invention may be an information distribution system according to any one of the above-mentioned inventions, wherein said predetermined method is the method of receiving said e-mail address by voice recognition of a voice message from said user.

The present invention may be an information distribution system according to any one of the above-mentioned inventions, wherein said predetermined method is the method of receiving said e-mail address by e-mail and/or Web page.

The present invention may be an information distribution system according to any one of the above-mentioned inventions, wherein said predetermined method is the method in which: a first e-mail address is notified to said user; and then, when said user has transmitted a first e-mail having blank contents or arbitrary contents to said first e-mail address, a second e-mail is transmitted to the e-mail address of the sender added in the received first e-mail.

The present invention may be an information distribution system according to any one of the above-mentioned inventions, wherein said second e-mail contains, as an attachment, the address of a predetermined Web page corresponding to said e-mail address of said sender of said first e-mail, and wherein

said predetermined method is the method in which: after said transmission of said second e-mail, when said user having received said second e-mail inputs a telephone number by accessing said predetermined Web page according to said address of said predetermined Web page, said e-mail address of said sender is identified on the basis of said address of said predetermined Web page contained in the access request issued for said access; and then

said input telephone number and said e-mail address of said sender are registered into said database.

The present invention may be an information distribution system according to any one of the above-mentioned inventions, wherein said predetermined method is the method in which after said transmission of said second e-mail, when said user having received said second e-mail replies an e-mail to which a telephone number is attached, said telephone number attached to said replied e-mail and the e-mail address of the sender added in said replied e-mail are registered in a form corresponded to each other into said database.

The present invention may be an information distribution system according to any one of the above-mentioned inventions, wherein in said transmission of said confirmation e-mail, said third apparatus: transmits said confirmation e-mail with attaching the address of a predetermined Web page corresponding to said telephone number of said caller; and then

when said user having received said confirmation e-mail issues an access request to said predetermined Web page, identifies said telephone number of said caller on the basis of said address of said predetermined Web page contained in said access request, and then registers said identified telephone number of said caller and an e-mail address generated from said telephone number of said caller according to a predetermined rule in a form corresponded to each other into said database.

The present invention may be an information distribution system according to any one of the above-mentioned inventions, wherein after said transmission of said confirmation e-mail, when said user having received said confirmation e-mail transmits a reply e-mail in response to said confirmation e-mail, said third apparatus identifies said telephone number of said caller from the e-mail address of the sender added in said reply e-mail, according to said predetermined rule, and then

registers said identified telephone number and said e-mail address of said sender into said database.

The 10th invention of the present invention (corresponding to claim 10) is an information distribution method according to any of the 6th to 9 inventions, comprising a fourth apparatus in which when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; wherein

when said telephone number of said caller is determined as unregistered, and when said e-mail address has been already notified according to said predetermined method on the basis of said guidance, said third apparatus identifies said telephone number of said telephone destination corresponding to the telephone number corresponding to said notified e-mail address by searching said second database, and thereby transmits e-mail information depending on said telephone number of said telephone destination said notified e-mail address.

The 11th invention of the present invention (corresponding to claim 11) is a third apparatus comprising guidance means of:

on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;

when said telephone number of said caller is determined as registered, after a predetermined time duration for causing said user to terminate said telephone call, carrying out registration change guidance for causing said user to notify a new e-mail address for registration change; and

when said user has terminated said telephone call before the elapse of said predetermined time duration, searching said database on the basis of said telephone number of said caller, and thereby transmitting e-mail information to the obtained e-mail address.

The 12th invention of the present invention (corresponding to claim 12) is a third apparatus comprising guidance means of:

on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

The 13th invention of the present invention (corresponding to claim 13) is a third apparatus comprising guidance means of:

on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

The 14th invention of the present invention (corresponding to claim 14) is a third apparatus comprising guidance means of:

on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;

when said telephone number of said caller is determined as registered, without any predetermined time duration for causing said user to terminate said telephone call, carrying out registration change guidance for causing said user to notify a new e-mail address for registration change;

when said telephone number of said caller is determined as registered, and when said user has terminated said telephone call, searching said database on the basis of said telephone number of said caller, and thereby transmitting e-mail information to the obtained e-mail address; and

when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

The 15th invention of the present invention (corresponding to claim 15) is a third apparatus according to any one of the 11th to 14th inventions, wherein said guidance means:

in said initial registration guidance, when said e-mail address to be notified from said user can be generated from said telephone number of said caller according to a predetermined rule, carries out guidance for termination of voice communication in order to notify the timing of termination of the voice communication of said telephone call; and

in contrast, when said e-mail address to be notified from said user cannot be generated from said telephone number of said caller according to said predetermined rule, carries out guidance for e-mail address input in order to cause said user to notify said e-mail address by a predetermined method.

The 16th invention of the present invention (corresponding to claim 16) is a third apparatus according to any one of the 11th to 14th inventions, wherein said guidance means:

in said registration change guidance, when said e-mail address to be notified from said user can be generated from said telephone number of said caller according to a predetermined rule, carries out guidance for termination of voice communication in order to notify the timing of termination of the voice communication of said telephone call; and

in contrast, when said e-mail address to be notified from said user cannot be generated from said telephone number of said caller according to said predetermined rule, carries out guidance for e-mail address input in order to cause said user to notify said e-mail address by a predetermined method.

The 17th invention of the present invention (corresponding to claim 17) is a third apparatus according to the 15th or 16th invention, wherein when said e-mail address to be notified from said user can be generated from said telephone number of said caller according to said predetermined rule, said guidance means transmits a confirmation e-mail to said e-mail address depending on the information on said timing.

The 18th invention of the present invention (corresponding to claim 18) is a third apparatus according to the 15th or 16th invention, wherein when said e-mail address to be notified from said user can be generated from said telephone number of said caller according to said predetermined rule, said guidance means does not transmit any confirmation e-mail, but generates said e-mail address from said telephone number of said caller according to said predetermined rule, and thereby registers said telephone number of said caller and said generated e-mail address into said database.

The 19th invention of the present invention (corresponding to claim 19) is a third apparatus according to the 18th invention, wherein when registering into said database, said guidance means further transmits said e-mail information to said e-mail address.

The 20th invention of the present invention (corresponding to claim 20) is a third apparatus according to any one of the 11th to 14th inventions, wherein said initial registration guidance is carried out in order to inform that when said e-mail address to be notified from said user can be generated from said telephone number of said caller according to a predetermined rule, said e-mail address is not necessary to be notified.

The 21st invention of the present invention (corresponding to claim 21) is a third apparatus according to any one of the 11th to 14th inventions, wherein said registration change guidance is carried out in order to inform that when said e-mail address to be notified from said user can be generated from said telephone number of said caller according to a predetermined rule, said e-mail address is not necessary to be notified.

The 22nd invention of the present invention (corresponding to claim 22) is a third apparatus according to the 20th or 21st invention, wherein regardless of whether said e-mail address to be notified from said user can be generated from said telephone number of said caller according to said predetermined rule or not, said guidance means generates an e-mail address from said telephone number of said caller according to said predetermined rule, and thereby transmits a confirmation e-mail to the generated e-mail address.

The 23rd invention of the present invention (corresponding to claim 23) is a third apparatus according to anyone of the 11th to 14th inventions, wherein said initial registration guidance is carried out in order to cause said user to notify said e-mail address according to a predetermined method, regardless of whether said e-mail address to be notified from said user can be generated from said telephone number of said caller according to a predetermined rule or not.

The 24th invention of the present invention (corresponding to claim 24) is a third apparatus according to any one of the 11th to 14th inventions, wherein said registration change guidance is carried out in order to cause said user to notify said e-mail address according to a predetermined method, regardless of whether said e-mail address to be notified from said user can be generated from said telephone number of said caller according to a predetermined rule or not.

The 25th invention of the present invention (corresponding to claim 25) is a third apparatus according to any one of the 11th to 14th inventions, wherein when receiving said e-mail address notified according to said guidance, said guidance means transmits said e-mail information to the notified e-mail address.

The 26th invention of the present invention (corresponding to claim 26) is a third apparatus according to the 17th or 22nd invention, wherein in said transmission of said confirmation e-mail, when a plurality of e-mail addresses can be generated from said telephone number of said caller according to said predetermined rule, said guidance means transmits said confirmation e-mail to said plurality of e-mail addresses.

The 27th invention of the present invention (corresponding to claim 27) is a third apparatus according to the 17th, 22th, or 26th invention, wherein in said transmission of said confirmation e-mail, said guidance means transmits said confirmation e-mail, and further transmits said e-mail information before or after the completion of the confirmation based on said confirmation e-mail.

The 28th invention of the present invention (corresponding to claim 28) is a third apparatus according to any one of the 11th to 27th inventions, wherein said guidance is carried out using at least one or more of a voice message, an e-mail, and a Web page.

The 29th invention of the present invention (corresponding to claim 29) is a third apparatus according to any one of the 11th to 24th inventions, wherein said predetermined method is the method of receiving said e-mail address by voice recognition of a voice message from said user.

The 30th invention of the present invention (corresponding to claim 30) is a third apparatus according to any one of the 11th to 24th inventions, wherein said predetermined method is the method of receiving said e-mail address by e-mail and/or Web page.

The 31st invention of the present invention (corresponding to claim 31) is a third apparatus according to the 30th invention, wherein said predetermined method is the method in which: a first e-mail address is notified to said user; and then, when said user has transmitted a first e-mail having blank contents or arbitrary contents to said first e-mail address, a second e-mail is transmitted to the e-mail address of the sender added in the received first e-mail.

The 32nd invention of the present invention (corresponding to claim 32) is a third apparatus according to the 31st invention, wherein said second e-mail contains, as an attachment, the address of a predetermined Web page corresponding to said e-mail address of said sender of said first e-mail, and wherein

said predetermined method is the method in which: after said transmission of said second e-mail, when said user having received said second e-mail inputs a telephone number by accessing said predetermined Web page according to said address of said predetermined Web page, said e-mail address of said sender is identified on the basis of said address of said predetermined Web page contained in the access request issued for said access; and then

said input telephone number and said e-mail address of said sender are registered into said database.

The 33rd invention of the present invention (corresponding to claim 33) is a third apparatus according to the 31st invention, wherein said predetermined method is the method in which after said transmission of said second e-mail, when said user having received said second e-mail replies an e-mail to which a telephone number is attached, said telephone number attached to said replied e-mail and the e-mail address of the sender added in said replied e-mail are registered in a form corresponded to each other into said database.

The 34th invention of the present invention (corresponding to claim 34) is a third apparatus according to any one of the 11th to 24th inventions, wherein in said transmission of said confirmation e-mail, said guidance means: transmits said confirmation e-mail with attaching the address of a predetermined Web page corresponding to said telephone number of said caller; and then

when said user having received said confirmation e-mail issues an access request to said predetermined Web page, identifies said telephone number of said caller on the basis of said address of said predetermined Web page contained in said access request, and then registers said identified telephone number of said caller and an e-mail address generated from said telephone number of said caller according to a predetermined rule in a form corresponded to each other into said database.

The 35th invention of the present invention (corresponding to claim 35) is a third apparatus according to any one of the 11th to 24th inventions, wherein after said transmission of said confirmation e-mail, when said user having received said confirmation e-mail transmits a reply e-mail in response to said confirmation e-mail, said guidance means identifies said telephone number of said caller from the e-mail address of the sender added in said reply e-mail, according to said predetermined rule, and then

registers said identified telephone number and said e-mail address of said sender into said database.

The 36th invention of the present invention (corresponding to claim 36) is a third apparatus according to any one of the 11th to 35th inventions comprising a fourth apparatus in which when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; wherein

when said telephone number of said caller is determined as unregistered, and when said e-mail address has been already notified according to said predetermined method on the basis of said guidance, said guidance means identifies said telephone number of said telephone destination corresponding to the telephone number corresponding to said notified e-mail address by searching said second database, and thereby transmits e-mail information depending on said telephone number of said telephone destination said notified e-mail address.

The 37th invention of the present invention (corresponding to claim 37) is a computer-processable medium carrying a program for causing a computer to execute, in the information distribution method according to the 1st invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said user has terminated said telephone call before the elapse of said predetermined time duration, searching said database on the basis of said telephone number of said caller, and thereby transmitting e-mail information to the obtained e-mail address.

The 38th invention of the present invention (corresponding to claim 38) is a computer-processable medium carrying a program for causing a computer to execute, in the information distribution method according to the 2nd invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

The 39th invention of the present invention (corresponding to claim 39) is a computer-processable medium carrying a program for causing a computer to execute, in the information distribution method according to the 3rd invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

The 40th invention of the present invention (corresponding to claim 40) is a computer-processable medium carrying a program for causing a computer to execute, in the information distribution method according to the 4th invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, without any predetermined time duration for causing said user to terminate said telephone call, carrying out registration change guidance for causing said user to notify a new e-mail address for registration change;

when said telephone number of said caller is determined as registered, and when said user has terminated said telephone call, searching said database on the basis of said telephone number of said caller, and thereby transmitting e-mail information to the obtained e-mail address; and

when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

The 41st invention of the present invention (corresponding to claim 41) is a program for causing a computer to execute, in the information distribution method according to the 1st invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said user has terminated said telephone call before the elapse of said predetermined time duration, searching said database on the basis of said telephone number of said caller, and thereby transmitting e-mail information to the obtained e-mail address.

The 42nd invention of the present invention (corresponding to claim 42) is a program for causing a computer to execute, in the information distribution method according to the 2nd invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

The 43rd invention of the present invention (corresponding to claim 43) is a program for causing a computer to execute, in the information distribution method according to the 3rd invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, after a predetermined time duration for causing said user to terminate said telephone call, carrying out registration change guidance for causing said user to notify a new e-mail address for registration change; and

when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

The 44th invention of the present invention (corresponding to claim 44) is a program for causing a computer to execute, in the information distribution method according to the 4th invention, all or part of the steps of:

generating a database for corresponding telephone numbers and e-mail addresses to each other, in advance;

on receiving a telephone call from a user, searching said database on the basis of the telephone number of the caller of said telephone call, and thereby determining whether said telephone number of said caller is registered or unregistered;

when said telephone number of said caller is determined as unregistered, carrying out initial registration guidance for causing said user to notify an e-mail address;

when said telephone number of said caller is determined as registered, without any predetermined time duration for causing said user to terminate said telephone call, carrying out registration change guidance for causing said user to notify a new e-mail address for registration change;

when said telephone number of said caller is determined as registered, and when said user has terminated said telephone call, searching said database on the basis of said telephone number of said caller, and thereby transmitting e-mail information to the obtained e-mail address; and

when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

The 45th invention of the present invention (corresponding to claim 45) is a system comprising:

an info-communication terminal for carrying out info-communications through a telephone network; and

information distributing means of distributing first information to an e-mail address corresponding to said info-communication terminal; wherein

when said info-communication terminal makes a telephone call to a predetermined telephone number,

said information distributing means distributes said first information by e-mail to said e-mail address corresponding to said info-communication terminal generated from the telephone number of said info-communication terminal according to a predetermined rule.

The 46th invention of the present invention (corresponding to claim 46) is a system according to the 45th invention comprising e-mail address generating means of generating said e-mail address corresponding to said info-communication terminal from said info-communication terminal according to said predetermined rule.

The 47th invention of the present invention (corresponding to claim 47) is a system according to the 45th or 46th invention comprising receiving means of receiving said telephone call from said info-communication terminal to said predetermined telephone number.

The 48th invention of the present invention (corresponding to claim 48) is a system comprising information distributing means of, when an info-communication terminal for carrying out info-communications through a telephone network makes a telephone call to a predetermined telephone number, distributing first information to an e-mail address corresponding to said info-communication terminal generated from the telephone number of said info-communication terminal according to a predetermined rule.

The 49th invention of the present invention (corresponding to claim 49) is a system comprising e-mail address generating means of, when an info-communication terminal for carrying out info-communications through a telephone network makes a telephone call to a predetermined telephone number, generating an e-mail address corresponding to said info-communication terminal from the telephone number of said info-communication terminal according to a predetermined rule, wherein

first information is distributed to said generated e-mail address.

The 50th invention of the present invention (corresponding to claim 50) is a system comprising receiving means of receiving a telephone call, when an info-communication terminal for carrying out info-communications through a telephone network makes said telephone call to a predetermined telephone number, wherein:

an e-mail address corresponding to said info-communication terminal is generated from the telephone number of said info-communication terminal according to a predetermined rule; and

first information is distributed to said generated e-mail address.

The 51st invention of the present invention (corresponding to claim 51) is a system comprising:

e-mail address generating means of, when an info-communication terminal for carrying out info-communications through a telephone network makes a telephone call to a predetermined telephone number, generating an e-mail address corresponding to said info-communication terminal from the telephone number of said info-communication terminal according to a predetermined rule; and

information distributing means for distributing first information to said generated e-mail address.

The 52nd invention of the present invention (corresponding to claim 52) is a system comprising:

receiving means of receiving a telephone call, when an info-communication terminal for carrying out info-communications through a telephone network makes said telephone call to a predetermined telephone number; and

e-mail address generating means of generating an e-mail address corresponding to said info-communication terminal from the telephone number of said info-communication terminal according to a predetermined rule; wherein

first information is distributed to said generated e-mail address.

The 53rd invention of the present invention (corresponding to claim 53) is a system comprising:

receiving means of receiving a telephone call, when an info-communication terminal for carrying out info-communications through a telephone network makes said telephone call to a predetermined telephone number; and

information distributing means of distributing first information to an e-mail address corresponding to said info-communication terminal generated from the telephone number of said info-communication terminal according to a predetermined rule.

The 54th invention of the present invention (corresponding to claim 54) is a system of an info-communication terminal comprising:

telephone calling means of making a telephone call to a predetermined telephone number; and

e-mail acquiring means of acquiring first information; wherein

when said telephone calling means makes a telephone call to a predetermined telephone number,

said first information is distributed by e-mail to an e-mail address corresponding to said info-communication terminal generated from the telephone number of said info-communication terminal according to a predetermined rule.

The 55th invention of the present invention (corresponding to claim 55) is a system comprising information providing means of providing the browse address of an Internet information providing site which provides information on a predetermined item, as second information to an info-communication terminal via said Internet, wherein:

when said info-communication terminal makes a telephone call to a predetermined telephone number, an e-mail address corresponding to said info-communication terminal is generated from the telephone number of said info-communication terminal according to a predetermined rule, and then first information is distributed to said generated e-mail address;

said distributed first information describes a browse address used for accessing said system; and

said info-communication terminal accesses an information distribution server on the basis of said first information.

The 56th invention of the present invention (corresponding to claim 56) is a system according to any one of the 45th to 55th inventions wherein:

a plurality of e-mail addresses are generated corresponding to said info-communication terminal; and

said first information is distributed to said plurality of e-mail addresses.

The 57th invention of the present invention (corresponding to claim 57) is a system according to any one of the 45th to 56th inventions, wherein the amount and/or the contents of said first information are changed depending on the telephone number of said info-communication terminal, said predetermined rule, or said e-mail address.

The 58th invention of the present invention (corresponding to claim 58) is a system according to any one of the 45th to 57th inventions, wherein said e-mail address of said info-communication terminal is determined using also a first table for corresponding the telephone number and the e-mail address of said info-communication terminal to each other.

The 59th invention of the present invention (corresponding to claim 59) is a system according to the 58th invention, wherein when said distribution of said first information was successful, generated is a second table for corresponding said e-mail address and the telephone number of said info-communication terminal corresponding to said e-mail address to each other.

The 60th invention of the present invention (corresponding to claim 60) is a system according to the 59th invention, wherein:

said e-mail address corresponding to said telephone number of said info-communication terminal is acquired by searching said first table and/or said second table, and then said first information is distributed to said acquired e-mail address; and

when said e-mail address corresponding to said telephone number of said info-communication terminal cannot be acquired by searching said first table and/or said second table, the e-mail address of said info-communication terminal is generated from said telephone number of said info-communication terminal according to a predetermined rule, and then said first information is distributed to said generated e-mail address.

The 61st invention of the present invention (corresponding to claim 61) is a system according to the 59th invention, wherein after said first information is distributed to said e-mail address generated according to said predetermined rule, said e-mail address corresponding to said telephone number of said info-communication terminal is acquired by searching said first table and/or said second table, and then said first information is distributed also to said acquired e-mail address.

The 62nd invention of the present invention (corresponding to claim 62) is a system according to the 59th invention, wherein:

said e-mail address corresponding to said telephone number of said info-communication terminal is acquired by searching said first table and/or said second table; and

said first information is distributed to said acquired e-mail address and said e-mail address generated according to said predetermined rule.

The 63rd invention of the present invention (corresponding to claim 63) is a system according to any one of the 58th to 62nd inventions wherein:

said e-mail address corresponding to said telephone number of said info-communication terminal is acquired by searching said first table or said second table, and then said first information is distributed to said acquired e-mail address; and

when said distribution of said first information to said e-mail address was unsuccessful, said e-mail address is deleted from said first table or said second table.

The 64th invention of the present invention (corresponding to claim 64) is a system according to any one of the 58th to 63rd inventions, wherein when said distribution of said first information to said e-mail address generated according to said predetermined rule was successful, and when said e-mail address is thereby registered into said first table and/or said second table, and further when an e-mail address corresponding to said telephone number of said info-communication terminal is already registered in said first table and/or said second table, said e-mail address presently registered is updated into said e-mail address to which said distribution of said first information was successful.

The 65th invention of the present invention (corresponding to claim 65) is a system according to any one of the 45th to 64th inventions wherein:

there are a plurality of said predetermined telephone numbers; and

said info-communication terminal selects desired said first information by selecting a telephone number to which a telephone call is made among said plurality of telephone numbers.

The 66th invention of the present invention (corresponding to claim 66) is a system according to the 65th invention, wherein said plurality of telephone numbers can be specified by selection numbers.

The 67th invention of the present invention (corresponding to claim 67) is a system according to any one of the 45th to 66th inventions wherein:

said info-communication terminal can be connected to the Internet; and

said first information describes the browse address used for accessing said Internet information providing site which provides information on a predetermined item.

The 68th invention of the present invention (corresponding to claim 68) is a system according to the 67th invention, wherein

said first information is in a hierarchical form, and wherein

when there are a plurality of predetermined telephone numbers:

each of said plurality of predetermined telephone numbers is corresponded to each of said hierarchical first information items;

a portion of said first information describes said predetermined telephone number used for obtaining said first information in the lower hierarchy; and

the other portion of said first information describes the browse address used for accessing said Internet information providing site.

The 69th invention of the present invention (corresponding to claim 69) is a system according to any one of the 45th to 66th inventions, wherein said first information describes information on a predetermined item.

The 70th invention of the present invention (corresponding to claim 70) is a system according to the 65th or 66th invention, wherein all or part of said first information describes all or part of said plurality of telephone numbers.

The 71st invention of the present invention (corresponding to claim 71) is a system according to the 70th invention wherein:

said first information is in a hierarchical form;

each of said plurality of predetermined telephone numbers is corresponded to each of said hierarchical first information items;

a portion of said first information describes said predetermined telephone number used for obtaining said first information in the lower hierarchy; and

the other portion of said first information describes information on a predetermined item.

The 72nd invention of the present invention (corresponding to claim 72) is a system according to any one of the 45th to 66th inventions wherein:

said info-communication terminal can be connected to the Internet;

said first information describes the browse address used for accessing an information distribution server which provides, as second information to said info-communication terminal via the Internet, the browse address of said Internet information providing site which provides information on a predetermined item;

said info-communication terminal access said information distribution server on the basis of said first information; and

said second information is provided from said information distribution server to said info-communication terminal.

The 73rd invention of the present invention (corresponding to claim 73) is a system according to the 72nd invention, wherein said second information is provided to said info-communication terminal by e-mail.

The 74th invention of the present invention (corresponding to claim 74) is a system according to the 72nd invention, wherein said second information is provided to said info-communication terminal by Web page.

The 75th invention of the present invention (corresponding to claim 75) is a system according to any one of the 72nd to 74th inventions, wherein said first information and/or said second information are in a hierarchical form.

The 76th invention of the present invention (corresponding to claim 76) is a system according to any one of the 45th to 67th, 69th, and 72nd to 75th inventions comprising voice guidance means of sending a voice guidance message when said info-communication terminal makes a telephone call to said predetermined telephone number, wherein

said info-communication terminal selects desired first information according to said voice guidance message.

The 77th invention of the present invention (corresponding to claim 77) is a system according to the 47th, 50th, 52nd, or 53rd inventions wherein:

said receiving means acquires the telephone number of said info-communication terminal on the basis of said telephone call from said info-communication terminal according to number notifying service; and

an e-mail address corresponding to said info-communication terminal is generated from said acquired telephone number.

The 78th invention of the present invention (corresponding to claim 78) is a system according to the 77th invention, wherein when a predetermined time duration has been elapsed after a telephone call from said info-communication terminal is received, said receiving means replies to said telephone call, and after that, terminates the voice communication.

The 79th invention of the present invention (corresponding to claim 79) is a computer-processable medium carrying a program and/or data for causing a computer to execute all or part of the function of all or part of said means and said info-communication terminal of said system according to any one of the 45th to 78th inventions.

The 80th invention of the present invention (corresponding to claim 80) is an information set composed of a program and/or data for causing a computer to execute all or part of the function of all or part of said means and said info-communication terminal of said system according to any one of the 45th to 78th inventions.

### BRIEF DESCRIPTION OF DRAWINGS

FIG. 1 shows the configuration of an information distribution system according to Embodiment 1 of the invention.

FIG. 2 shows interactions among a guidance apparatus, a portable telephone terminal, a guidance server, and an information providing site according to Embodiment 1 of the invention.

FIG. 3 shows an example of telephone numbers and distributed guidance information according to Embodiments 1 and 3 of the invention.

FIG. 4 shows an example of guidance information sent by e-mail from a guidance apparatus according to Embodiments 1, 3 and 4 of the invention.

FIG. 5 shows an example of guidance information sent by e-mail from a guidance apparatus according to Embodiments 1 and 4 of the invention.

FIG. 6 shows an example of guidance information provided in a Web page by a guidance server according to Embodiments 1 and 4 of the invention.

FIG. 7 shows an example of guidance information provided in a Web page by a guidance server according to Embodiment 1 of the invention.

FIG. 8 shows the configuration of an information distribution system according to Embodiment 2 of the invention.

FIG. 9 shows interactions among a guidance apparatus, a portable telephone terminal, a guidance server, and an information providing site according to Embodiment 2 of the invention.

FIG. 10(a) shows an example of telephone numbers each used for selecting a local area according to Embodiment 2 of the invention. FIG. 10(b) shows an example of voice guidance according to Embodiment 2 of the invention.

FIG. 11 shows the configuration of an information distribution system according to Embodiment 3 of the invention.

FIG. 12 shows interactions between a guidance apparatus and a portable telephone terminal according to Embodiment 3 of the invention.

FIG. 13 shows an example of guidance information sent by e-mail from a guidance apparatus according to Embodiment 3 of the invention.

FIG. 14 shows an example of guidance information sent by e-mail from a guidance apparatus according to Embodiment 3 of the invention.

FIG. 15 shows interactions among a guidance server, a portable telephone terminal, and a guidance apparatus according to Embodiment 4 of the invention.

FIG. 16 shows an example of guidance information sent by e-mail from a guidance server according to Embodiment 4 of the invention.

FIG. 17 shows the configuration of an information distribution system according to Embodiment 5 of the invention.

FIG. 18 shows the configuration of an information distribution system according to Embodiment 6 of the invention.

FIG. 19 shows the configuration of an information distribution system according to Embodiment 7 of the invention.

FIG. 20 shows the configuration of an information distribution system according to Embodiment 8 of the invention.

FIG. 21 shows the configuration of an alternative information distribution system according to Embodiment 8 of the invention.

FIG. 22 shows the configuration of an information distribution system according to Embodiment 9 of the invention.

FIG. 23 shows the configuration of an information distribution system according to Embodiment 10 of the invention.

FIG. 24 shows an example in which selection numbers are used for selecting guidance information according to Embodiment 1 of the invention.

FIG. 25 shows the configuration of an information distribution system according to Embodiment 10 of the invention.

FIG. 26 is a flowchart showing the operation of an information distribution system according to Embodiment 10 of the invention.

FIG. 27 shows a part of guidance according to Embodiment 10 of the invention.

FIG. 28 shows a part of guidance according to Embodiment 10 of the invention.

FIG. 29 shows a part of guidance according to Embodiment 10 of the invention.

FIG. 30 shows a part of guidance according to Embodiment 10 of the invention.

FIG. 31 shows a part of guidance according to Embodiment 10 of the invention.

FIG. 32 is a flowchart showing the operation of an information distribution system according to Embodiment 11 of the invention.

### DESCRIPTION OF THE REFERENCE NUMERALS

1 Guidance apparatus

2 Portable telephone terminal

3 Information providing apparatus

4 Relay station

5 Provider

6 Internet

7 Telephone receiving means

8 Telephone number acquiring means

9 E-mail address acquiring means

10 User information database

11 E-mail transmitting means

12 Distributed information database

13 Wireless communication

14 Telephone line

16 Voice guidance means

17 Telephone replying means

18 Guidance information distributing means

20 Telephone call

30 Guidance apparatus

31 E-mail address acquiring means

32 Posterior registration table

33 Virtual e-mail address generating means

34 Virtual e-mail address generation rule

35 Transmission result determining means

36 Guidance apparatus

38 Anterior registration table

39 Guidance apparatus

40 E-mail address acquiring means

41 Virtual e-mail address generating means

42 Guidance apparatus

43 Selecting means

44 Guidance apparatus

45 Deleting means

201 Guidance apparatus

202 Guidance means

203 Database managing means

204 Web page providing means

205 User information database

206 Call history database

### BEST MODE FOR CARRYING OUT THE INVENTION

The embodiments of the invention are described below with reference to the drawings.

(Embodiment 1)

Embodiment 1 is described below at first.

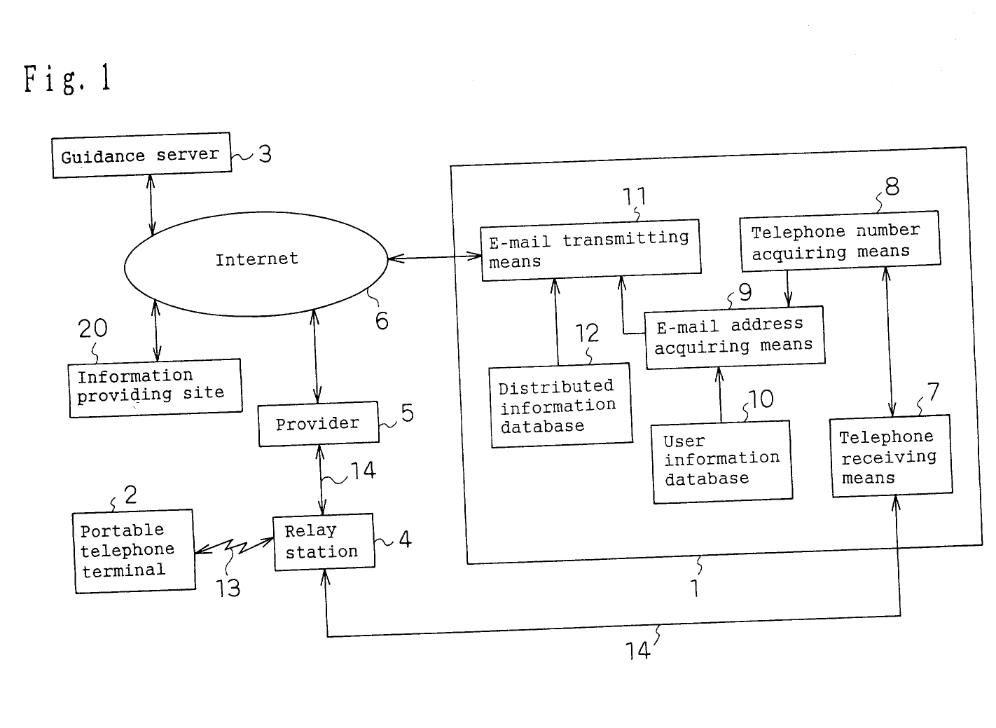

FIG. 1 shows the configuration of an information distribution system according to the present embodiment.

The information distribution system according to the present embodiment comprises a guidance apparatus 1, a portable telephone terminal 2, a guidance server 3, a relay station 4, a provider 5, the Internet 6, and an information providing site 20.

The guidance apparatus 1 is an apparatus for transmitting guidance information which describes the URL of a Web page provided by the guidance server 3, to the portable telephone terminal 2 by e-mail in response to a telephone call from the portable telephone terminal 2.

The portable telephone terminal 2 is a portable telephone terminal capable of being connected to the Internet. In FIG. 1, a single portable telephone terminal 2 is solely shown. However, a plurality of portable telephone terminals 2 are used actually.

The portable telephone terminal 2 comprises: telephone calling means (not shown) of making a telephone call to a predetermined telephone number; and e-mail acquiring means of receiving an e-mail. The telephone calling means is means of making a telephone call via the relay station 4 and a telephone line. The e-mail acquiring means is means of acquiring an e-mail from a mail box for the portable telephone terminal 2 provided in the provider 5.

The guidance server 3 is a Web server for providing the addresses of Web pages provided by the information providing site 20, as a Web page via the Internet 6 to the portable telephone terminal 2.

The guidance apparatus 1 is connected to the Internet 6 and the relay station 4. The portable telephone terminal 2 can be connected to the Internet 6 via the relay station 4 and the provider 5.

The relay station 4 is an apparatus for relaying between the portable telephone terminal 2 and the telephone line network.

The provider 5 is an apparatus for connecting the portable telephone terminal 2 to the Internet.

The guidance apparatus 1 comprises telephone receiving means 7, telephone number acquiring means 8, e-mail address acquiring means 9, a user information database 10, e-mail transmitting means 11, and a distributed information database 12.

The telephone receiving means 7 is means of receiving a telephone call from the portable telephone terminal 2.

The telephone number acquiring means 8 is means of acquiring the telephone number of the portable telephone terminal 2 making the telephone call, by number notifying service. The number notifying service is a service in which the caller's telephone number is notified to the receiver when a telephone call is made. This service is provided by the telephone company.

The e-mail address acquiring means 9 is means of referring to the user information database 10 on the basis of the acquired telephone number and thereby acquiring the e-mail address corresponding to the acquired telephone number.

The user information database 10 is a database for storing the information of the users who may use the guidance apparatus 1, and used for corresponding the telephone number of the portable telephone terminal 2 to the e-mail address thereof.

The e-mail transmitting means 11 is means of reading out to-be-distributed guidance information from the distributed information database 12 and thereby transmitting the information by e-mail to the acquired e-mail.

Here, the user information database 10 according to the present embodiment is an example of a first table according to the invention. The URL according to the present embodiment is an example of an information browsing address according to the invention. The portable telephone terminal according to the present embodiment is an example of an info-communication terminal according to the invention. The guidance information such as an e-mail transmitted from the guidance apparatus 1 to the portable telephone terminal 2 according to the present embodiment is an example of first information according to the invention. The guidance information such as a Web page and an e-mail provided from the guidance server 3 to the portable telephone terminal 2 according to the present embodiment is an example of second information according to the invention. The e-mail transmitting means 11 and the distributed information database according to the present embodiment constitute an example of information distributing means according to the invention. The e-mail address acquiring means 9 and the user information database 10 according to the present embodiment constitute an example of e-mail address generating means according to the invention. The telephone number acquiring means 8 and the telephone receiving means 7 according to the present embodiment constitute an example of receiving means according to the invention. The guidance server 3 is an example of information providing means according to the invention.

The operation of the present embodiment in such a configuration is described below.

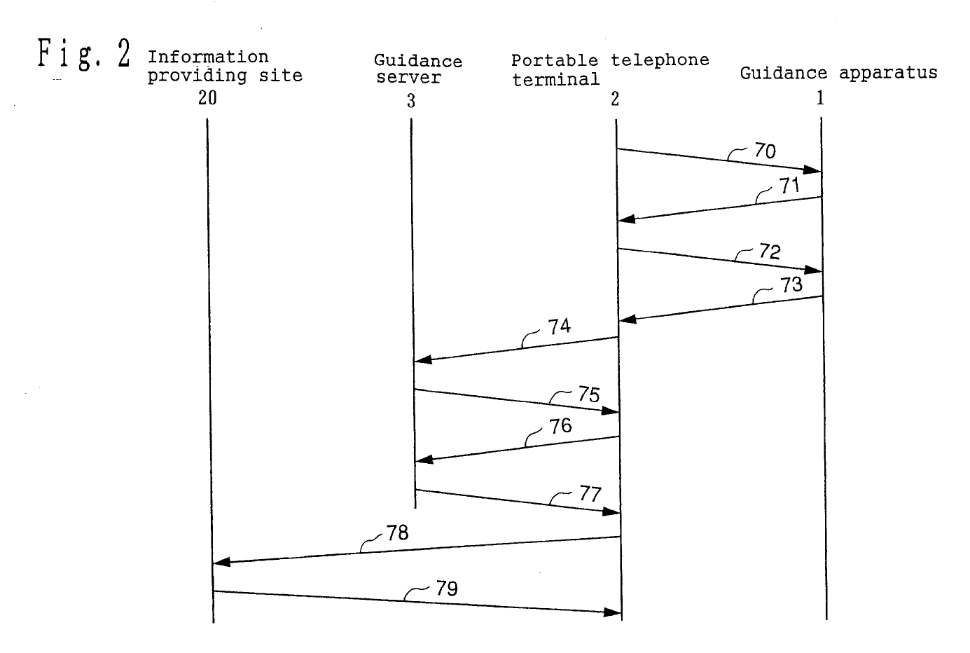

FIG. 2 shows interactions among the guidance apparatus 1, the portable telephone terminal 2, the guidance server 3, and the information providing site 20.

It is assumed that a user goes out with carrying the portable telephone terminal 2.

Further, it is assumed that in the outside, the user desires to find a shop holding a bargain sale and thereby purchase teenagers' wear at a low price.

The outline of the operation of the present embodiment is described below at first. And then, the detail is described later.

In such a case, at first, the user makes a telephone call from the portable telephone terminal 2 to the guidance apparatus 1 as indicated by a telephone call 70 in FIG. 2.

Then, the guidance apparatus 1 transmits guidance information which lists telephone numbers utilized by the user for selecting desired information, to the e-mail address of the portable telephone terminal 2 by e-mail as indicated by e-mail transmission 71.

The user selects desired information and then makes a telephone call again from the portable telephone terminal 2 to a telephone number corresponding to the desired information among the telephone numbers listed in the received guidance information, as indicated by a telephone call 72. Then, the guidance apparatus 1 transmits guidance information describing the URL of a Web page provided by the guidance server 3, to the portable telephone terminal 2 by e-mail as indicated by e-mail transmission 73.

The portable telephone terminal 2 accesses the Web page according to the URL described in the received e-mail, as indicated by access 74. Then, the guidance server 3 provides the Web page utilized by the user for selecting desired information, to the portable telephone terminal 2 as indicated by Web page delivery 75.

The portable telephone terminal 2 browses the received Web page and thereby selects desired information. Then, the portable telephone terminal 2 accesses again the guidance server 3 as indicated by access 76. The guidance server 3 then provides a Web page which lists items each having the link to an information providing site 20 providing the desired information, to the portable telephone terminal 2 as indicated by Web page delivery 77.

The user browses the received Web page on the portable telephone terminal 2, and thereby selects a listed item having the link to an information providing site 20. This permits the user to access the information providing site 20 as indicated by access 78. Thus, the information providing site 20 provides the user-desired information as a Web page to the portable telephone terminal 2.

As such, the guidance information providing system according to the present embodiment provides guidance information in a hierarchical form. That is, in order to obtain guidance information in the one-step lower hierarchy, a telephone call is made to a telephone number listed by the guidance apparatus 1. Then, in order to obtain guidance information in the one-more-step lower hierarchy, access is made to a URL of the guidance server 3 listed in the guidance information received as an e-mail, whereby the Web page provided by the guidance server 3 is browsed, and desired information is selected. According to this method, even when the URL of the information providing site 20 of a shop, such as a department store and a boutique, holding a bargain sale of teenagers' wear, is not known, the information can be obtained on the bargain sale of teenagers' wear. On the basis of the obtained information, the user can go to the shop and purchase teenagers' wear at a low price.

The detail of the above-mentioned operation is described below.

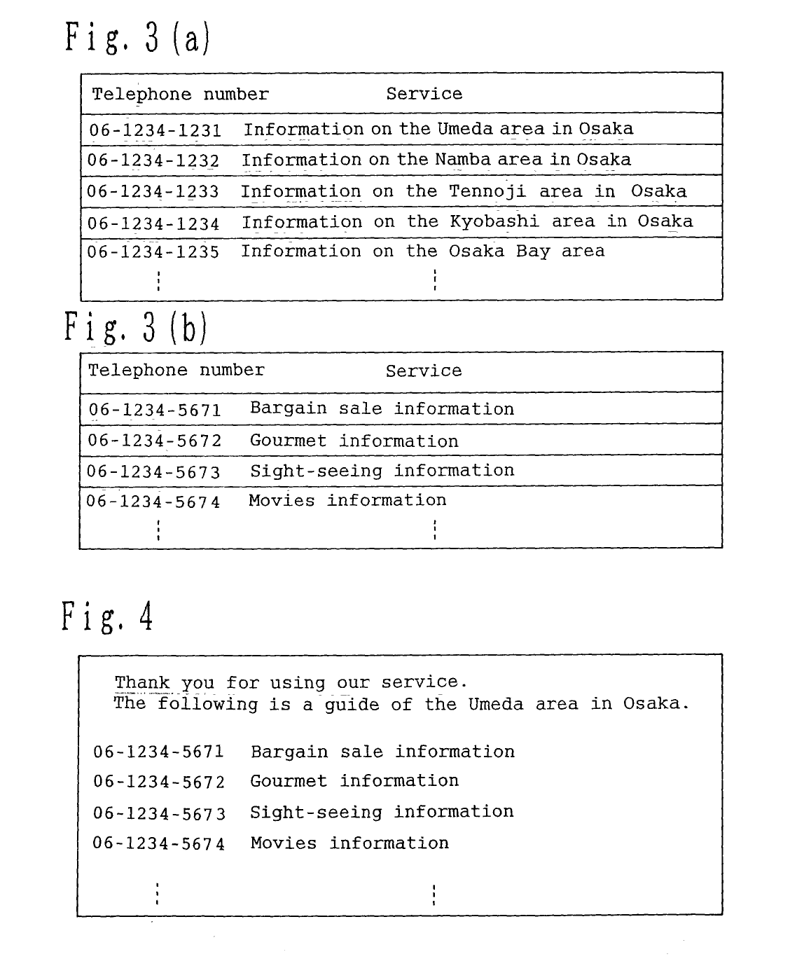

At first, the user makes a telephone call from the portable telephone terminal 2 to the guidance apparatus 1 as indicated by the telephone call 70. FIG. 3(a) shows an example of telephone numbers to which a telephone call can be made from the portable telephone terminal 2. A plurality of telephone numbers to which a telephone call can be made are listed. By selecting any one of these telephone numbers and by making a telephone call thereto, the contents of the provided service is selected. In FIG. 3(a), the telephone numbers are classified by local area. When a telephone call is made to 06-1234-1231, information on the Umeda area in Osaka is obtained. In contrast, when a telephone call is made to 06-1234-1232, information on the Namba area in Osaka is obtained. A telephone directory listing these telephone numbers is distributed to each user in advance. Further, when the portable telephone terminal 2 is brought to a service shop, such a telephone directory can be registered into the memory of the portable telephone terminal 2. The guidance apparatus 1 provides such information for each local area. Thus, detailed information can be provided to the user.

It is assumed that the user is now in Umeda in Osaka, and that the user desires to purchase teenagers' wear in Umeda in Osaka. In this case, in order to obtain information on the Umeda area in Osaka, the user makes a telephone call from the portable telephone terminal 2 to 06-1234-1231.

The telephone call from the portable telephone terminal 2 is notified to the relay station 4 by wireless communication 13, and then notified from the relay station 4 through the telephone line 14 to the telephone receiving means 7.

The telephone receiving means 7 notifies, to the telephone number acquiring means 8, that a telephone call is being made to the telephone number corresponding to the information on the Umeda area in Osaka.

The telephone number acquiring means 8 acquires the telephone number of the caller, that is, the telephone number of the portable telephone terminal 2, by number notifying service.

When receiving the notice that the telephone number acquiring means 8 has completed the acquisition of the telephone number of the portable telephone terminal 2, the telephone receiving means 7 terminates the telephone call from the portable telephone terminal 2 without replying thereto. That is, since the telephone number acquiring means 8 acquires the telephone number of the portable telephone terminal 2 by number notifying service, the telephone receiving means 7 does not reply to the telephone call from the portable telephone terminal 2. Accordingly, when the portable telephone terminal 2 makes a telephone call to the guidance apparatus 1 in order to request guidance information, no telephone charge occurs newly.

Then, the telephone number acquiring means 8 notifies the acquired telephone number of the portable telephone terminal 2 to the e-mail address acquiring means 9.

The e-mail address acquiring means 9 refers to the user information database 10, and thereby acquires the e-mail address of the addressee of the guidance information on the basis of the notified telephone number. Here, the user information database 10 stores information for corresponding the telephone number to the e-mail address. This information is generated when the user makes user registration for the use of the guidance apparatus 1.

Then, the e-mail transmitting means 11 reads out guidance information on the Umeda area in Osaka from the distributed information database 12, and thereby transmits the guidance information to the e-mail address acquired by the e-mail address acquiring means 9, by e-mail as indicated by e-mail transmission 71. As shown in FIG. 3(b), this guidance information lists telephone numbers for selecting bargain sale information, gourmet information, sight-seeing information, and the like in the Umeda area in Osaka.

The e-mail transmitted from the e-mail transmitting means 11 goes through the Internet 6 to the mail box for the portable telephone terminal 2 in the provider 5.

The portable telephone terminal 2 downloads the e-mail from its own mail box in the provider 5, and then displays the e-mail on the monitor of the portable telephone terminal 2.

FIG. 4 shows an example of the e-mail displayed on the monitor of the portable telephone terminal 2. This received e-mail lists telephone numbers for selecting desired information among the information items on the Umeda area in Osaka. As shown in the figure, bargain sale information is obtained by a telephone call to 06-1234-5671. Gourmet information is obtained by a telephone call to 06-1234-5672. Sight-seeing information on hotels, inns, and tourist spots is obtained by a telephone call to 06-1234-5673. Movies information is obtained by a telephone call to 06-1234-5674.

The user browses the e-mail displayed on the monitor of the portable telephone terminal 2, and then selects the telephone number 06-1234-5671 in which bargain sale information is obtained. In the e-mail displayed on the monitor of the ordinary portable telephone terminal 2, telephone number portions are recognized automatically and thereby displayed in a character color reversed to the character color for the other portions. Further, when the cursor is moved onto a telephone number and then the telephone number is selected, a telephone call is made to the telephone number automatically as a function of the portable telephone terminal 2.

Using this function, the user makes a telephone call again from the portable telephone terminal 2 to the telephone number 06-1234-5671 in which bargain sale information is obtained, as indicated by the telephone call 72 in FIG. 2.

Then, the guidance apparatus 1 reads out guidance information from the distributed information database 12 by an operation similar to the above-mentioned one, and thereby transmits the guidance information to the portable telephone terminal 2 by e-mail as indicated by e-mail transmission 73 in FIG. 2.

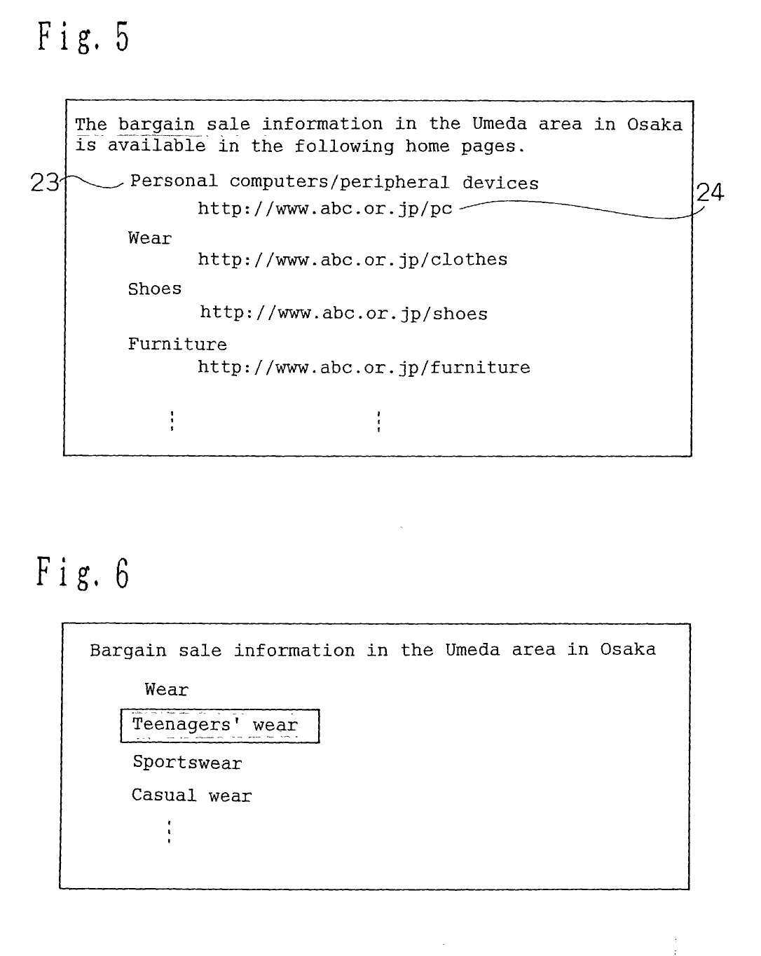

FIG. 5 shows an example of the guidance information received as an e-mail by the portable telephone terminal 2. In the e-mail, provided information is classified as personal computers/peripheral devices, wear, and the like as shown by classifications 23. Further, URLs in each of which the information belonging to each classification 23 is obtained are listed as shown by URLs 24.

In the ordinary portable telephone terminal 2 capable of being connected to the Internet 6, similarly to the above-mentioned case of telephone numbers, in the e-mail displayed on the monitor, URL portions are recognized automatically and thereby displayed in a character color reversed to the character color for the other portions. Further, when the cursor is moved onto a URL and then the URL is selected, the URL is accessed automatically as a function of the portable telephone terminal 2.

The user displays the guidance information shown in FIG. 5 onto the monitor of the portable telephone terminal 2, and thereby selects a URL 24 using the above-mentioned function. Accordingly, the user accesses the guidance server 3 in the Internet 6 as indicated by access 74 in FIG. 2.

In response to the access 74 from the portable telephone terminal 2, the guidance server 3 provides the Web page to the portable telephone terminal 2 via the Internet 6 as indicated by Web page delivery 75. FIG. 6 shows an example of the Web page provided to the portable telephone terminal 2. The Web page shown in FIG. 6 is a menu for selecting desired information among the information items on the bargain sales of wear held in the Umeda area in Osaka. That is, the detail of the desired bargain sale information can be selected among the items such as teenagers' wear, sportswear, and casual wear. Each item, such as teenagers' wear, sportswear, and casual wear, has a tag for referring to a Web page providing the information corresponding to the item.

Since the user desires to obtain information on the bargain sales of teenagers' wear in the Umeda area in Osaka, the user moves the cursor and selects “teenagers' wear” on the Web page displayed on the monitor of the portable telephone terminal 2. Then, the portable telephone terminal 2 accesses a Web page providing the information for teenagers, as indicated by access 76 in FIG. 2.

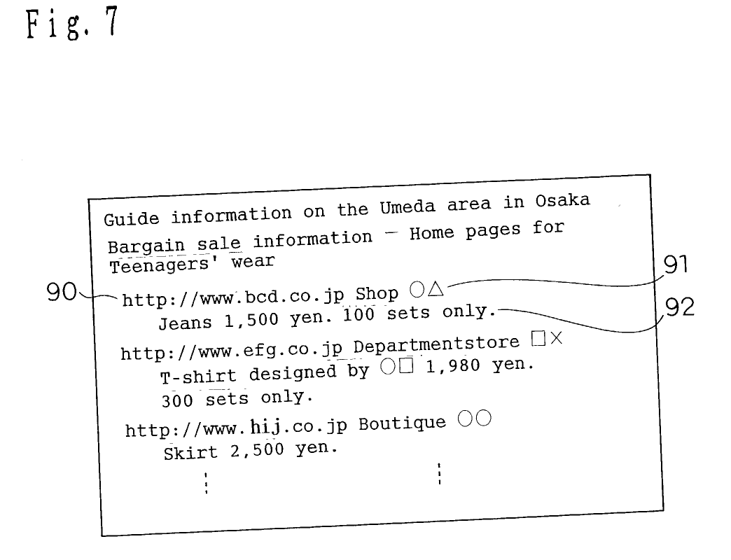

In response to the access 76 from the portable telephone terminal 2, the guidance server 2 provides the Web page to the portable telephone terminal 2 again via the Internet 6 as indicated by Web page delivery 77. FIG. 7 shows an example of the Web page provided to the portable telephone terminal 2.

This Web page introduces the Web pages of the shops providing the information on the bargain sale of teenagers' wear, among the guidance information on the Umeda area in Osaka. That is, the Web page lists: the URLs of the information providing sites 20 each holding a bargain sale of teenagers' wear as indicated by URLs 90; the names of the shops holding the bargain sales as indicated by shop names 91; and the brief descriptions thereof as indicated by descriptions 92.

Each item of the URLs 90, shop names 91, and descriptions 92 has a link for accessing the corresponding information providing site. Accordingly, when an item is selected, access is made to the corresponding information providing site.

The user browses the Web page displayed on the monitor of the portable telephone terminal 2, and it is assumed that the user thinks about the purchase of jeans. Then, the user moves the cursor and selects http://www.bcd.co.jp. This permits the portable telephone terminal 2 to access the information providing site 20 holding a bargain sale of jeans, as indicated by access 78 in FIG. 2.

In response to the access from the portable telephone terminal 2, the information providing site 20 provides the Web page to the portable telephone terminal 2 as indicated by Web page delivery 79 in FIG. 2.

The user browses the Web page provided by the information providing site 20, and thereby obtains detailed information on jeans, such as the addresses and the telephone numbers of the shops holding the bargain sales of jeans, as well as the designs of jeans. This permits the user to think the purchase in detail.

As such, even when a method for obtaining information on desired jeans is not known, the user can easily obtain the information on jeans by virtue of the information distribution system according to the present embodiment.

Further, in case that a telephone number is input manually from the portable telephone terminal 2, a numeral can be input by pressing an input button once in the portable telephone terminal 2. In contrast, in case that a URL is input manually, the URL generally contains alphabets and other signs. In this case, in order to input each single character of alphabet or other sign, the keys need to be pressed several times in the portable telephone terminal 2. Accordingly, inputting a telephone number manually is much easier and quicker than inputting a URL manually in the portable telephone terminal 2. In the present embodiment, in order to browse a Web page provided by the information providing site 20, a telephone number is manually input instead of inputting a URL. Accordingly, the present embodiment has the advantage that the operation is easier and quicker than inputting a URL manually.

In contrast, when the user desires to obtain gourmet information in the Umeda area in Osaka, the user can make a telephone call to 06-1234-5672 as shown in FIG. 4, and thereby obtain gourmet information in a manner similar to the above-mentioned case.

Further, when the e-mails sent from the guidance apparatus 1 and the Web pages sent from the guidance server 3 are saved in the portable telephone terminal 2, those menus can be used many times in order to obtain desired information.

For example, after the user purchased jeans in the above-mentioned manner, it is assumed that the user further desires to have a meal in the Umeda area in Osaka. In this case, the user can make a telephone call to 06-1234-5672 in which gourmet information in the Umeda area in Osaka is obtained, and thereby obtain the gourmet information immediately.

Further, a few days later, the user goes to the Umeda area in Osaka, and it is assumed that the user desires to purchase a personal computer/peripheral device in the Umeda area in Osaka. In this case, the user displays the e-mail shown in FIG. 5 which is already received from the guidance apparatus 1, and thereby selects the URL of personal computers/peripheral devices. Then, the user immediately obtains the Web page providing the guidance information on personal computers/peripheral devices.

As such, in the present embodiment, when the e-mails sent from the guidance apparatus 1 and the Web pages sent from the guidance server 3 are saved in the portable telephone terminal 2, those menus can be used many times in order to obtain desired information. This avoids the necessity and the time of accessing the guidance apparatus 1 and the guidance server 3 in every occasion to obtain newly desired information.

As such, by selecting any one of the predetermined telephone numbers and by making a telephone call thereto from the portable telephone terminal 2, desired guidance information is obtained. And then, desired final information is obtained from the information providing site 20.

The description of the present embodiment has been made for the case that when receiving the notice that the telephone number acquiring means 8 has completed the acquisition of the telephone number of the portable telephone terminal 2, the telephone receiving means 7 terminates the telephone call from the portable telephone terminal 2 without replying thereto. However, the invention is not restricted to this. That is, when receiving the notice that the telephone number acquiring means 8 has completed the acquisition of the telephone number of the portable telephone terminal 2, the telephone receiving means 7 may reply to the telephone call from the portable telephone terminal 2, and then terminate the telephone call. Further, after a predetermined time duration starting from the reception of the telephone call from the portable telephone terminal 2, the telephone number acquiring means 8 may reply to and then terminate the telephone call. In this case, at the time of the reply to the telephone call from the portable telephone terminal 2, a voice message, such as “please stop your telephone call,” may be sent to the portable telephone terminal 2 in order to request the portable telephone terminal 2 to stop the telephone call.

(Embodiment 2)

Embodiment 2 is described below.

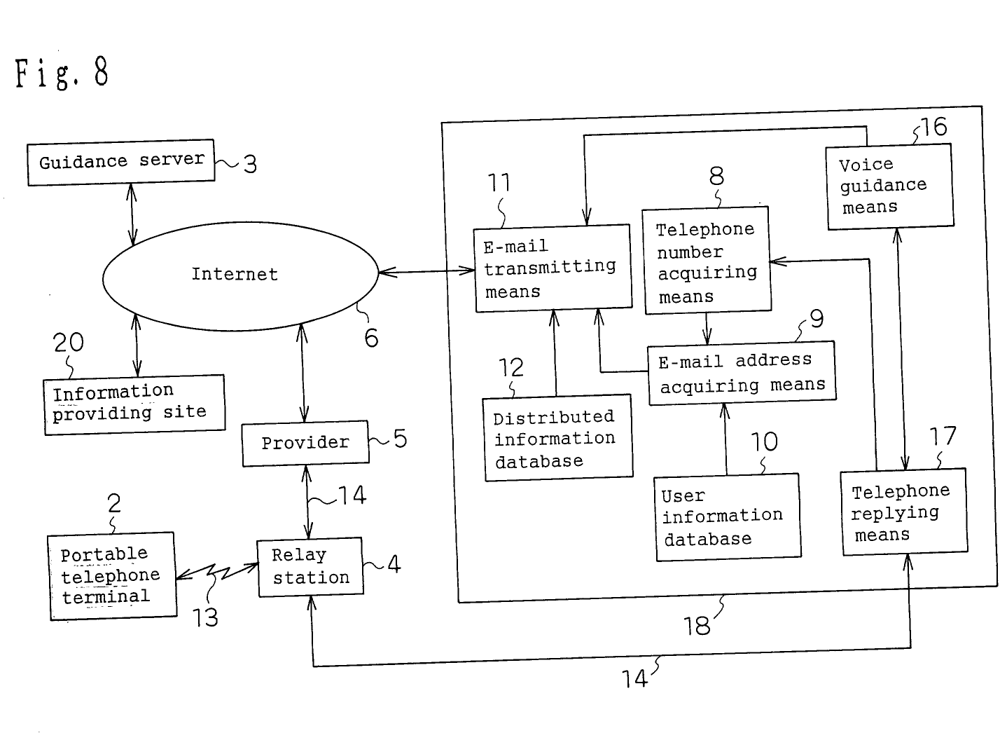

FIG. 8 shows the configuration of an information distribution system according to the present embodiment.

The information distribution system according to the present embodiment comprises a guidance apparatus 18 in place of the guidance apparatus 1 according to Embodiment 1.

The guidance apparatus 18 comprises telephone replying means 17 and voice guidance means 16 which are not included in Embodiment 1.

The telephone replying means 17 is means of replying to a telephone call when receiving the telephone call.

The voice guidance means 16 is means of carrying out voice guidance in order for the portable telephone terminal 2 to select desired guidance information.

The other configuration is the same as that in Embodiment 1, and hence the description is omitted.

Here, the telephone number acquiring means 8 and the telephone replying means 17 according to the present embodiment constitute an example of receiving means according to the invention.

The operation of the present embodiment in such a configuration is described below with focusing the attention on the difference from Embodiment 1.

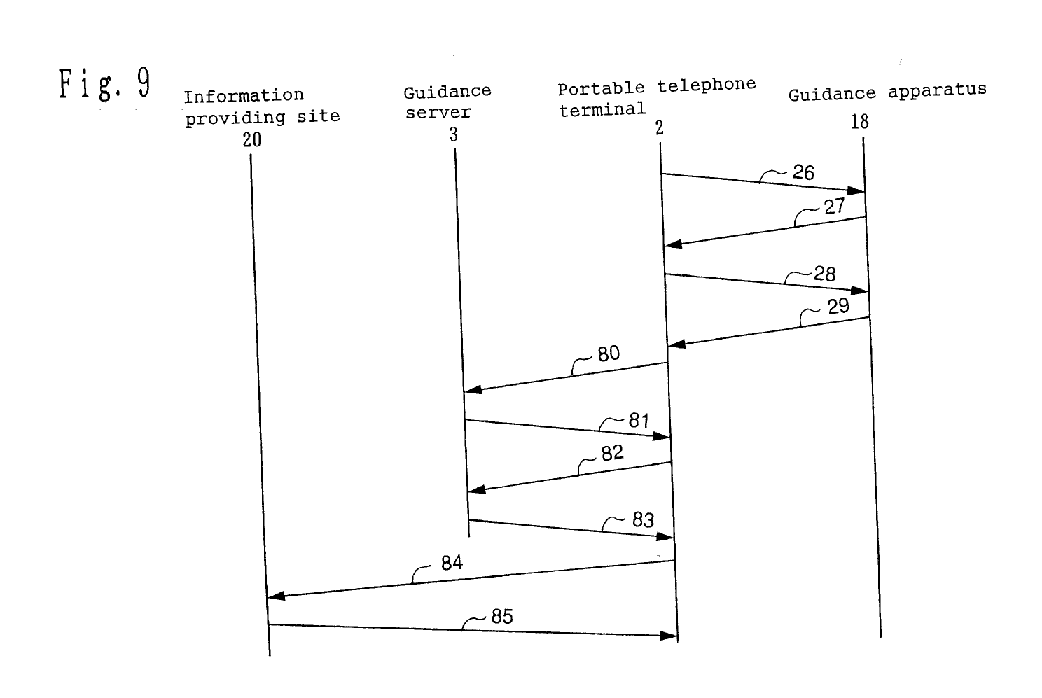

FIG. 9 shows interactions among the guidance apparatus 1, the portable telephone terminal 2, the guidance server 3, and the information providing site 20.

Similarly to Embodiment 1, it is assumed that a user goes out with carrying the portable telephone terminal 2, and that in the outside, the user desires to obtain information in order to purchase teenagers' wear at a bargain sale at a low price.

The outline of the operation in such a case is described below. Detailed operation is described later.

FIG. 9 shows interactions among the guidance apparatus 18, the portable telephone terminal 2, the guidance server 3, and the information providing site 20. At first, the user makes a telephone call from the portable telephone terminal 2 to the guidance apparatus 18 as indicated by a telephone call 26 in FIG. 9. In response to the telephone call 26, the guidance apparatus 18 transmits voice guidance as indicated by voice guidance 27. On the basis of the voice guidance 27, the portable telephone terminal 2 selects desired guidance information as indicated by menu selection 28. Then, the guidance apparatus 18 transmits selected guidance information to the portable telephone terminal 2 by e-mail as indicated by e-mail transmission 29.

The portable telephone terminal 2 accesses a Web page according to the URL described in the received e-mail, as indicated by access 80. Then, the guidance server 3 provides the Web page utilized by the user for selecting desired information, to the portable telephone terminal 2 as indicated by Web page delivery 81.

The user browses the Web page sent to the portable telephone terminal 2, and thereby selects desired information. Then, access is made to a Web page providing the desired information, as indicated by access 82.

In response to the access 82, the guidance server 3 provides the Web page to the portable telephone terminal 2.

The portable telephone terminal 2 selects the URL of an information providing site 20 in the list, and thereby accesses the information providing site 20 as indicated by access 84. That is, the address of each information providing site 20 has a link for accessing the information providing site 20.

Then, the information providing site 20 provides the user-desired information as a Web page to the portable telephone terminal 2.

As such, similarly to Embodiment 1, the guidance information providing system according to the present embodiment provides guidance information in a hierarchical form. The difference is that the guidance apparatus 18 provides a part of the hierarchical guidance information as voice guidance.

According to this method, even when the URL of the information providing site 20 of a shop, such as a department store and a boutique, holding a bargain sale of teenagers' wear, is not known, the information can be obtained on the bargain sale of teenagers' wear. On the basis of the obtained information, the user can go to the shop and purchase teenagers' wear at a low price.

The detail of the above-mentioned operation is described below.

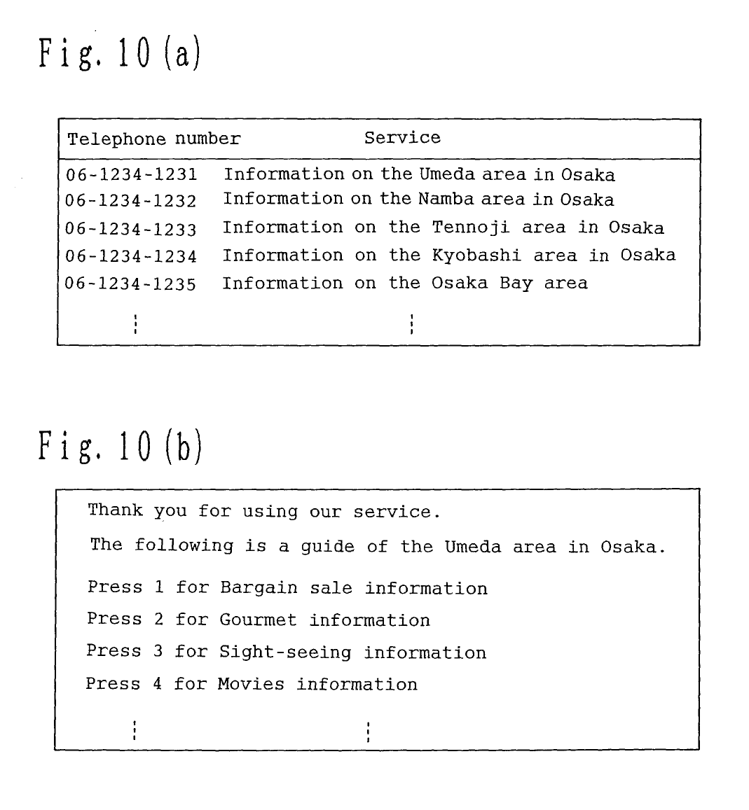

FIG. 10(a) shows the classification of provided information for each local area. Similarly to Embodiment 1, it is assumed that the user desires to obtain information on the bargain sales of wear in the Umeda area in Osaka.

Then, the portable telephone terminal 2 makes a telephone call to 06-1234-1231 as indicated by a telephone call 26. The telephone replying means 17 replies to the telephone call. The telephone replying means 17 notifies, to the voice guidance means 16, that the telephone call is replied.

On receiving the notification, the voice guidance means 16 sends voice guidance as indicated by voice guidance 27 in FIG. 9. On the basis of the voice guidance 27, the user of the portable telephone terminal 2 selects desired information as indicated by menu selection 28 in FIG. 9.

FIG. 10 shows an example in which desired guidance information is selected on the basis of voice guidance.

At first, the guidance apparatus 18 guides so as to input numeral 1 in the portable telephone terminal 2 for selecting the bargain sale information, and similarly, numeral 2 for gourmet information, numeral 3 for sight-seeing information, and numeral 4 for movies information.

It is assumed that the user of the portable telephone terminal 2 inputs numeral 1 on the basis of the voice guidance.

On receiving numeral 1 from the portable telephone terminal 2, the voice guidance means 16 notifies the completion of the voice guidance, to the telephone replying means 17. In response to this notification, the telephone replying means 17 terminates the telephone call with the portable telephone terminal 2.

Then, the voice guidance means 16 notifies the selected guidance information to the e-mail transmitting means 11 as indicated by e-mail transmission 29 in FIG. 9.

On the other hand, similarly to Embodiment 1, the telephone number acquiring means 8 acquires the telephone number of the portable telephone terminal 2 by number notifying service, and then notifies the telephone number to the e-mail address acquiring means 9.

Similarly to Embodiment 1, the e-mail address acquiring means 9 acquires the e-mail address of the portable telephone terminal 2, and then notifies the e-mail address to the e-mail transmitting means 11.

The e-mail transmitting means 11 reads out, from the distributed information database 12, the guidance information on bargain sale information notified from the voice guidance means 16, and thereby transmits the guidance information to the e-mail address acquired by the e-mail address acquiring means 9, by e-mail as indicated by e-mail transmission 29.

The operation subsequent to this is the same as that of Embodiment 1, and hence the description is omitted.

As such, according to the present embodiment, desired information can be selected on the basis of voice guidance.

(Embodiment 3)

Embodiment 3 is described below.

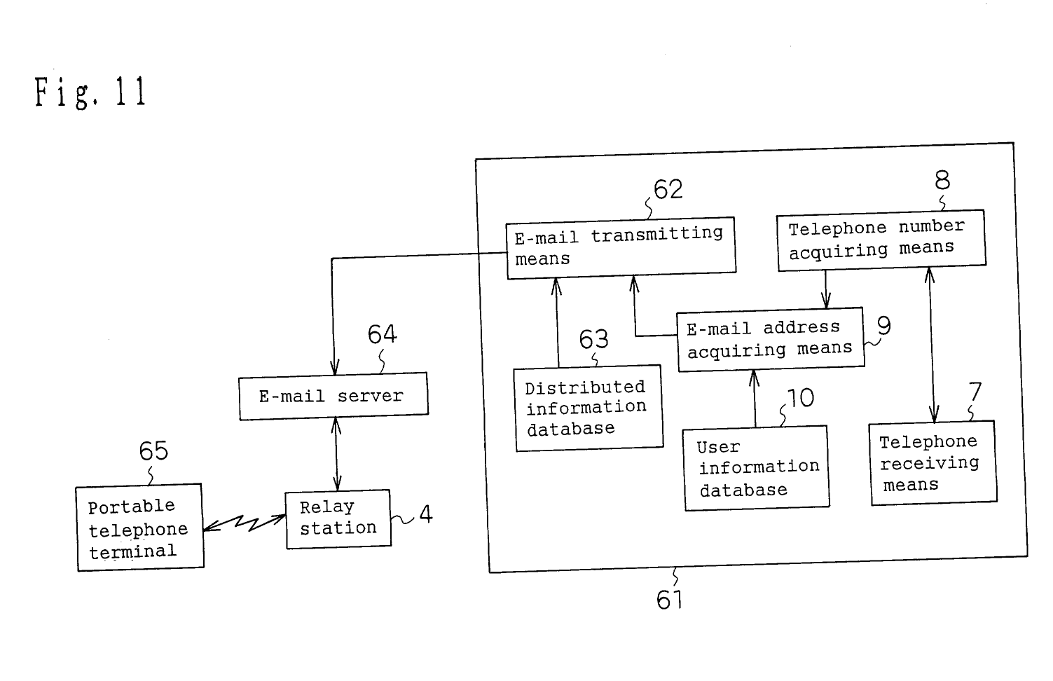

FIG. 11 shows the configuration of an information distribution system according to the present embodiment.

In the information distribution system according to the present embodiment, a difference from that of Embodiment 1 is that a portable telephone terminal 65 does not have the function of connection to the Internet.

Further, an e-mail server 64 is a server used by the portable telephone terminal 65 and a guidance apparatus 1 for the purpose of exchanging e-mails.

The other configuration is the same as that in Embodiment 1, and hence the description is omitted.

Here, guidance information, such as an e-mail, transmitted from the guidance apparatus 61 to the portable telephone terminal 2 according to the present embodiment is an example of first information according to the invention The e-mail transmitting means 62 and the distributed information database 63 according to the present embodiment constitute an example of information distributing means according to the invention. The telephone number acquiring means 8 and the telephone receiving means 7 according to the present embodiment constitute an example of receiving means according to the invention.

The operation of the present embodiment in such a configuration is described below with focusing the attention on the difference from Embodiment 1.

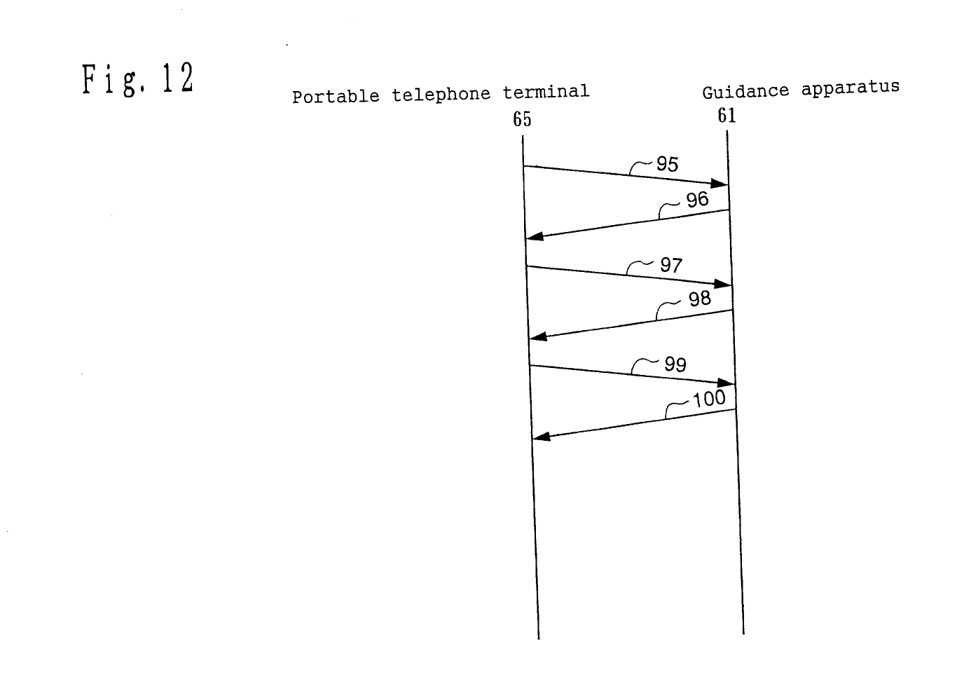

FIG. 12 shows interactions between the portable telephone terminal 65 and the guidance apparatus 61. In the present embodiment, similarly to Embodiment 1, description is made for the case that a user uses the portable telephone terminal 65 and obtains information on the bargain sales of teenagers' wear in the Umeda area in Osaka, thereby thinking the purchase of jeans.

The user makes a telephone call from the portable telephone terminal 2 to 06-1234-1231 shown in FIG. 3(a) as indicated by a telephone call 95 in FIG. 12.

Then, the guidance apparatus 1 transmits an e-mail describing the contents shown in FIG. 4, to the portable telephone terminal 2 as indicated by e-mail transmission 96. The e-mail is transmitted to the portable telephone terminal 65 via the e-mail server 64.

Then, the user makes a telephone call, among the telephone numbers shown in FIG. 4, to the telephone number 06-1234-5671 in which bargain sale information is obtained, as indicated by a telephone call 97 in FIG. 12. The above-mentioned operation is the same as that of Embodiment 1, except that the e-mail server 64 processes the reception of the e-mail.

Then, the guidance apparatus 1 transmits the guidance information on bargain sale information to the portable telephone terminal 65 by e-mail as indicated by e-mail transmission 98.

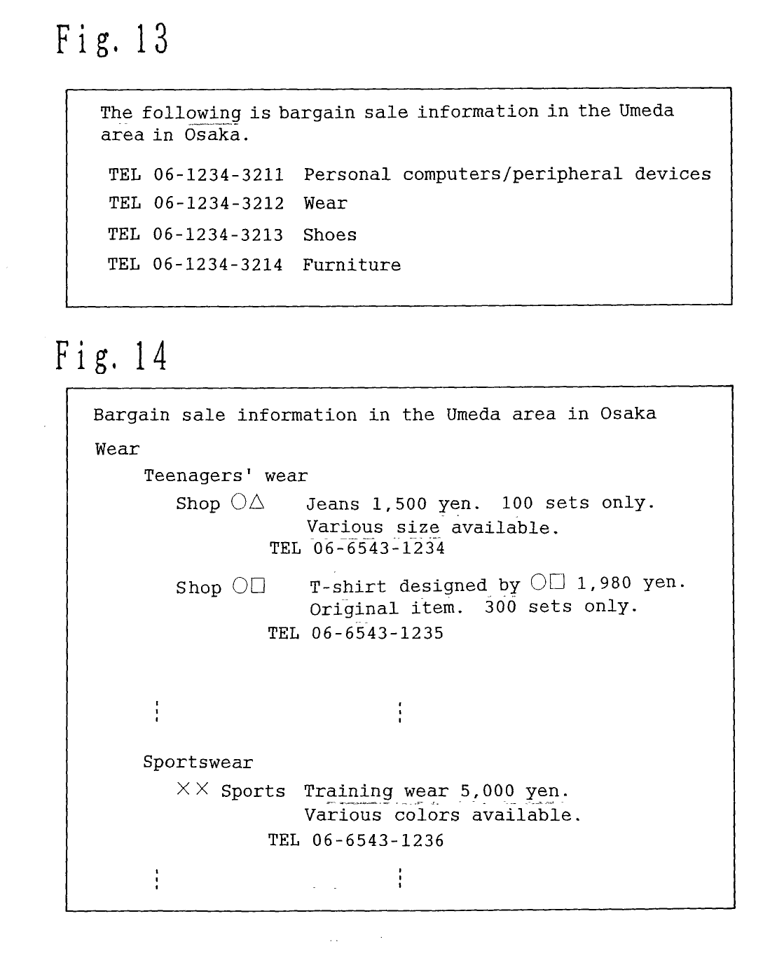

FIG. 13 shows the guidance information sent to the portable telephone terminal 65. In this e-mail, in contrast to that of Embodiment 1, telephone numbers are listed in place of URLs.

The user makes a telephone call to the telephone number 06-1234-3212 in which guidance information on wear is obtained, as indicated by a telephone call 99 in FIG. 12.

Then, the guidance apparatus 61 transmits an e-mail describing the information on the bargain sales of wear in the Umeda area in Osaka, to the portable telephone terminal 65 by e-mail as indicated by e-mail transmission 100 in FIG. 12.

FIG. 14 shows an example of the received e-mail. The e-mail lists the bargain sale information of wear, with classifying the information as teenagers' wear, sportswear, and the like. On the basis of the received bargain sale information, the user finds that a shop ∘Δ sells jeans at a low price.

(Embodiment 4)

Embodiment 4 is described below.

The configuration of an information distribution system according to the present embodiment is the same as that of Embodiment 1.

The difference of the present embodiment from Embodiment 1 is that the final information obtained by the user is transmitted as an e-mail from the guidance server 3.

The other operation is the same as that in Embodiment 1, and hence the description is omitted.

The operation of the present embodiment in such a configuration is described below with focusing the attention on the difference from Embodiment 1.

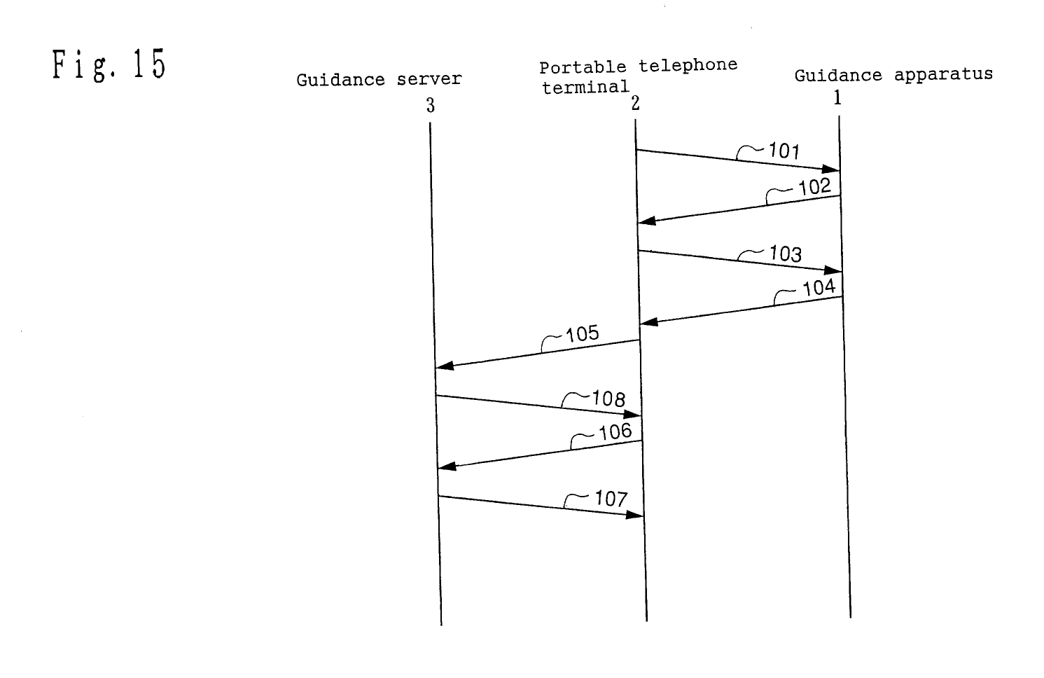

FIG. 15 shows interactions among the guidance apparatus 1, the portable telephone terminal 2, and the guidance server 3.

At first, the user makes a telephone call from the portable telephone terminal 2 to 06-1234-1231 in order to obtain information on the Umeda area in Osaka, as indicated by a telephone call 101 in FIG. 15.

Then, the guidance apparatus 1 transmits an e-mail describing the contents shown in FIG. 4, to the portable telephone terminal 2 as indicated by e-mail transmission 102 in FIG. 15.

The user makes a telephone call from the portable telephone terminal 2 to the telephone number 06-1234-5671 in which bargain sale information is obtained as shown in FIG. 4, as indicated by a telephone call 103 in FIG. 15.

Then, the guidance apparatus 1 transmits an e-mail describing the contents shown in FIG. 5, to the portable telephone terminal 2 as indicated by e-mail transmission 104 in FIG. 15.

On the basis of the received e-mail, access is made to a Web page in the guidance server 3 providing the bargain sale information of wear, as indicated by access 105 in FIG. 15.

Then, the guidance server 3 transmits a Web page shown in FIG. 6, to the portable telephone terminal 2 as indicated by Web page transmission 108 in FIG. 15.

The above-mentioned operation is the same as that of Embodiment 1.

Then, the portable telephone terminal 2 selects “teenagers' wear” in the Web page shown in FIG. 6, and thereby requests an e-mail describing the information on teenagers' wear, as indicated by e-mail request 106 in FIG. 15.

Then, the guidance server 3 transmits the bargain sale information of teenagers' wear, to the portable telephone terminal 2 by e-mail as indicated by e-mail transmission 107 in FIG. 15.

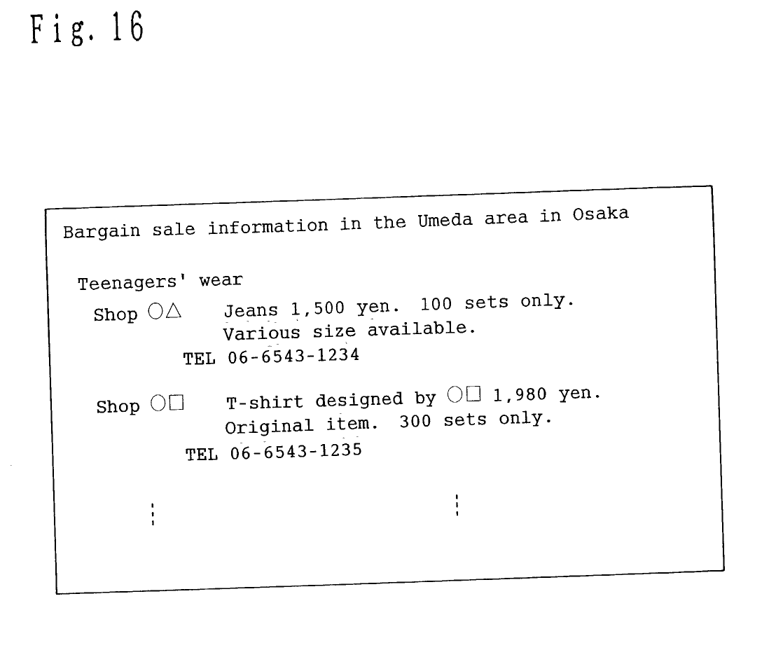

FIG. 16 shows an example of the received e-mail. In FIG. 16, for simplicity in illustration, it is assumed that the e-mail lists shop names, their telephone numbers, and brief descriptions. However, the e-mail may actually list more detailed descriptions such as detailed descriptions of respective bargain articles.

On the basis of this e-mail, the user thinks the purchase of jeans similarly to Embodiment 1.

(Embodiment 5)

Embodiment 5 is described below.

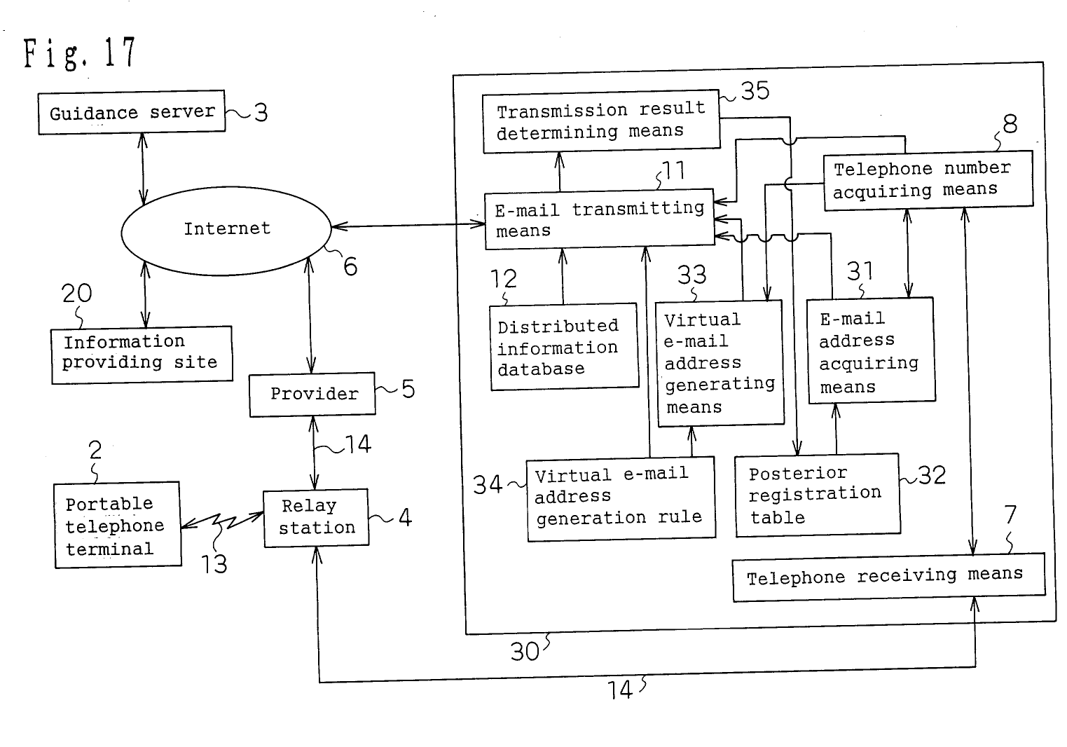

FIG. 17 shows the configuration of an information distribution system according to the present embodiment.

A guidance apparatus 30 according to the present embodiment comprises e-mail address acquiring means 31, a posterior registration table 32, virtual e-mail address generating means 33, and a virtual e-mail address generating rule 34 in place of the e-mail address acquiring means 9 and the user information database 10 according to Embodiment 1.

The virtual e-mail address generating rule 34 is a rule for generating an e-mail address for a portable telephone terminal 2 from the telephone number of the portable telephone terminal 2.

The virtual e-mail address generating means 33 is means of generating a virtual e-mail address which is an e-mail address corresponding to a portable telephone terminal 2, from the telephone number of the portable telephone terminal 2 on the basis of the virtual e-mail address generating rule 34.

Here, the virtual e-mail address according to the present embodiment is an e-mail address, however, a portable telephone terminal 2 corresponding to this e-mail address may not necessarily exist. Accordingly, when an e-mail is transmitted to a virtual e-mail address, the transmission is successful in some cases, but the transmission fails when no corresponding mail box exists.

The posterior registration table 32 is a table in which when the above-mentioned e-mail transmission to a virtual e-mail address is successful, the virtual e-mail address is registered such as to be corresponded to the telephone number of the portable telephone terminal 2.

The e-mail address acquiring means 31 is means of acquiring the e-mail address of a portable telephone terminal 2 by searching the posterior registration table 32, when the e-mail address of the portable telephone terminal 2 is already registered in the posterior registration table 32.

Here, the posterior registration table 32 according to the present embodiment is an example of a second table according to the invention. The e-mail transmitting means 11, the distributed information database 12, and the transmission result determining means 35 according to the present embodiment constitute an example of information distributing means according to the invention. The e-mail address acquiring means 9, the posterior registration table 32, the virtual e-mail address generating means 33, and the virtual e-mail address generating rule 34 according to the present embodiment constitute an example of e-mail address generating means according to the invention. The telephone number acquiring means 8 and the telephone receiving means 7 according to the present embodiment constitute an example of receiving means according to the invention.

The operation of the present embodiment in such a configuration is described below with focusing the attention on the difference from Embodiment 1.

When there is not yet any telephone call from any portable telephone terminal 2, the posterior registration table 32 is not yet generated in the guidance apparatus 30. Obviously, neither telephone number of a portable telephone terminal 2 nor e-mail address corresponding to the telephone number of the portable telephone terminal 2 is registered yet.

Interactions among the guidance apparatus 30, the portable telephone terminal 2, the guidance server 3, and the information providing site 20 are those shown in FIG. 2 similarly to Embodiment 1. That is, in the following description, the guidance apparatus 1 shown in FIG. 2 is to be read as the guidance apparatus 30.

Similarly to Embodiment 1, it is assumed that a user goes out with carrying the portable telephone terminal 2.

Further, it is assumed that in the outside, the user desires to find a shop holding a bargain sale and thereby purchase teenagers' wear at a low price.

In such a case, at first, the user makes a telephone call from the portable telephone terminal 2 to the guidance apparatus 30 as indicated by a telephone call 70 in FIG. 2.

At first, the user makes a telephone call from the portable telephone terminal 2 to the guidance apparatus 1 as indicated by a telephone call 70 in FIG. 2. Similarly to Embodiment 1, FIG. 3(a) shows an example of telephone numbers to which a telephone call can be made from the portable telephone terminal 2.

It is assumed that the user is now in Umeda in Osaka, and that the user desires to purchase teenagers' wear in Umeda in Osaka. Thus, in order to obtain information on the Umeda area in Osaka, the user makes a telephone call from the portable telephone terminal 2 to 06-1234-1231.

The telephone call from the portable telephone terminal 2 is notified to the relay station 4 by wireless communication 13, and then notified from the relay station 4 through the telephone line 14 to the telephone receiving means 7.

The telephone receiving means 7 notifies, to the telephone number acquiring means 8, that a telephone call is being made to the telephone number corresponding to the information on the Umeda area in Osaka.

The telephone number acquiring means 8 acquires the telephone number of the caller, that is, the telephone number of the portable telephone terminal 2, by number notifying service.

When receiving the notice that the telephone number acquiring means 8 has completed the acquisition of the telephone number of the portable telephone terminal 2, the telephone receiving means 7 terminates the telephone call from the portable telephone terminal 2.

Then, the telephone number acquiring means 8 notifies the acquired telephone number of the portable telephone terminal 2 to the e-mail address acquiring means 9.

In the initial state in which the posterior registration table 32 is not yet generated, the e-mail address acquiring means 31 notifies, to the telephone number notifying means 8, that no e-mail address corresponding to the acquired telephone number is not acquired.

On receiving the notification from the e-mail address acquiring means 31, the telephone number acquiring means 8 notifies the acquired telephone number to the virtual e-mail address generating means 33.

The virtual e-mail address generating means 33 generates a virtual e-mail address from the notified telephone number on the basis of the virtual e-mail address generating rule 34 as described below.

That is, the telephone company assigns an e-mail address to the portable telephone terminal 2 the communications service of which is provided by the company, on the basis of the telephone number of the portable telephone terminal 2 according to a predetermined rule. An example of such rule is that an e-mail address “telephone number@domain name” is assigned to the portable telephone terminal 2.

More specifically, when the telephone number of the portable telephone terminal 2 is “09012345678”, and when the domain name of the telephone company providing the service to the portable telephone terminal 2 is “abc.ne.jp”, an e-mail address “12345678@abc.ne.jp” is assigned.

Here, the domain name used in such e-mail addresses is different depending on each telephone company. In telephone company A, a different domain name is used for each local area where the user of the portable telephone terminal 2 resides. In contrast, in telephone company B, a plurality of domain names are used. And, any one of the domain names is selected, for example, depending on the type of contract with the user of the portable telephone terminal 2, whereby the e-mail address of the portable telephone terminal 2 is generated as the combination of the telephone number of the portable telephone terminal 2 and the selected domain name. In telephone company C, a single domain name is used.

Thus, specifically speaking, the virtual e-mail address generating rule 34 is a rule in which a virtual e-mail address is generated as the combination of the telephone number of the portable telephone terminal 2 and a domain name used in the telephone company, as described above. Accordingly, a single domain name or a plurality of domain names may be used in a single telephone company or a single branch thereof.

As such, the virtual e-mail address generating means 33 generates a virtual e-mail address by combining the telephone number notified from the telephone number acquiring means 8 with the domain name used in the telephone company or a branch thereof according to the virtual e-mail address generating rule 34. At this time, the virtual e-mail address generating means 33 generates virtual e-mail addresses using not only the domain name used in the telephone company or the branch thereof providing the communications service to the portable telephone terminal 2 but also the domain names used in the other telephone companies or the branches thereof.

Accordingly, the virtual e-mail addresses generated according to the virtual e-mail address generating rules 34 exist in a number equal to that of the domain names used in all the telephone companies and the branches thereof.

As such, the virtual e-mail address generating means 33 generates all possible virtual e-mail addresses according to the virtual e-mail address generating rules 34 each used for generating an e-mail address from a telephone number in a telephone company.

The virtual e-mail address generating means 33 notifies the generated virtual e-mail addresses to the e-mail transmitting means 11.

Then, the e-mail transmitting means 11 reads out guidance information on the Umeda area in Osaka from the distributed information database 12, and thereby transmits the guidance information to all the virtual e-mail addresses notified from the virtual e-mail address generating means 33, by e-mail as indicated by e-mail transmission 71 in FIG. 2.

For example, when eight virtual e-mail addresses are notified, the e-mail transmitting means 11 transmits the guidance information by e-mail to each of the eight e-mail addresses. When a virtual e-mail address coincides with the e-mail address of the portable telephone terminal 2, the e-mail transmitted from the e-mail transmitting means 11 to the virtual e-mail address reaches the mail box for the portable telephone terminal 2 in the provider 5, via the Internet 6. In case that the rule for generating an e-mail address from the telephone number is not unified, that is, in case that any one of a plurality of possible e-mail addresses is assigned to the telephone number, an e-mail is transmitted to every virtual e-mail address possible to be assigned to the telephone number. Accordingly, one and only one e-mail securely reaches the e-mail address actually assigned to the portable telephone terminal 2.

In the e-mail transmission, the e-mail transmitting means 11 changes the amount and/or the contents of the guidance information for each virtual e-mail address used in the transmission, according to the virtual e-mail address generating rules 34.

That is, on the basis of each virtual e-mail address generated according to the virtual e-mail address generating rules 34, the telephone company or the branch thereof is identified. Further, the type of the portable telephone terminal 2 provided by the telephone company is identified. In case that the identified type does not have the function that the selecting of an e-mail address or a URL in the text of the displayed e-mail causes a telephone call to the telephone number or access to a Web page corresponding to the URL, a message, such as “please input a URL listed in the text” and “please make a telephone call to a telephone number listed in the text,” is inserted into the guidance information.

In case that the identified type has such a function, a message, such as “please select a URL listed in the text” and “please select a telephone number listed in the text,” is inserted into the guidance information.

Further, in case that the guidance information having such a message inserted exceeds the limit of the number of characters which can be received by the identified type, the number of characters in the guidance information is reduced, and then the guidance information is transmitted by e-mail. As such, the e-mail transmitting means 11 changes the amount and/or the contents of the transmitted guidance information depending on each telephone number and each virtual e-mail address.

The e-mail transmitting means 11 notifies, to the transmission result determining means 35, the telephone number notified from the telephone number acquiring means 8 and the virtual e-mail address to which the e-mail is transmitted.

In case that the virtual e-mail address does not coincide with the e-mail address of the portable telephone terminal 2, the provider 5 transmits an error message indicating that the e-mail is not deliverable, to the e-mail address of the guidance apparatus 30.

That is, when the e-mail transmitting means 11 transmits to a plurality of virtual e-mail addresses, at least one virtual e-mail address coincides with the e-mail address of the portable telephone terminal 2. Accordingly, the portable telephone terminal 2 can receive an e-mail transmitted from the e-mail transmitting means 11.

On the other hand, when receiving an error reply e-mail transmitted from the provider 5, the transmission result determining means 35 analyzes the header portion of the e-mail address, and thereby identifies that the e-mail is not an ordinary e-mail but an error reply e-mail. Further, identified is the virtual e-mail address to which the original e-mail is transmitted.

Such identification is carried out as follows. The header portion of an e-mail via the Internet describes the e-mail address of the sender and the e-mail address of the addressee. The header portion further describes the names of all servers having relayed the e-mail, between the server having transmitted the e-mail and the server having received the e-mail.

Accordingly, when the e-mail addresses of the sender and the addressee are acquired from the header portion of the e-mail, found is the virtual e-mail address to which the guidance apparatus 30 has transmitted an e-mail. Further, in case that the header portion of the e-mail describes both: the route between the server used for the e-mail transmission by the guidance apparatus 30 and the provider 5; and the route between the provider 5 and the server used for the e-mail reception by the guidance apparatus 30; the e-mail is determined as an error reply e-mail. Thus, a virtual e-mail address not found in the header portions of such error reply e-mails is determined as a successful e-mail address for e-mail transmission.

In the above-mentioned description, the transmission result determining means 35 has analyzed the header portion of a received e-mail in order to determine whether the e-mail is an error reply e-mail or not. However, the invention is not restricted to this. The title or the text of the received e-mail may be analyzed in order to determine whether the e-mail is an error reply e-mail or not.

As such, the transmission result determining means 35 determines whether the e-mail transmission was successful or not, for each virtual e-mail address.

Then, when among the virtual e-mail addresses, there is an e-mail the transmission of which was successful, the transmission result determining means 35 generates a posterior registration table 32 newly, and then registers the virtual e-mail address to which the e-mail transmission was successful, into the posterior registration table 32 in the form corresponded to the telephone number notified from the e-mail transmitting means 11.

When the posterior registration table 32 is already generated, and when a virtual e-mail address to which the e-mail transmission was unsuccessful is already registered in the posterior registration table 32, the virtual e-mail address is deleted from the posterior registration table 32.

On the other hand, the portable telephone terminal 2 downloads the e-mail transmitted from the e-mail transmitting means 11, from its own mail box in the provider 5, and then displays the e-mail on the monitor of the portable telephone terminal 2.

FIG. 4 shows an example of the e-mail displayed on the monitor of the portable telephone terminal 2. The user browses the e-mail displayed on the monitor of the portable telephone terminal 2, and then selects the telephone number 06-1234-5671 in which bargain sale information is obtained.

The user makes a telephone call again from the portable telephone terminal 2 to the telephone number 06-1234-5671 in which bargain sale information is obtained, as indicated by a telephone call 72 in FIG. 2.

Then, similarly to the case of the telephone call 70, the telephone number acquiring means 8 notifies the acquired telephone number to the e-mail address acquiring means 31.

On receiving the telephone number from the telephone number acquiring means 8, the e-mail address acquiring means 31 searches the posterior registration table 32 already generated, and thereby acquires an e-mail address corresponding to the notified telephone number, that is, the e-mail address of the portable telephone terminal 2.

The e-mail address acquiring means 31 then notifies the acquired e-mail address of the portable telephone terminal 2 to the e-mail transmitting means 11.

Then, similarly to the above-mentioned case, the e-mail transmitting means 11 reads out guidance information from the distributed information database 12, and thereby transmits the guidance information to the notified e-mail address of the portable telephone terminal 2 by e-mail as indicated by e-mail transmission 73 in FIG. 2. Then, similarly to the above-mentioned case, the transmission result determining means 35 determines whether the e-mail transmission was successful or not, and thereby updates the posterior registration table 32 on the basis of the determination result.

After that, interactions shown in FIG. 2 are carried out among the information providing site 20, the guidance server 3, the portable telephone terminal 2, and the guidance apparatus 30. These interactions are already described in detail in Embodiment 1, and hence the description is omitted.

As described above, according to the present embodiment, even in case that a user is not registered in advance, the portable telephone terminal 2 can use the guidance apparatus 30. Further, into the posterior registration table 34, at the first time when the guidance information is distributed, an e-mail address to which the distribution was successful is registered into the posterior registration table 32 in the form corresponded to the telephone number of the portable telephone terminal 2. Accordingly, when guidance information is distributed in subsequent steps, the appropriate e-mail address is obtained by searching the posterior registration table 32. Thus, when the portable telephone terminal 2 uses the guidance apparatus 36 twice or more, useless distribution of guidance information to the invalid virtual e-mail addresses is avoided.

In the present embodiment, even in case that the posterior registration table 32, the e-mail address acquiring means 31, and the transmission result determining means 35 are removed from the guidance apparatus 30, the same effect as that of Embodiment 1 is obtained. In this case, the system configuration becomes simpler. Further, the search for an e-mail address corresponding to the telephone number is not necessary. This speeds up the distribution of guidance information.

The description of the present embodiment has been made for the case that the virtual e-mail address generating means 33 generates, from the telephone number of the portable telephone terminal 2, all possible virtual e-mail addresses which may be assigned by the telephone companies and the branches thereof. However, the invention is not restricted to this.

That is, a list showing which telephone number is assigned to which telephone company is made public by the Ministry of Posts and Telecommunications. Accordingly, by referring to this list, one can identify the telephone company providing the communications service to the portable telephone terminal 2, and even the branch thereof providing the communications service in which local area.

The list showing which telephone number is assigned to which telephone company may be used as a virtual e-mail address generating rule 34.

In other words, as virtual e-mail address generating rules 34, a first rule is set such that the telephone company providing the communications service to the portable telephone terminal 2 and the branch thereof providing the communications service in the local area are identified from the telephone number. Then, another rule is set such that the domain name used in the identified telephone company is identified. Here, it should be noted that a domain name or a plurality of domain names may be used by the telephone company or the branch thereof identified by the telephone number, as described above.

Then, at first, according to the telephone number assigning rule of the above-mentioned virtual e-mail address generating rules 34, on the basis of the telephone number of the portable telephone terminal 2, the virtual e-mail address generating means 33 identifies the telephone company and the branch thereof providing the communications service to the telephone number. Then, the domain name used in the identified telephone company or branch thereof is identified, whereby a virtual e-mail address may be generated by combining the telephone number of the portable telephone terminal 2 with the identified domain name. This reduces the number of e-mails transmitted by the e-mail transmitting means 11 at a time.

Further, the description of the present embodiment has been made for the case that the type of the portable telephone terminal 2 is identified from the virtual e-mail address, and that the amount and/or the contents of the information transmitted by e-mail is thereby changed depending on each virtual e-mail address. However, the invention is not restricted to this. For example, similarly to the above-mentioned modified case in which the virtual e-mail address generating rules 34 include a rule for identifying, from the telephone number, the telephone company or the branch thereof providing the communications service to the portable telephone terminal 2 to which the telephone number is assigned, the telephone company or the branch thereof may be identified from the telephone number of the portable telephone terminal 2. Then, the type of the portable telephone terminal 2 used in the identified telephone company or branch thereof may be identified, whereby the amount and/or the contents of the information transmitted by e-mail may be changed depending on the identified type. That is, the amount and/or the contents of the information transmitted by e-mail may be changed depending on the telephone number of the portable telephone terminal 2. In summary, the amount and/or the contents of the information transmitted by e-mail may be changed depending on at least one or more of the telephone number of the portable telephone terminal 2, the virtual e-mail address generating rules 34, and the generated virtual e-mail addresses.

(Embodiment 6)

Embodiment 6 is described below.

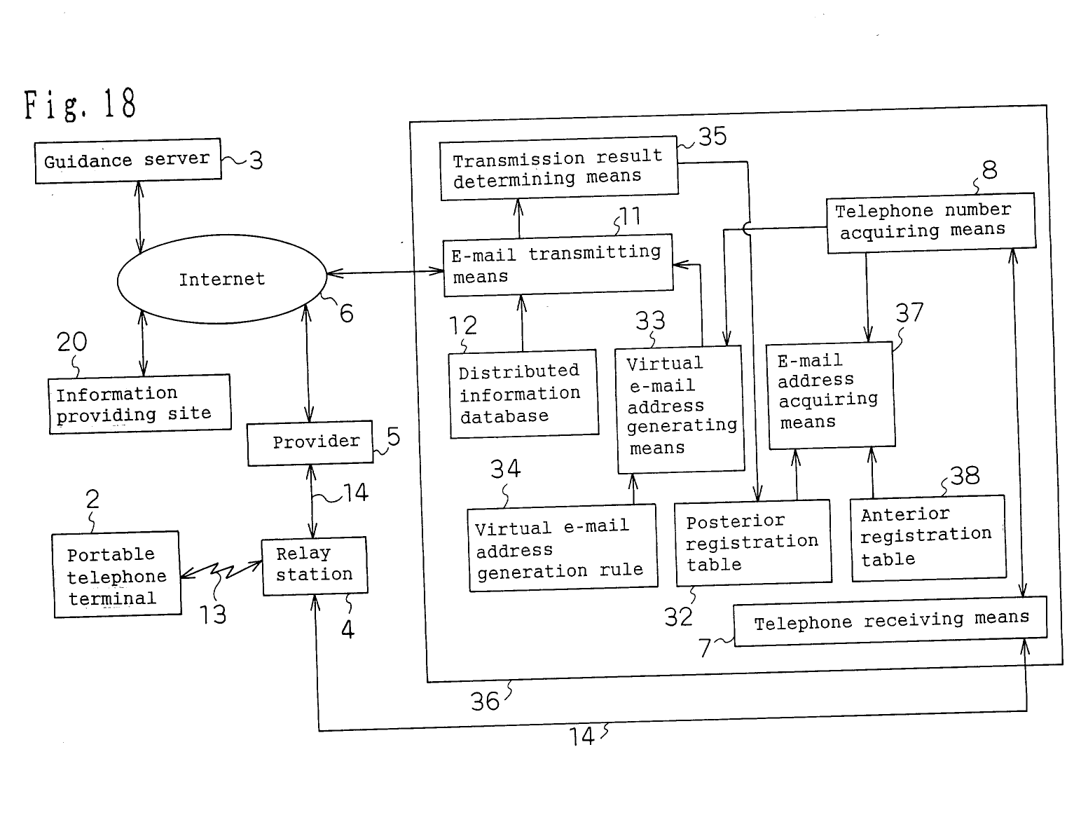

FIG. 18 shows the configuration of an information distribution system according to the present embodiment.

The information distribution system according to the present embodiment further comprises an anterior registration table 38 in addition to the information distribution system.

The anterior registration table 38 is similar to the user information database 10 described in Embodiment 1. And, this is a table for storing the information of the users who may use the guidance apparatus 36, and for corresponding the telephone number of a portable telephone terminal 2 to the e-mail address.

The other configuration is the same as that of Embodiment 5.

Here, the anterior registration table 38 according to the present embodiment is an example of a first table according to the invention. The posterior registration table 32 according to the present embodiment is an example of a second table according to the invention. The e-mail transmitting means 11, the distributed information database 12, and the transmission result determining means 35 according to the present embodiment constitute an example of information distributing means according to the invention. The e-mail address acquiring means 9, the posterior registration table 32, the anterior registration table 38, the virtual e-mail address generating means 33, and the virtual e-mail address generating rule 34 according to the present embodiment constitute an example of e-mail address generating means according to the invention. The telephone number acquiring means 8 and the telephone receiving means 7 according to the present embodiment constitute an example of receiving means according to the invention.

Further, the guidance apparatus 36 according to the present embodiment is an example of an information distribution apparatus according to the invention. The anterior registration table 38 according to the present embodiment is an example of a first table according to the invention. The transmission result determining means 35 and the e-mail transmitting means 11 according to the present embodiment constitute an example of e-mail transmitting means 11 according to the invention.

The operation of the present embodiment in such a configuration is described below with focusing the attention on the difference from Embodiment 5.

In the present embodiment, the posterior registration table 32 is already generated. However, the portable telephone terminal 2 does not yet use the guidance apparatus 36. Accordingly, no information on the portable telephone terminal 2 is not yet registered in the posterior registration table 32. Further, it is assumed that the user of the portable telephone terminal 2 has completed user registration. Accordingly, the anterior registration table 38 already stores information for corresponding the telephone number of the portable telephone terminal 2 to the e-mail address thereof.

Interactions among the guidance apparatus 36, the portable telephone terminal 2, the guidance server 3, and the information providing site 20 are those shown in FIG. 2 similarly to Embodiment 1. That is, in the following description, the guidance apparatus 1 shown in FIG. 2 is to be read as the guidance apparatus 36.

Similarly to Embodiment 1, it is assumed that a user goes out with carrying the portable telephone terminal 2.

It is assumed that the user goes out with carrying the portable telephone terminal 2. Further, it is assumed that in the outside, the user desires to find a shop holding a bargain sale and thereby purchase teenagers wear at a low price.

In such a case, at first, the user makes a telephone call from the portable telephone terminal 2 to the guidance apparatus 36 as indicated by a telephone call 70 in FIG. 2.

In a manner similar to Embodiment 5, the telephone number acquiring means 8 acquires the telephone number of the portable telephone terminal 2, by number notifying service.

Then, the telephone number acquiring means 8 notifies the acquired telephone number to the virtual e-mail address generating means 33, the e-mail address acquiring means 37, and the e-mail transmitting means 11.

In a manner similar to Embodiment 5, the virtual e-mail address generating means 33 generates virtual e-mail addresses from the notified telephone number according to the virtual e-mail address generating rules 34, and then notifies the generated virtual e-mail addresses to the e-mail transmitting means 11.

On the other hand, the e-mail address acquiring means 37 searches the anterior registration table 38 and the posterior registration table 32 on the basis of the notified telephone number, and thereby acquires an e-mail address corresponding to the notified telephone number. At present, the telephone number of the portable telephone terminal 2 is not yet registered in the posterior registration table 32, but is already registered in the anterior registration table 38. Accordingly, the e-mail address acquiring means 37 acquires the e-mail address of the portable telephone terminal 2 from the anterior registration table 38. The e-mail address acquiring means 37 then notifies the acquired e-mail address to the e-mail transmitting means 11.

Then, the e-mail transmitting means 11 reads out guidance information from the distributed information database 12, and thereby transmits the guidance information to the virtual e-mail addresses notified from the virtual e-mail address generating means 33 and to the e-mail address notified from the e-mail address acquiring means 37, by e-mail as indicated by e-mail transmission 71 in FIG. 2.

Here, in the e-mail transmission, when there are two or more identical e-mail addresses among the virtual e-mail addresses notified from the virtual e-mail address generating means 33 and the e-mail address notified from the e-mail address acquiring means 37, the e-mail transmitting means 11 transmits only one e-mail to the e-mail address in question.

On completion of the e-mail transmission to all the virtual e-mail addresses and the e-mail address, the e-mail transmitting means 11 notifies: the telephone number acquired from the telephone number acquiring means 8; and the virtual e-mail addresses and the e-mail address thereof; to the transmission result determining means 35.

The transmission result determining means 35 receives error reply e-mails returned from the provider 5 and the like, then analyzes the header portions of the replied e-mails, and thereby determines whether the e-mail transmission was successful or not.

On the basis of the determination result, the transmission result determining means 35 updates the posterior registration table 32.

That is, when a virtual e-mail address was successful in the e-mail transmission, the transmission result determining means 35 registers the virtual e-mail address which was successful in the e-mail transmission, into the posterior registration table 32 in the form corresponded to the telephone number notified from the e-mail transmitting means 11.

Further, when the posterior registration table 32 is already generated, and when a virtual e-mail address which was unsuccessful in the e-mail transmission is already registered in the posterior registration table 32, the virtual e-mail address is deleted from the posterior registration table 32.

When an e-mail address which was unsuccessful in the e-mail transmission is already registered in the anterior registration table 38, the transmission result determining means 35 transmits an e-mail for notifying the unsuccessful e-mail address to the portable telephone terminal 2, via the e-mail transmitting means 11 to the e-mail address which was successful in the e-mail transmission. This e-mail carries a message that when the e-mail is returned intact, the registered contents in the anterior registration table 38 is updated for the user.

Accordingly, only when the e-mail is returned intact, and when an e-mail address which was unsuccessful in the e-mail transmission is already registered in the anterior registration table 38, the transmission result determining means 35 updates the existing e-mail address into the e-mail address which was successful in the e-mail transmission.

Similarly to Embodiment 5, the user makes a telephone call again from the portable telephone terminal 2 to the telephone number 06-1234-5671 in which bargain sale information is obtained, as indicated by a telephone call 72 in FIG. 2.

Then, similarly to the case of the telephone call 70, the telephone number acquiring means 8 notifies the acquired telephone number to the e-mail address acquiring means 31.

On receiving the telephone number from the telephone number acquiring means 8, the e-mail address acquiring means 31 notifies the acquired telephone number to the virtual e-mail address generating means 33, the e-mail address acquiring means 37 and the e-mail transmitting means 11.

Similarly to the case of the telephone call 70, the virtual e-mail address generating means 33 generates virtual e-mail addresses according to the virtual e-mail address generating rules 34, and thereby notifies the virtual e-mail addresses to the e-mail transmitting means 11.

The e-mail address acquiring means 37 acquires the e-mail addresses of the portable telephone terminal 2 from the posterior registration table 32 and the anterior registration table 38, and thereby notifies the e-mail addresses to the e-mail transmitting means 11.

Then, the e-mail transmitting means 11 transmits e-mails to the notified virtual e-mail addresses and e-mail addresses as indicated by e-mail transmission 73 in FIG. 2.

Here, when there are two or more identical e-mail addresses among the notified virtual e-mail addresses and e-mail addresses, the e-mail transmitting means 11 transmits only one e-mail to the e-mail address in question, similarly to the above-mentioned case.

After that, interactions shown in FIG. 2 are carried out among the information providing site 20, the guidance server 3, the portable telephone terminal 2, and the guidance apparatus 36, with repeating the above-mentioned processes. These interactions are already described in detail in Embodiment 1, and hence the description is omitted.

As such, the present embodiment has effects similar to that of Embodiment 5. Further, the following advantage is also obtained.

That is, in case that the e-mail address of the portable telephone terminal 2 is acquired from the user information database 10 similarly to Embodiment 1, the user of the portable telephone terminal 2 needs to update the e-mail address registered in the user information database 10 when the user has changed the registered e-mail address, or when the type of the portable telephone terminal 2 is changed and thereby the telephone number is changed. Thus, when the user forgets the update, the user cannot use the guidance apparatus 1.

In contrast, in the present embodiment, e-mails are transmitted to the virtual e-mail addresses generated according to the virtual e-mail address generating rules 34 as well as to the e-mail addresses acquired from the posterior registration table 32 and the anterior registration table 38. Accordingly, even when the user forgets to update the anterior registration table 38 when the e-mail address of the portable telephone terminal 2 is changed, the portable telephone terminal 2 can still use the guidance apparatus 36. Further, the transmission result determining means 35 generates an e-mail for confirmation of the update of the anterior registration table 38, and then transmits the e-mail to the portable telephone terminal 2. Accordingly, the portable telephone terminal 2 can simply return the e-mail to the guidance apparatus 36, and thereby update the e-mail address registered in the anterior registration table 38.

As such, in case that the guidance apparatus 36 provides various additional services to the portable telephone terminal 2 by e-mail on the basis of the information in the anterior registration table 38, even when the user of the portable telephone terminal 2 forgets to update the e-mail address registered in the anterior registration table 38, the user can receive the additional services continuously. Here, such additional services include: the distribution of commercial messages from the companies having a contract with the guidance apparatus 36; and the distribution of prize information and obtained-points information from the companies.

The description of the present embodiment has been made for the case that in the update of the e-mail address registered in the anterior registration table 38, the transmission result determining means 35 transmits an e-mail for confirmation of the update to the portable telephone terminal 2. However, the invention is not restricted to this. That is, without transmitting an e-mail for confirmation of the update of the e-mail address registered in the anterior registration table 38, the transmission result determining means 35 may update the e-mail address which was unsuccessful in the e-mail transmission, in the anterior registration table 38.

(Embodiment 7)

Embodiment 7 is described below.

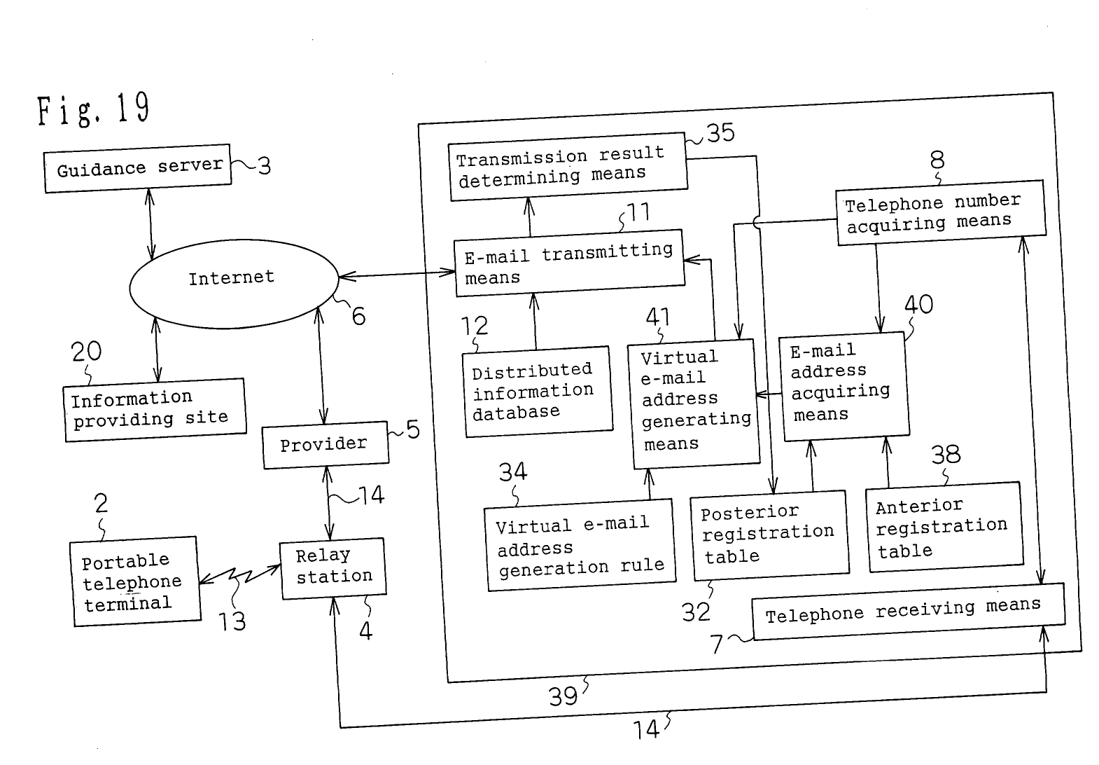

FIG. 19 shows the configuration of an information distribution system according to the present embodiment.

The information distribution system according to the present embodiment comprises virtual e-mail address generating means 41 and e-mail address acquiring means 40 in place of the virtual e-mail address generating means 33 and the e-mail address acquiring means 37 according to Embodiment 6.

The virtual e-mail address generating means 41 is means of generating virtual e-mail addresses from a telephone number notified from the telephone number acquiring means 8, according to the virtual e-mail address generating rules 34 similarly to Embodiment 6.

The e-mail address acquiring means 40 is means of acquiring an e-mail address corresponding to the telephone number notified from the telephone number acquiring means 8, by searching the posterior registration table 32 and the anterior registration table 38 similarly to Embodiment 6.

The difference of the present embodiment from Embodiment 1 is that only when the e-mail address acquiring means 40 cannot acquire an e-mail address corresponding to the telephone number notified from the telephone number acquiring means 8, the virtual e-mail address generating means 41 generates virtual e-mail addresses.

The other configuration is the same as that of Embodiment 6.

Here, the e-mail address acquiring means 40, the posterior registration table 32, the anterior registration table 38, the virtual e-mail address generating means 41, and the virtual e-mail address generating rules 34 according to the present embodiment constitute an example of e-mail address generating means according to the invention.

The operation of the present embodiment in such a configuration is described below with focusing the attention on the difference from Embodiment 6.

In the present embodiment, the posterior registration table 32 is already generated. However, the portable telephone terminal 2 does not yet use the guidance apparatus 36. Accordingly, no information on the portable telephone terminal 2 is not yet registered in the posterior registration table 32. Further, it is assumed that the user of the portable telephone terminal 2 has completed user registration. Accordingly, the anterior registration table 38 already stores information for corresponding the telephone number of the portable telephone terminal 2 to the e-mail address thereof.

Interactions among the guidance apparatus 39, the portable telephone terminal 2, the guidance server 3, and the information providing site 20 are those shown in FIG. 2 similarly to Embodiment 1. That is, in the following description, the guidance apparatus 1 shown in FIG. 2 is to be read as the guidance apparatus 39.

Similarly to Embodiment 1, it is assumed that a user goes out with carrying the portable telephone terminal 2.

It is assumed that the user goes out with carrying the portable telephone terminal 2. Further, it is assumed that in the outside, the user desires to find a shop holding a bargain sale and thereby purchase teenagers wear at a low price.

In such a case, at first, the user makes a telephone call from the portable telephone terminal 2 to the guidance apparatus 39 as indicated by a telephone call 70 in FIG. 2.

In a manner similar to Embodiment 5, the telephone number acquiring means 8 acquires the telephone number of the portable telephone terminal 2, by number notifying service.

Then, the telephone number acquiring means 8 notifies the acquired telephone number to the virtual e-mail address generating means 33, the e-mail address acquiring means 37, and the e-mail transmitting means 11.

The e-mail address acquiring means 37 searches the anterior registration table 38 and the posterior registration table 32 on the basis of the notified telephone number, and thereby acquires an e-mail address corresponding to the notified telephone number. At present, the telephone number of the portable telephone terminal 2 is not yet registered in the posterior registration table 32, but is already registered in the anterior registration table 38. Accordingly, the e-mail address acquiring means 37 acquires the e-mail address of the portable telephone terminal 2 from the anterior registration table 38. Then, the e-mail address acquiring means 37 notifies that the e-mail address has been acquired, to the virtual e-mail address, and at the same time, notifies the acquired e-mail address to the virtual e-mail address generating means 41.

When receiving the notification that the e-mail address acquiring means 40 has acquired the e-mail address, the virtual e-mail address generating means 41 does not generate any virtual e-mail address, but notifies the notified e-mail address to the e-mail transmitting means 11.

In contrast, only when receiving the notification that the e-mail address acquiring means 40 has failed to acquire an e-mail address, the virtual e-mail address generating means 41 generates virtual e-mail addresses from the notified telephone number according to the virtual e-mail address generating rules 34, in a manner similar to Embodiment 5. Then, the virtual e-mail address generating means 41 notifies the generated virtual e-mail addresses to the e-mail transmitting means 11.

The operation subsequent to this is the same as that of Embodiment 6.

In the present embodiment, when the e-mail address can be obtained from the anterior registration table 38 and the posterior registration table 32, an e-mail is transmitted to that e-mail address by priority. In contrast, only when the e-mail address cannot be obtained from the anterior registration table 38 and the posterior registration table 32, e-mails are transmitted to virtual e-mail addresses. This approach reduces the number of e-mails transmitted to invalid e-mail addresses, and at the same time, permits even a portable telephone terminal 2 before user registration to use the guidance apparatus 39 immediately.

(Embodiment 8)

Embodiment 8 is described below.

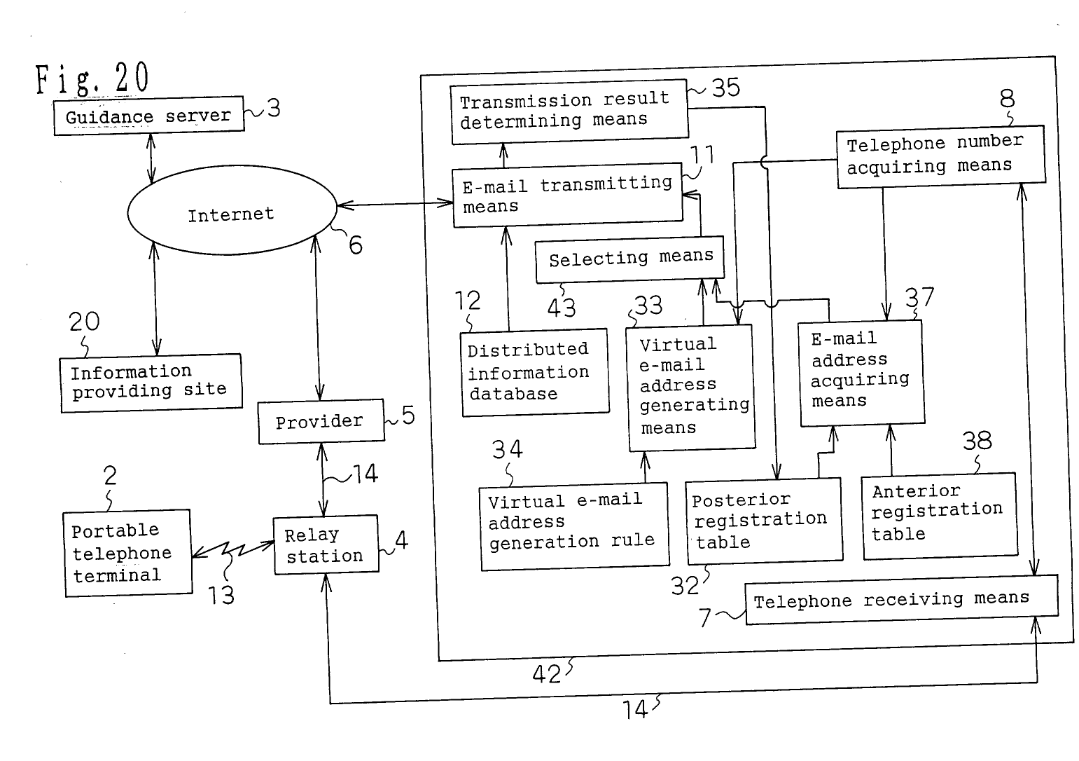

FIG. 20 shows the configuration of an information distribution system according to the present embodiment.

A guidance apparatus 42 according to the present embodiment further comprises selecting means 43 in addition to the guidance apparatus 39 according to Embodiment 6.

The selecting means 43 is means of selecting a virtual e-mail address to which an e-mail is to be transmitted among the generated virtual e-mail addresses, on the basis of the e-mail address notified from the e-mail address acquiring means 37.

The other configuration is the same as that of Embodiment 6.

Here, the e-mail address acquiring means 37, the posterior registration table 32, the anterior registration table 38, the virtual e-mail address generating means 33, and the virtual e-mail address generating rules 34 according to the present embodiment constitute an example of e-mail address generating means according to the invention. Further, the virtual e-mail address generating means 33, the virtual e-mail address generating rules 34, the e-mail address acquiring means 37, the selecting means 43, the posterior registration table 32, and the anterior registration table 38 according to the present embodiment constitute an example of e-mail address generating means according to the invention.

The operation of the present embodiment in such a configuration is described below with focusing the attention on the difference from Embodiment 6.

In a manner similar to Embodiment 6, the telephone number acquiring means 8 acquires the telephone number of the portable telephone terminal 2, and then notifies the telephone number to the virtual e-mail address generating means 33, the e-mail address acquiring means 37, and the transmission result determining means 35.

In a manner similar to Embodiment 6, the virtual e-mail address generating means 33 generates virtual e-mail addresses, while the e-mail address acquiring means 37 acquires the e-mail address. Then, the virtual e-mail address generating means 33 notifies the generated virtual e-mail addresses to the selecting means 43, while the e-mail address acquiring means 37 notifies the acquired e-mail address to the selecting means 43.

The selecting means 43 selects a virtual e-mail address to which an e-mail is to be actually transmitted among the notified virtual e-mail addresses, on the basis of the e-mail address notified from the e-mail address acquiring means 37.

The selecting means 43 then transmits the selected virtual e-mail address to the e-mail transmitting means 11.

The other operation is the same as that of Embodiment 6, and hence the description is omitted.

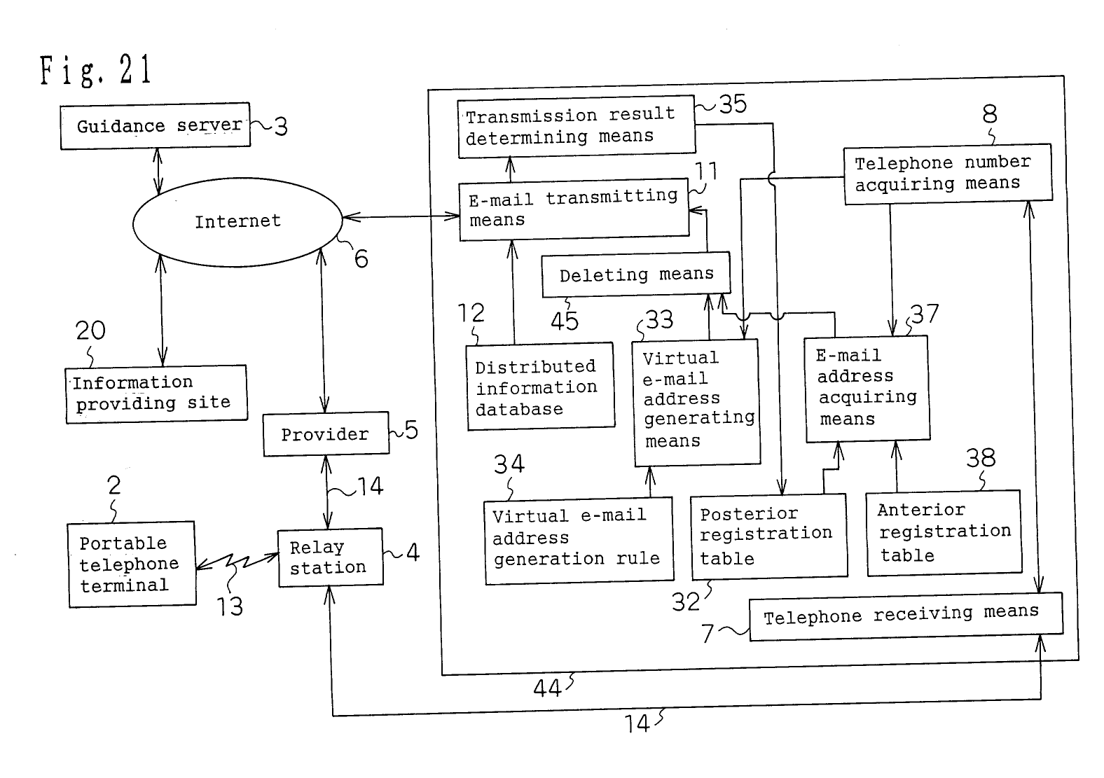

In the present embodiment, the description has been made for the case that the selecting means 43 transmits a virtual e-mail address to which an e-mail is to be actually transmitted among the generated virtual e-mail addresses, on the basis of the e-mail address notified from the e-mail address acquiring means 37. However, the invention is not restricted to this. As illustrated by a guidance apparatus 44 shown in FIG. 21, deleting means 45 maybe used. Here, the deleting means 45 deletes virtual e-mail addresses to which an e-mail is not to be transmitted among the generated virtual e-mail addresses, on the basis of the e-mail address notified from the e-mail address acquiring means 37, and then notifies the remained virtual e-mail address to the e-mail transmitting means 11.

(Embodiment 9)

Embodiment 9 is described below.

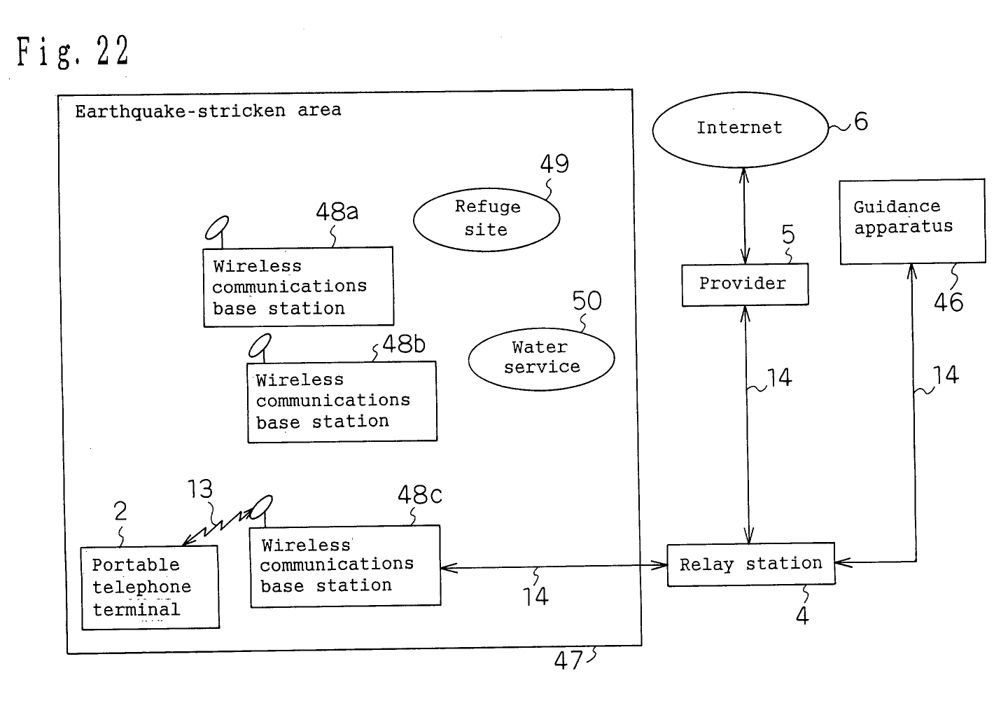

FIG. 22 shows the configuration of a guidance information distribution system according to the present embodiment.

The present embodiment describes the case in which a guidance information distribution system according to Embodiments 1-8 is used at a serious natural disaster such as an earthquake.

The guidance information distribution system according to the present embodiment comprises a portable telephone terminal 2, wireless communications base stations 48a, 48b, 48c, a relay station 4, a provider 6, and a guidance apparatus 46.

The guidance apparatus 46 is any one of the guidance apparatuses according to Embodiments 1-8.

The portable telephone terminal 2, the relay station 4, and the provider 6 are identical to those in Embodiments 1-8.

The earthquake-stricken area 47 is an area where a large earthquake has occurred, and is assumed to be the Osaka area, for example. The wireless communications base stations 48a-48c are constructed in the earthquake-stricken area 47. Each wireless communications base station 48a-48c is connected to the relay station 4 via the telephone line 4.

The guidance apparatus 46 is assumed to be constructed in Tokyo completely free from the influence of the earthquake.

The operation of the present embodiment in such a configuration is described below.

When an earthquake occurs in the earthquake-stricken area 47, a large number of telephone calls for inquiring after persons' safety and the like are made to the area. Accordingly, the telephone line 14 becomes congested and busy in the earthquake-stricken area 47. This makes telephone calls difficult to connect. However, telephone calls are easier to connect in the areas other than the earthquake-stricken area 47, such as in Tokyo.

In such a case, the portable telephone terminal 2 makes a telephone call to the guidance apparatus 46 constructed in Tokyo.

The guidance apparatus 46 acquires the telephone number of the portable telephone terminal 46, and then transmits guidance information containing the information for securing the safety of the user of the portable telephone terminal 2, by e-mail.

Such guidance information includes: information notifying the locations of a safe refuge site 49; and information notifying the locations of a site where water service 50 is available at a certain time after the earthquake occurrence, in case that the ordinary city water is out of service.

The user of the portable telephone terminal 2 reads the guidance information transmitted from the guidance apparatus 46 by e-mail, and thereby goes to the safe refuge site 49, and/or goes to the site of water service 50 so as to obtain drinking water.

As such, the guidance apparatus 46 transmits the information on the refuge site 49 and the like, continuously at each time of change in the situation of the earthquake-stricken area, beginning at the time when the telephone call from the portable telephone terminal 2 is received.

An e-mail, which transfers information in character messages, needs much smaller amount of data in comparison with the case that the same amount of information is transferred as voice messages. Thus, when the guidance information distribution system according to the present embodiment is used in the earthquake-stricken area 47, the congestion in the telephone line 14 is reduced, whereby the information on the refuge site 49 and the water service 50 for securing the sufferers' safety is transferred to the sufferers rapidly.

The guidance apparatus 46 may have the function of detecting the wireless communications base station through which the portable telephone terminal 2 makes the telephone call, among the wireless communications base stations 48a-48c. Such a function permits the identification of the approximate location of the portable telephone terminal 2. In this case, the guidance apparatus 46 can provide guidance information on the refuge site 49 and the water service site 50 nearest to the location of the portable telephone terminal 2. As such, the guidance information may be changed depending on the location of the portable telephone terminal 2.

(Embodiment 10)

Embodiment 10 is described below.

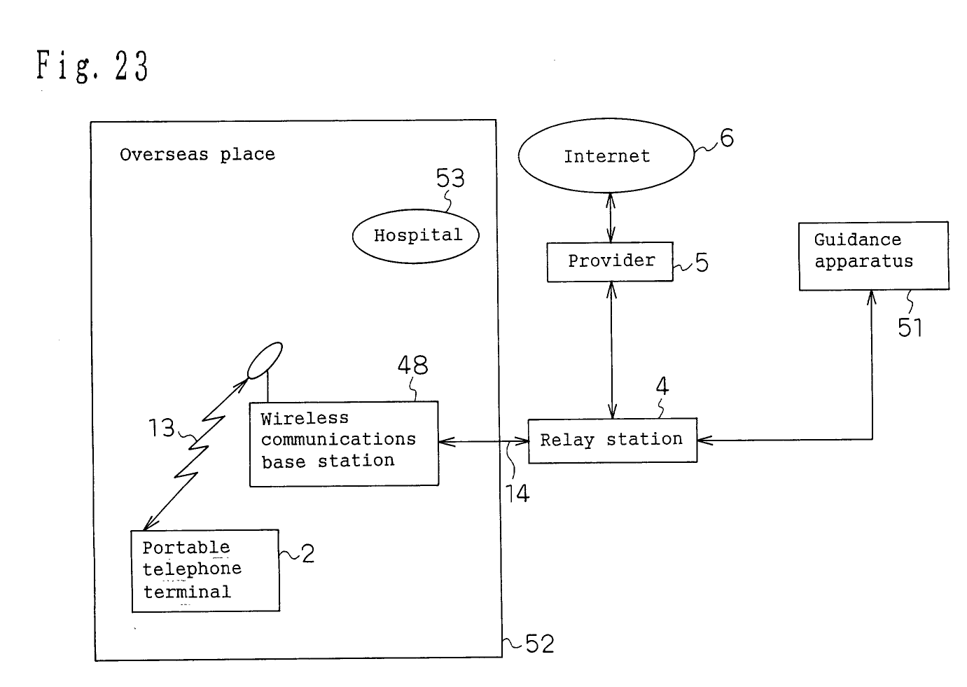

FIG. 23 shows the configuration of a guidance information distribution system according to the present embodiment.

The present embodiment describes the case in which a user goes overseas with carrying the portable telephone terminal 2.

The guidance information distribution system according to the present embodiment comprises a portable telephone terminal 2, a wireless communications base station 48, a relay station 4, a provider 6, and a guidance apparatus 51.

The guidance apparatus 51 is any one of the guidance apparatuses according to Embodiments 1-8.

The portable telephone terminal 2, the relay station 4, and the provider 6 are identical to those in Embodiments 1-8.

The portable telephone terminal 2 is located in an overseas place 52.

The operation of the present embodiment in such a configuration is described below.

It is assumed that the user of the portable telephone terminal 2 cannot speak the local language in the overseas place 52. Further, it is assumed that the user has got a stomachache.

In such a case, because the user cannot speak the local language in the overseas place 52, the user makes at first a telephone call to the guidance apparatus 51 constructed in Japan, the user's home country.

Then, in a manner similar to that of Embodiments 1-8, the guidance apparatus 51 transmits guidance information notifying the location of a hospital, in Japanese by e-mail.

When the portable telephone terminal 2 receives the guidance information, the user is informed of the location of the hospital 53, and thereby goes to the hospital 53 for examination.

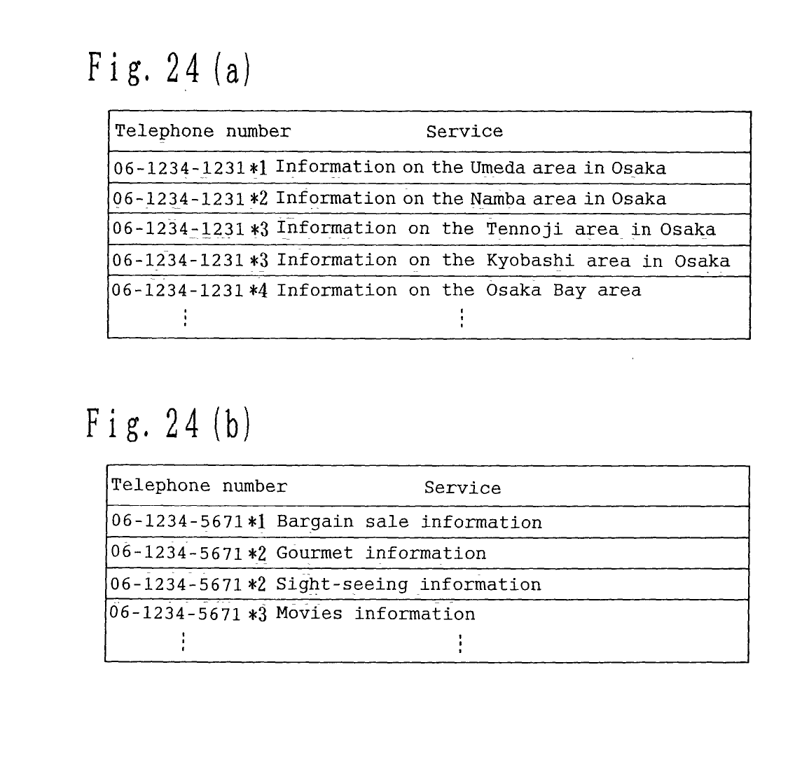

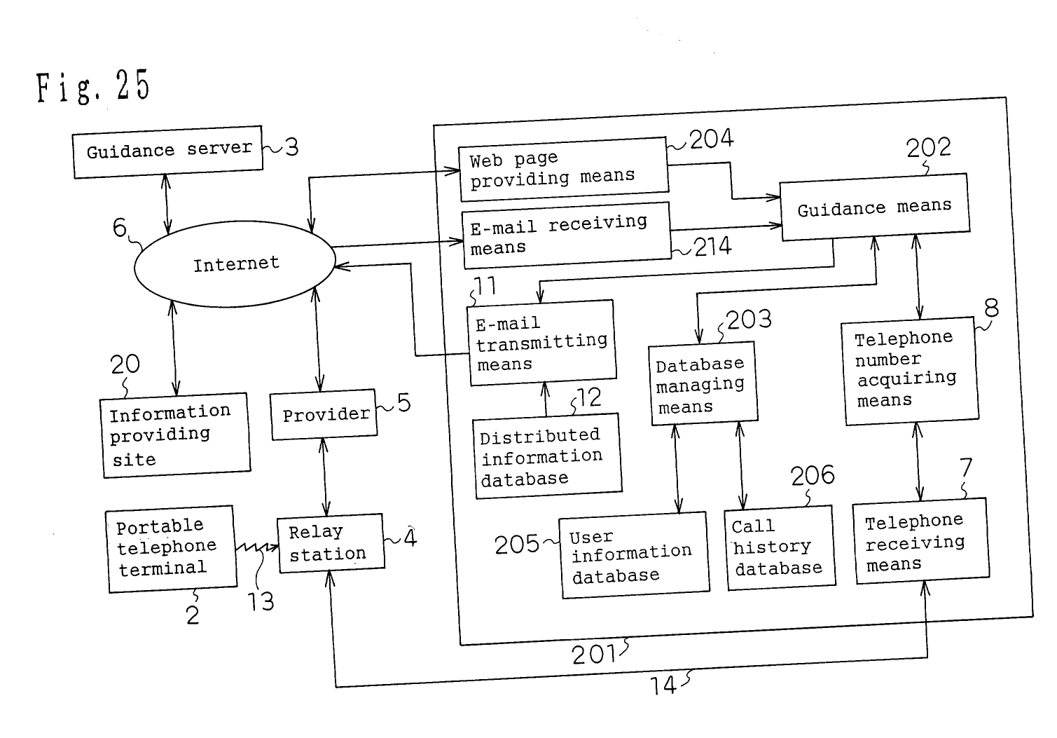

In the above-mentioned embodiments, the description has been made for the case that the portable telephone terminal 2 selects guidance information by selecting one of telephone numbers to which a telephone call is to be made. However, the invention is not restricted to this. As shown in FIG. 24(a), the telephone number to which a telephone call is to be made may be the only telephone number 06-1234-1231, and one of selection numbers may be specified. That is, when number 1 is selected when the portable telephone terminal 2 makes a telephone call to 06-1234-1231, the information on the Umeda area in Osaka is selected. When number 2 is selected, the information on the Namba area in Osaka is selected. As shown in FIG. 24(b), in order to select the bargain sale information among the information items on the Umeda area in Osaka, number 1 is selected when a telephone call is made to 06-1234-5671. As such, instead of selecting one of a plurality of telephone numbers to which a telephone call is to be made from the portable telephone terminal 2, one of selection numbers may be selected in order to select guidance information.

In the above-mentioned embodiments, the description has been made for the case that the guidance information is in a hierarchically form, and that the guidance apparatus 1 provides guidance information in two-layer hierarchy to the portable telephone terminal 2. However, the invention is not restricted to this. The guidance apparatus 1 may provide guidance information in the hierarchy of any number of layers, such as single-layer hierarchy, three-layer hierarchy, and four-layer hierarchy, to the portable telephone terminal 2.

In the above-mentioned embodiments, the description has been made for the case that the guidance information in the hierarchy lower than that of the guidance information provided by the guidance apparatus 1 is provided in two-layer hierarchy by the guidance server 3. However, the invention is not restricted to this. The guidance server 3 may provide guidance information in the hierarchy of any number of layers, such as single-layer hierarchy, three-layer hierarchy, and four-layer hierarchy, to the portable telephone terminal 2.

Further, first information and/or second information according to the invention may be, or alternatively, may be not, in a hierarchical form similar to that of the guidance information according to the above-mentioned embodiments.

In the above-mentioned embodiments, the description has been made for the case that the local area on which the information is to be obtained is selected at first. However, the invention is not restricted to this. The field of interest on which the information is to be obtained may be selected at first, and then the local area on which the information is to be obtained may be selected.

In the above-mentioned embodiments, the description has been made for the case that the telephone replying means 17 terminates the telephone call from the portable telephone terminal 2 immediately after the completion of the acquisition of the telephone number of the portable telephone terminal 2. However, the invention is not restricted to this. The telephone call from the portable telephone terminal 2 may be terminated after being replied to.

The info-communication terminal according to the invention is not restricted to the portable telephone terminal 2 according to the above-mentioned embodiments. That is, the info-communication terminal according to the invention may be a terminal of any type capable of being connected to the Internet and making a telephone call. Such terminals include: a PHS terminal capable of being connected to the Internet; an automobile telephone set capable of being connected to the Internet; and an e-mail-dedicated mobile terminal capable of being connected to the Internet via the portable telephone terminal line.

In the above-mentioned Embodiments 1-4, the description has been made for the case that the user of the guidance apparatus is registered to the user information database 10 in advance. However, the invention is not restricted to this. As described in detail in Embodiment 5 and the subsequent embodiments, the e-mail address of the portable telephone terminal 2 may be generated according to a rule such as the virtual e-mail address generating rule.

The information distributing means, the e-mail address generating means, and the receiving means according to the invention need not to constitute a single apparatus. The information distributing means and the e-mail address generating means may be located in the same place, while the receiving means maybe located in another place departing therefrom. Further, the information distributing means and the receiving means may be located in the same place, while the e-mail address generating means may be located in another place departing therefrom. The receiving means and the e-mail address generating means may be located in the same place, while the information distributing means may be located in another place departing therefrom.

The scope of the invention includes a computer-processable medium which carries a program and/or data for causing a computer to execute all or part of the function of all or part of means or the info-communication terminal in the system according to the invention.

The scope of the invention includes an information set which is a program and/or data for causing a computer to execute all or part of the function of all or part of means or the info-communication terminal in the system according to the invention.

The invention is a medium which carries a program and/or data for causing a computer to execute all or part of the function of all or part of means or the info-communication terminal in the above-mentioned system according to the invention, wherein: the medium is read out by a computer; and the read-out program and/or data carry out the above-mentioned function in cooperation with the computer.

The invention is further an information set which is a program and/or data for causing a computer to execute all or part of the function of all or part of means or the info-communication terminal in the above-mentioned system according to the invention, wherein: the information set is read out by a computer; and the read-out program and/or data carry out the above-mentioned function in cooperation with the computer.

The data according to the invention includes a data structure, a data format, a data type.

The medium according to the invention includes: a recording medium such as a ROM; a transmitting medium such as the Internet; and a transmitting medium such as light, radio waves, acoustic waves, and the like.

Further, the medium which carries a program and/or data according to the invention includes: a recording medium on which a program and/or data is recorded; and a transmitting medium for transmitting a program and/or data.

The computer processability according to the invention includes: that a recording medium such as a ROM is readable by a computer; and that a program and/or data transmitted by a transmitting medium can be processed by a computer after the transmission.

The information set according to the invention includes software such as a program and/or data.

Further, as described above, the configuration of the invention may be implemented by software or hardware.

(Embodiment 11)

FIG. 25 shows the configuration of an information distribution system according to Embodiment 11.

The information distribution system according to the present embodiment comprises a guidance apparatus 201, a portable telephone terminal 2, a guidance server 3, a relay station 4, a provider 5, the Internet 6, and an information providing site 20.

In FIG. 25, like parts to those in the related art of the present invention are designated by like numerals, and hence detailed description is omitted.

The guidance apparatus 201 is an apparatus for transmitting guidance information which describes the URL of a Web page provided by the guidance server 3, to the portable telephone terminal 2 by e-mail in response to a telephone call from the portable telephone terminal 2.

The portable telephone terminal 2 is a portable telephone terminal capable of being connected to the Internet. In FIG. 1, a single portable telephone terminal 2 is solely shown. However, a plurality of portable telephone terminals 2 are used actually.

The portable telephone terminal 2 comprises: telephone calling means (not shown) of making a telephone call to a predetermined telephone number; and e-mail acquiring means of receiving an e-mail. The telephone calling means is means of making a telephone call via the relay station 4 and the telephone line 14. The e-mail acquiring means is means of acquiring an e-mail from a mail box which is provided in the provider 5 and corresponds to the e-mail address assigned to the user of the portable telephone terminal 2.

The guidance server 3 is a Web server for providing the addresses of Web pages provided by the information providing site 20, as a Web page via the Internet 6 to the portable telephone terminal 2.

The guidance apparatus 201 is connected to the Internet 6 and the relay station 4. The portable telephone terminal 2 can be connected to the Internet 6 via the relay station 4 and the provider 5.

The relay station 4 is an apparatus for relaying between the portable telephone terminal 2 and the telephone line 14.

The provider 5 is an apparatus for connecting the portable telephone terminal 2 to the Internet.

The guidance apparatus 201 comprises telephone receiving means 7, telephone number acquiring means 8, guidance means 202, database managing means 203, a user information database 205, a call history database 206, e-mail transmitting means 11, Web page providing means 204, e-mail receiving means 214, and a distributed information database 12.

The telephone receiving means 7 is means of receiving a telephone call from the portable telephone terminal 2.

The telephone number acquiring means 8 is means of acquiring the telephone number of the portable telephone terminal 2 making the telephone call, by number notifying service. The number notifying service is a service in which the caller's telephone number is notified to the receiver when a telephone call is made. This service is provided by the telephone company.

The database managing means 203 is means of managing the user information database 205 and the call history database 206 in response to the control by the guidance means 202.

The user information database 205 is a database for storing the information of the users who may use the guidance apparatus 201. In this database, the telephone number and the e-mail address of the portable telephone terminal 2 are stored in a form corresponded to each other.

The call history database 206 is a database in which when a telephone call is made to a predetermined telephone destination of the guidance apparatus 201, the telephone number of the caller of the telephone call and the telephone number of the telephone destination are stored in a form corresponded to each other for a predetermined time duration.

The e-mail transmitting means 11 is means of reading out to-be-distributed guidance information from the distributed information database 12 and thereby transmitting the information by e-mail to the acquired e-mail.

The Web page providing means 204 is means of providing a Web page in response to the access request from the portable telephone terminal 2 and the like, and at the same time, notifying which URL is accessed, to the guidance means 202.

The e-mail receiving means 214 is means of receiving an e-mail transmitted from the portable telephone terminal 2 and the like.

Here, the user information database 205 according to the present embodiment is an example of a first table according to the invention. The URL according to the present embodiment is an example of a Web page address according to the invention. The guidance information transmitted from the guidance apparatus 201 to the portable telephone terminal 2 according to the present embodiment is an example of e-mail information according to the invention. The user information database 205 according to the present embodiment is an example of a first apparatus according to the invention. The database managing means 203 according to the present embodiment is an example of a second apparatus according to the invention. The guidance means 202 according to the present embodiment is an example of a third apparatus according to the invention. The call history database 206 according to the present embodiment is an example of a fourth apparatus according to the invention.

The operation of the present embodiment in such a configuration is described below.

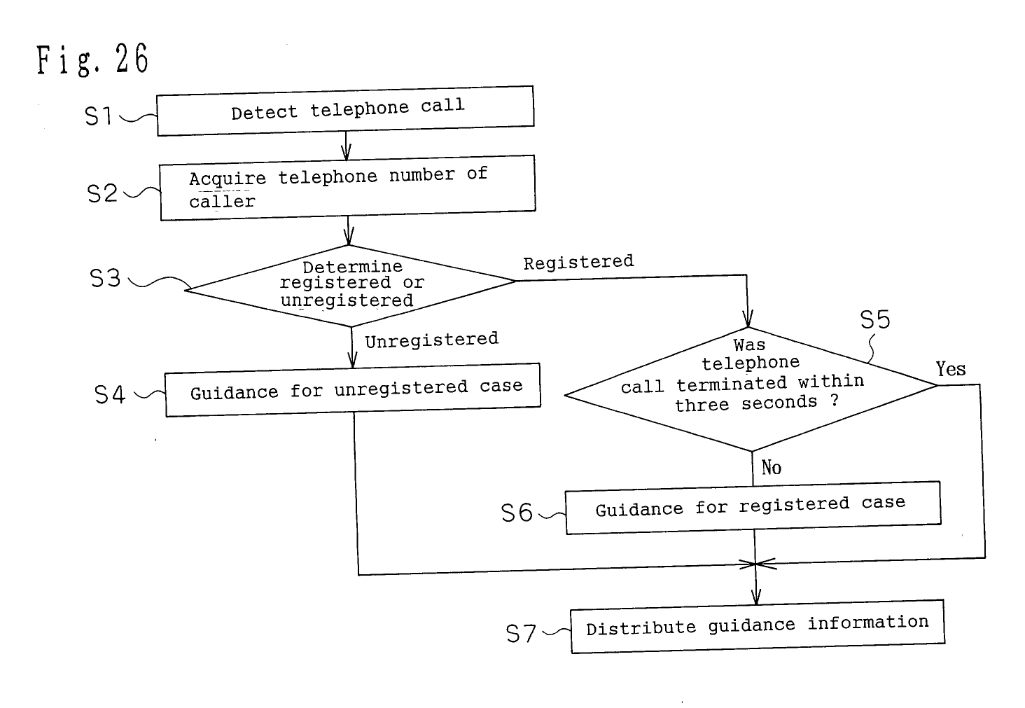

FIG. 26 is a flowchart for the present embodiment.

Similarly to the above-mentioned embodiments, it is assumed that a user goes out with carrying the portable telephone terminal 2.

Further, it is assumed that in the outside, the user desires to find a shop holding a bargain sale and thereby purchase teenagers' wear at a low price.

In such a case, at first, the user makes a telephone call from the portable telephone terminal 2 to the guidance apparatus 201.

FIG. 3(a) shows an example of telephone numbers to which a telephone call can be made from the portable telephone terminal 2. A plurality of telephone numbers to which a telephone call can be made are listed. By selecting any one of these telephone numbers and by making a telephone call thereto, the contents of the provided service is selected. In FIG. 3(a), the telephone numbers are classified by local area. When a telephone call is made to 06-1234-1231, information on the Umeda area in Osaka is obtained. In contrast, when a telephone call is made to 06-1234-1232, information on the Namba area in Osaka is obtained. A telephone directory listing these telephone numbers is distributed to each user in advance. Further, when the portable telephone terminal 2 is brought to a service shop, such a telephone directory can be registered into the memory of the portable telephone terminal 2. The guidance apparatus 201 provides such information for each local area. Thus, detailed information can be provided to the user.

It is assumed that the user is now in Umeda in Osaka, and that the user desires to purchase teenagers' wear in Umeda in Osaka. In this case, in order to obtain information on the Umeda area in Osaka, the user makes a telephone call from the portable telephone terminal 2 to 06-1234-1231.

The telephone call from the portable telephone terminal 2 is notified to the relay station 4 by wireless communication 13, and then notified from the relay station 4 through the telephone line 14 to the telephone receiving means 7.

The telephone receiving means 7 detects that a telephone call is being made to the telephone number corresponding to the information on the Umeda area in Osaka, and then notifies the fact of detection to the telephone number acquiring means 8 (S1).

The telephone number acquiring means 8 acquires the telephone number of the caller, that is, the telephone number of the portable telephone terminal 2, by number notifying service. Then, the telephone number acquiring means 8 notifies, to the guidance means 202, the acquired telephone number of the caller, the telephone number 06-1234-1231 of the destination of the telephone call, and the time of day of the telephone call detection by the telephone receiving means 7 (S2).

When receiving, from the telephone number acquiring means 8, the telephone number of the caller or the telephone number of the portable telephone terminal 2, the telephone number of the telephone destination, and the time of the telephone call detection by the telephone receiving means 7, the guidance means 202 inquires of the database managing means 203, at first, whether the telephone number of the caller is already registered or not (S3).

When receiving the inquiry whether the telephone number of the caller is already registered or not from the guidance means 202, the database managing means 203 searches the user information database 205 in order to check whether any registered telephone number coincides with the telephone number of the caller, that is, the telephone number of the portable telephone terminal 2. In the user information database 205, users' telephone numbers and users' e-mail addresses are stored in a form corresponded to each other.

When a telephone number registered in the user information database 205 coincides with the telephone number of the portable telephone terminal 2, the database managing means 203 acquires the e-mail address corresponding to the registered telephone number, and then notifies: the fact that the telephone number of the caller is already registered; and the e-mail address corresponding to the telephone number of the caller; as a response to the guidance means 202.

In contrast, when no telephone number registered in the user information database 205 coincides with the telephone number of the portable telephone terminal 2, the database managing means 203 notifies the fact that the telephone number of the caller is not yet registered, as a response to the guidance means 202.

When receiving the response of unregistered status from the database managing means 203, the guidance means 202 proceeds to S4. In contrast, when receiving the response of registered status, the guidance means 202 proceeds to S5.

Described below at first is the operation (S4) carried out when receiving the response of unregistered status from the database managing means 203. After that, described is the operation (S5) carried out when receiving the response of registered status from the database managing means 203.

(Operation S4)

In S4, when receiving the response of unregistered status from the database managing means 203, the guidance means 202 instructs the telephone number acquiring means 8 to reply to the telephone call from the portable telephone terminal 2. In response to this, the telephone number acquiring means 8 controls the telephone receiving means 7 so as to go into voice communication of the telephone call. When the telephone receiving means 7 goes into voice communication, the guidance means 202 carries out guidance for initial registration.

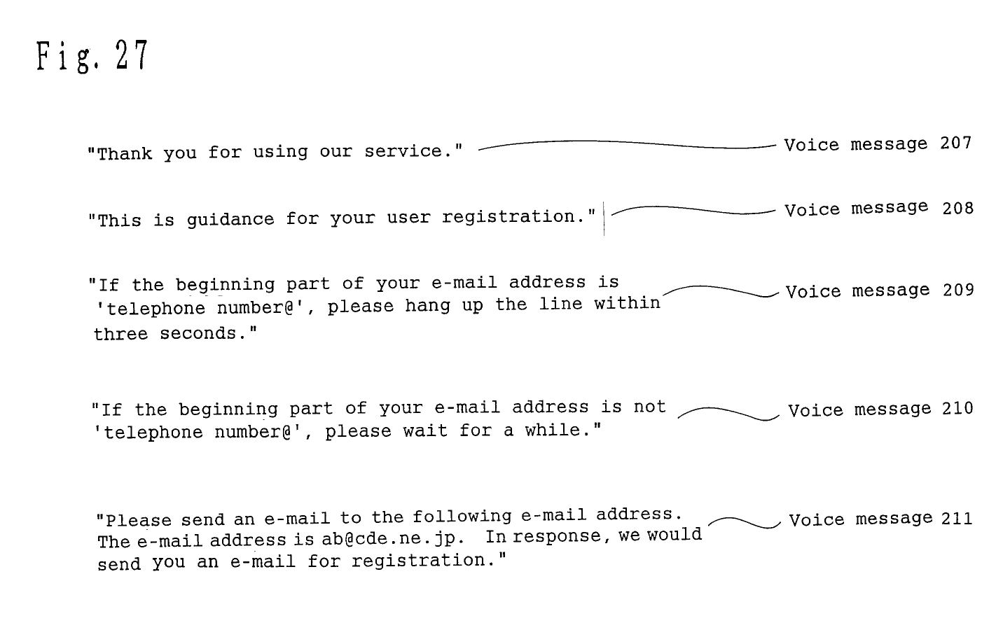

FIG. 27 shows main part of the voice guidance.

The guidance means 202 sends a voice message “Thank you for using our service” as indicated by a voice message 207. Then, a voice message “This is guidance for your user registration” is sent as indicated by a voice message 208. Further, a voice message “If the beginning part of your e-mail address is ‘telephone number@’, please hang up the line within three seconds” is sent as indicated by a voice message 209.

Here, it is assumed that the e-mail address assigned to the user of the portable telephone terminal 2 by the telephone company can be generated from the telephone number according to a predetermined rule. Such a predetermined rule is similar to that described above in the related art of the invention.

Accordingly, the user who has listened the voice message 209 through the receiver of the portable telephone terminal 2 terminates the voice communication in the portable telephone terminal 2. The operation carried out when the user does not terminates the voice communication within three seconds is described later.

When detecting the termination of the voice communication from the portable telephone terminal 2, the telephone receiving means 7 notifies this fact to the telephone number acquiring means 8. Then, the telephone number acquiring means 8 notifies this fact to the guidance means 202.

Then, on the basis of the fact that the voice communication has been terminated by the portable telephone terminal 2 before a voice message 211 is sent, the guidance means 202 determines that the e-mail address of the portable telephone terminal 2 can be generated from the telephone number according to a predetermined rule. Here, it is assumed that the voice message 211 starts at three seconds later after the completion of a voice message 210. Accordingly, it is concluded that the user has terminated the voice communication within three seconds after the voice message 209.

In this case, the guidance means 202 instructs the e-mail transmitting means 11 to transmit a confirmation e-mail as an e-mail guidance.

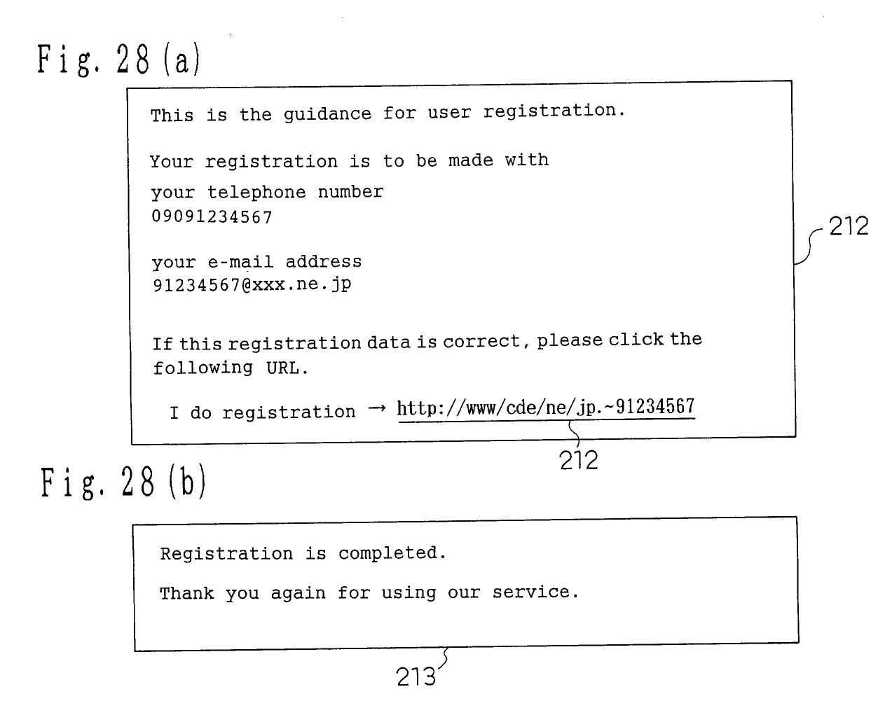

FIG. 28(a) shows an example of the confirmation e-mail as indicated by a confirmation e-mail 212. The confirmation e-mail describes: the telephone number of the portable telephone terminal 2 acquired by number notifying service; the e-mail address generated from the telephone number according to a predetermined rule; and a URL 212. Further, the description of the method of use of the information providing services available from the guidance apparatus 201 is also attached, but not shown in FIG. 28(a). Here, when the guidance means 202 generates the confirmation e-mail 212, the URL 212 is made to be in one-to-one correspondence to the combination between the telephone number of the portable telephone terminal 2 and the e-mail address generated from the telephone number according to the predetermined rule.

In the portable telephone terminal 2, when the text of an e-mail describes a telephone number or a URL, clicking of the telephone number causes an automatic telephone call to the telephone number. Further, clicking of the URL causes automatic access to the Internet Web page. These points are described above in the related art of the invention.

The user desires user registration, and thereby clicks the URL 212. Then, the portable telephone terminal 2 transmits an access request for the Web page specified by the URL 212. The access request is transmitted through the relay station 4, through the provider 5, through the Internet 6, and to the Web page providing means 204.

On receiving the access request, the Web page providing means 204 transmits a registration completion notification 213 shown in FIG. 28(b), as a Web page to the portable telephone terminal 2. Further, the Web page providing means 204 notifies that the Web page corresponding to the URL 212 has received an access request, to the guidance means 202.

On receiving the registration completion notification 213 shown in FIG. 28(b), the portable telephone terminal 2 displays the notification on the monitor.

On the other hand, when receiving the notification that the Web page corresponding to the URL 212 has received an access request, the guidance means 202 notifies the telephone number and the e-mail address which have been corresponded to the URL 212 in advance, to the database managing means 203, and thereby instructs the database managing means 203 to register the data into the user information database.

In response to this, the database managing means 203 registers the telephone number and the e-mail address notified from the guidance means 202, into the user information database 201 in a form corresponded to each other. Then, the database managing means 203 searches the call history database 206, and thereby notifies: the telephone number of the telephone destination corresponding to the telephone number notified from the guidance means 202; and the completion of registration; to the guidance means 202 as a response.

On receiving the response from the database managing means 203, the guidance means 202 notifies the notified telephone number of the telephone destination and the notified e-mail address of the portable telephone terminal 2 to the e-mail transmitting means 11, and thereby instructs the e-mail transmitting means 11 to transmit guidance information.

In response to this, the e-mail transmitting means 11 selects information corresponding to the notified telephone number of the telephone destination, from the distributed information database 12, and thereby transmits the information to the notified e-mail address by e-mail (S7).

The operation S7 is similar to that in the related art of the invention, and hence detailed description is omitted.

When the user does not desire user registration, or alternatively when the telephone call is just a wrong number call, the user can leave intact the URL 212 shown in FIG. 28(a). In this case, it is avoided that the telephone number and the e-mail address are registered into the user information database 205 against the user's will. As such, the confirmation e-mail 212 shown in FIG. 28(a) is transmitted to the user of the portable telephone terminal 2, whereby it is confirmed whether the user actually desires registration or not. This permits appropriate treatment of the users' will.

Described below is the operation carried out when the user does not terminate the voice communication within three seconds in S4. In this case, the voice message 210 is sent, and then three seconds later, a voice message 211 is sent. That is, a voice message “Please send an e-mail to the following e-mail address. The e-mail address is ad@cde.ne.jp. In response, we would send you an e-mail address for registration” is sent via the portable telephone terminal 2.

After listening the voice message 211 from the receiver of the portable telephone terminal 2, the user terminates the voice communication, and then transmits an e-mail to the e-mail address specified by the voice message 211. That is, the user transmits an e-mail to the e-mail address ad@cde.ne.jp specified by the voice message 211. Here, the text and the title of the transmitted e-mail may be blank or not blank. A blank e-mail cannot be transmitted in some telephone companies. In this case, an e-mail containing, for example, a numeral “1” or an alphabet “a” can be transmitted.

The transmitted e-mail goes from the portable telephone terminal 2, through the relay station 4, through the provider 5, through the Internet 6, and then reaches the e-mail receiving means 214.

When receiving the e-mail transmitted to the e-mail address ad@cde.ne.jp specified by the voice message 211 via the portable telephone terminal 2, the e-mail receiving means 214 notifies the sender's e-mail address which is added in the header portion of the e-mail, to the guidance means 202.

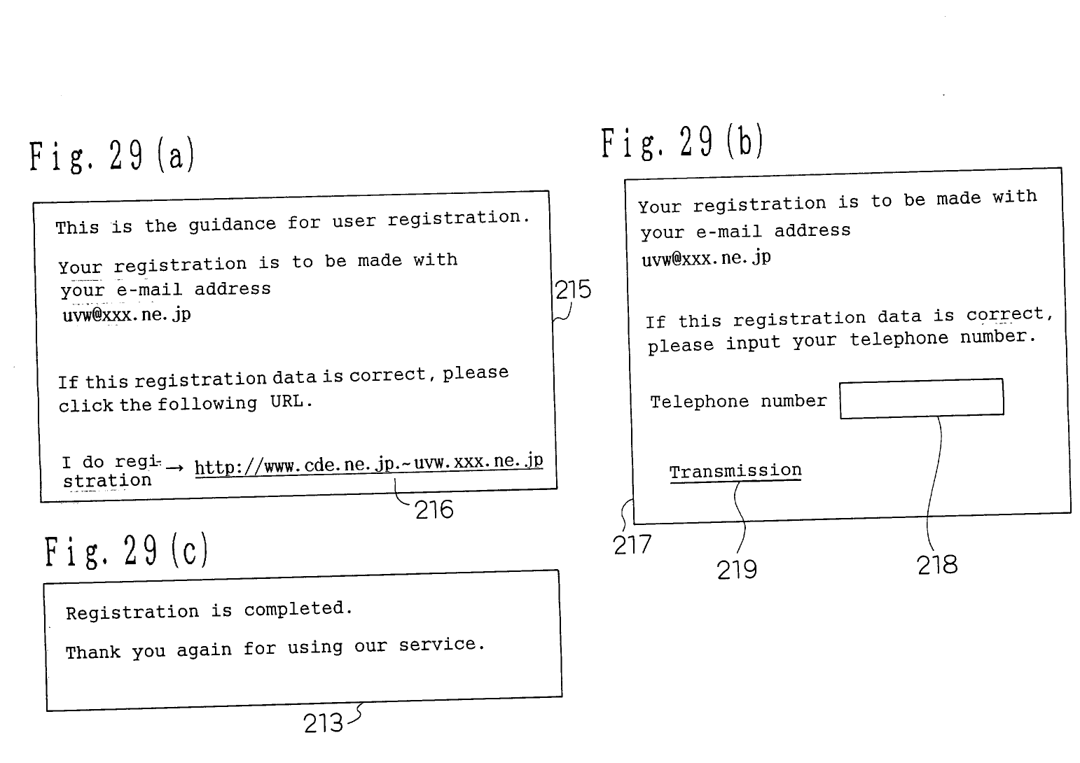

On receiving the notification of the sender's e-mail address from the e-mail receiving means 214, the guidance means 202 instructs the e-mail transmitting means 11 to transmit a confirmation e-mail to the notified e-mail address. FIG. 29(a) shows an example of the confirmation e-mail, as indicated by a confirmation e-mail 215.

The confirmation e-mail 215 describes the e-mail address to be registered and a URL 216. Here, the guidance means 202 establishes one-to-one correspondence between the URL described in the confirmation e-mail 215 and the sender's e-mail address notified from the e-mail receiving means 214. Accordingly, the sender's e-mail address is identified uniquely from the URL 216.

It is assumed that the portable telephone terminal 2 has received the confirmation e-mail 215. When the user desires registration, the user clicks the URL 216 portion of the confirmation e-mail 215. When the URL 216 portion is clicked, the portable telephone terminal 2 transmits an access request for accessing the Web page corresponding to the URL 216. The access request is transmitted through the relay station 4, through the provider 5, through the Internet 6, and to the Web page providing means 214.

On receiving the access request, the Web page providing means 204 inquires of the guidance means 202 for the e-mail address of the user of the portable telephone terminal 2 identified from the URL 216 added in the access request. Then, the Web page providing means 204 generates, as a Web page, a telephone number inputting screen 217 shown in FIG. 29(b), and thereby transmits the telephone number inputting screen 217 as a response to the access request from the portable telephone terminal 2.

On receiving the telephone number inputting screen 217, the portable telephone terminal 2 displays the screen image on the monitor. Then, the user inputs the telephone number into the telephone number inputting box 218, and then presses the transmission button 219. At the time of pressing the transmission button 219, the telephone number input by the user is transmitted to the Web page providing means 214 via the Internet 6 and the like.

On receiving the information input in the portable telephone terminal 2, the Web page providing means 214 notifies the information to the guidance means 202, and at the same time, transmits a registration completion notification 213 shown in FIG. 29(c), as a Web page to the portable telephone terminal 2.

On receiving the registration completion notification 213 shown in FIG. 29(b), the portable telephone terminal 2 displays the notification on the monitor.

On the other hand, when receiving the telephone number from the Web page providing means 204, the guidance means 202 notifies the e-mail address corresponding to the URL 212 and the notified telephone number, to the database managing means 203, and thereby instructs the database managing means 203 to register the data into the user information database.

In response to this, the database managing means 203 registers the telephone number and the e-mail address notified from the guidance means 202, into the user information database 201 in a form corresponded to each other. Then, the database managing means 203 searches the call history database 206, and thereby notifies: the telephone number of the telephone destination corresponding to the telephone number notified from the guidance means 202; and the completion of registration; to the guidance means 202 as a response.

On receiving the response from the database managing means 203, the guidance means 202 notifies the notified telephone number of the telephone destination and the notified e-mail address of the portable telephone terminal 2, to the e-mail transmitting means 11, and thereby instructs the e-mail transmitting means 11 to transmit guidance information.

In response to this, the e-mail transmitting means 11 selects information corresponding to the notified telephone number of the telephone destination, from the distributed information database 12, and thereby transmits the information to the notified e-mail address by e-mail (S7). The transmission of the guidance information is described above in detail in the related art of the invention, and hence the description is omitted.

(Operation S5)

Described below is the operation (S5) carried out when receiving the response of registered status from the database managing means 203.

In S5, when receiving the response of registered status from the database managing means 203, the guidance means 202 instructs the telephone number acquiring means 8 to wait for a predetermined time duration, for example, three seconds, starting from the time point of detection of the telephone call from the portable telephone terminal 2. When receiving, from the telephone number acquiring means 8, a notification that the telephone call has been terminated by the portable telephone terminal 2 during the time duration of wait, the guidance means 202 transmits guidance information (S7). The transmission of the guidance information is described above in detail in the related art of the invention, and hence the description is omitted.

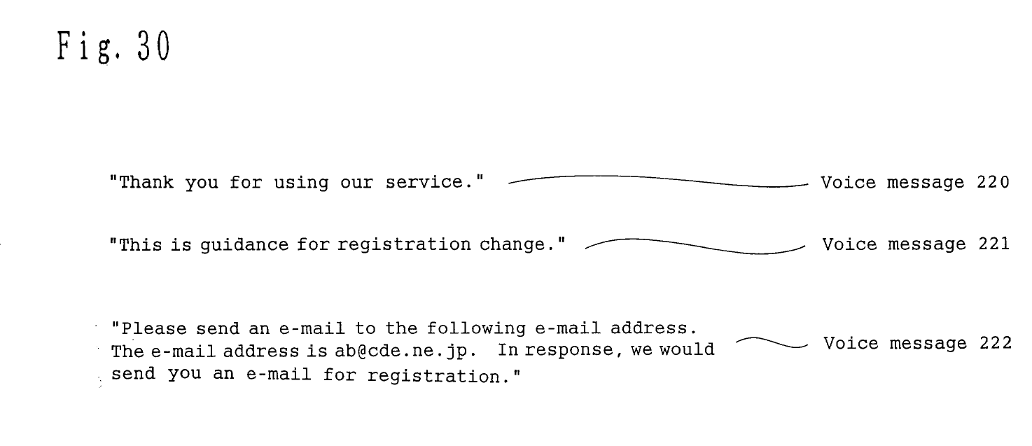

Further, in S5, when the telephone call has not been terminated during the predetermined time duration, that is, three seconds, the guidance means 202 instructs the telephone number acquiring means 8 to reply to the telephone call. In response to this, the telephone number acquiring means 8 controls the telephone receiving means 7, and thereby replies to the telephone call. Then, the guidance means 202 sends voice guidance as indicated by the voice messages shown in FIG. 30 (S6).

First, the guidance means 202 sends a voice message “Thank you for using our service” as indicated by a voice message 220. Then, a voice message “This is guidance for the change of your user registration” is sent as indicated by a voice message 221. Further, a voice message ““Please send an e-mail to the following e-mail address. The e-mail address is ab@cde@ne.jp. In response, we would send you an e-mail for registration” is sent as indicated by a voice message 222.

After listening the voice message 222 from the receiver of the portable telephone terminal 2, the user terminates the voice communication, and then transmits an e-mail to the e-mail address specified by the voice message 222. That is, the user transmits an e-mail to the e-mail address ab@cde.ne.jp specified by the voice message 211. Here, similarly to the above-mentioned case, the text and the title of the transmitted e-mail may be blank or not blank.

The transmitted e-mail goes from the portable telephone terminal 2, through the relay station 4, through the provider 5, through the Internet 6, and then reaches the e-mail receiving means 214.

When receiving the e-mail transmitted to the e-mail address ab@cde.ne.jp specified by the voice message 211 via the portable telephone terminal 2, the e-mail receiving means 214 notifies the sender's e-mail address which is added in the header portion of the e-mail, to the guidance means 202.

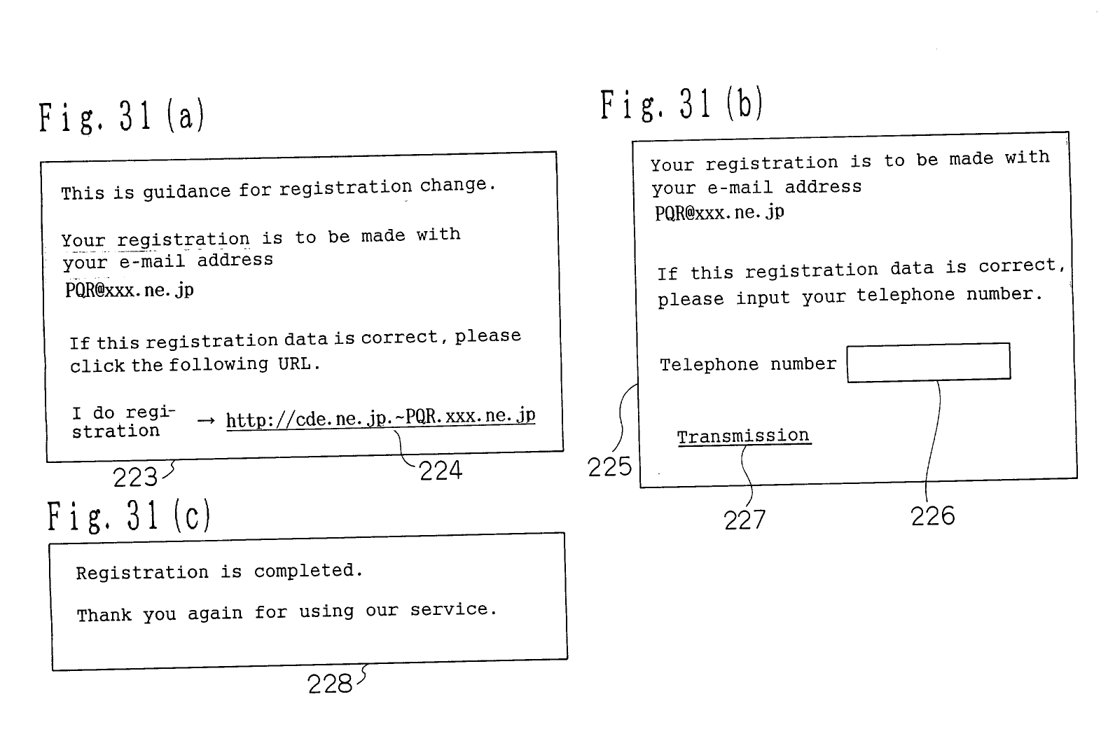

On receiving the notification of the sender's e-mail address from the e-mail receiving means 214, the guidance means 202 instructs the e-mail transmitting means 11 to transmit a confirmation e-mail to the notified e-mail address. FIG. 31(a) shows an example of the confirmation e-mail, as indicated by a confirmation e-mail 223.

The confirmation e-mail 223 describes an e-mail address to be newly registered and a URL 224. Here, the guidance means 202 establishes one-to-one correspondence between the URL described in the confirmation e-mail 223 and the sender's e-mail address notified from the e-mail receiving means 214. Accordingly, the sender's e-mail address is identified uniquely from the URL 224.

It is assumed that the portable telephone terminal 2 has received the confirmation e-mail 223. When the user desires registration, the user clicks the URL 224 portion of the confirmation e-mail 223. When the URL 224 portion is clicked, the portable telephone terminal 2 transmits an access request for accessing the Web page corresponding to the URL 224. The access request is transmitted through the relay station 4, through the provider 5, through the Internet 6, and to the Web page providing means 204.

On receiving the access request, the Web page providing means 204 inquires of the guidance means 202 for the e-mail address of the user of the portable telephone terminal 2 corresponding to the URL 224 added in the access request. Then, the Web page providing means 204 generates a telephone number inputting screen 225 shown in FIG. 31(b), and thereby transmits the telephone number inputting screen 225 as a Web page as a response to the access request from the portable telephone terminal 2.

On receiving the telephone number inputting screen 225, the portable telephone terminal 2 displays the screen image on the monitor. Then, the user inputs the telephone number into the telephone number inputting box 226, and then presses the transmission button 227. At the time of pressing the transmission button 227, the telephone number input by the user is transmitted to the Web page providing means 204 via the Internet 6 and the like.

On receiving the information input in the portable telephone terminal 2, the Web page providing means 204 notifies the information to the guidance means 202, and at the same time, transmits a registration completion notification 228 shown in FIG. 31(c), as a Web page to the portable telephone terminal 2.

On receiving the registration completion notification 228 shown in FIG. 31(c), the portable telephone terminal 2 displays the notification on the monitor.

On the other hand, when receiving the telephone number from the Web page providing means 204, the guidance means 202 notifies the e-mail address corresponding to the URL 224 and the notified telephone number, to the database managing means 203, and thereby instructs the database managing means 203 to register the data into the user information database.

In response to this, the database managing means 203 registers the telephone number and the e-mail address notified from the guidance means 202, into the user information database 201 in a form corresponded to each other. Then, the database managing means 203 searches the call history database 206, and thereby notifies: the telephone number of the telephone destination corresponding to the telephone number notified from the guidance means 202; and the completion of registration; to the guidance means 202 as a response.

On receiving the response from the database managing means 203, the guidance means 202 notifies the notified telephone number of the telephone destination and the notified e-mail address of the portable telephone terminal 2, to the e-mail transmitting means 11, and thereby instructs the e-mail transmitting means 11 to transmit guidance information.

In response to this, the e-mail transmitting means 11 selects information corresponding to the notified telephone number of the telephone destination, from the distributed information database 12, and thereby transmits the information to the notified e-mail address by e-mail (S7). The transmission of the guidance information is described above in the related art of the invention, and hence the description is omitted.

As such, in the present embodiment, the user information database 205 in which the telephone number and the e-mail address are stored in a form corresponded to each other is generated in advance. When receiving a telephone call from the user of the portable telephone terminal 2, the user information database 205 is searched on the basis of the telephone number of the caller of the telephone call, whereby it is determined whether the telephone number of the caller is already registered or not. When the telephone number of the caller is determined as unregistered, guidance for initial registration is carried out in order to cause the user of the portable telephone terminal 2 to notify the e-mail address.

In contrast, when the telephone number of the caller is determined as registered, a predetermined time duration for causing the user of the portable telephone terminal 2 to terminate the telephone call is generated, and after that, guidance for registration change is carried out in order to cause the user of the portable telephone terminal 2 to notify the new e-mail address for the change.

In case that the user has terminated the telephone call during the predetermined time duration, the user information database 205 is searched on the basis of the telephone number of the caller, whereby guidance information is transmitted to the obtained e-mail address. According to this method, the user can make user registration and then obtain desired information by simple operations.

In the present embodiment, the description has been made for the case that the Web page providing means 204 provides a Web page in response to an access request transmitted from the portable telephone terminal 2 or the like, and at the same time, notifies which URL is accessed, to the guidance means 202. However, the invention is not restricted to this. Similarly to the related art of the invention, the Web page providing means 204 in the guidance apparatus 201 may be omitted, and then the guidance server 3 may provide a Web page in response to an access request transmitted from the portable telephone terminal 2 or the like, and at the same time, notify which URL is accessed, to the guidance means 202. The exchange of information between the guidance server 3 and the guidance apparatus 201 may be carried out via the Internet 6 or a dedicated line.

In the present embodiment, the description has been made for the case that when the telephone call is terminated by the user of the portable telephone terminal 2 within three seconds after the detection of the telephone call, the guidance means 202 generates an e-mail address from the telephone number acquired by number notifying service, according to a predetermined rule, and then transmits guidance information to the generated e-mail address. However, the invention is not restricted to this. The guidance means 202 may transmit the guidance information when the telephone call is terminated by the user of the portable telephone terminal 2 within an arbitrarily predetermined time duration such as four seconds, five seconds, and the like.

In the present embodiment, in S6, the description has been made for the case that the e-mail address for registration change must be input regardless of whether the e-mail address of the user of registration change can be generated according to a predetermined rule or not. However, the invention is not restricted to this. When the e-mail address of the user can be generated from the telephone number according to a predetermined rule, a method similar to that shown in FIG. 28 may be used. That is, when the new e-mail address of the user of registration change can be generated from the telephone number according to a predetermined rule, guidance for termination of voice communication may be carried out in order to notify the timing of termination of voice communication of the telephone call. In contrast, when the new e-mail address of the user of registration change cannot be generated from the telephone number according to a predetermined rule, guidance for e-mail address input may be carried out in order to cause the user to notify the e-mail address by e-mail and the like. As such, registration change may be carried out in a manner similar to the initial registration according to the present embodiment.

In the present embodiment, in S4, the description has been made for the case that the registration is carried out in different manners depending on whether the e-mail address of the user of initial registration can be generated according to a predetermined rule or not. However, the invention is not restricted to this. Similarly to S6, guidance may be carried out in order to cause the user to input the e-mail address for registration regardless of whether the e-mail address of the user of registration can be generated according to a predetermined rule or not. That is, in the initial registration, guidance may be carried out in order to cause the user to notify the e-mail address by e-mail and the like regardless of whether the e-mail address to be notified from the user can be generated according to a predetermined rule or not.

In the present embodiment, in S4, the description has been made for the case that when the e-mail address for registration can be generated according to a predetermined rule, a confirmation e-mail is transmitted. However, the invention is not restricted to this. When the e-mail address for registration can be generated according to a predetermined rule, no confirmation e-mail is transmitted, but the telephone number and the e-mail address generated from the telephone number according to a predetermined rule may be registered into the user information database 205.

In the present embodiment, in S4, the description has been made for the case that when the e-mail address for registration can be generated according to a predetermined rule, a confirmation e-mail is transmitted, and that guidance information is distributed by e-mail as indicated by S7 at the time when the confirmation of registration is obtained from the user. However, the invention is not restricted to this. The e-mail address is generated from the telephone number according to a predetermined rule, and then guidance information may be transmitted at the same time when the confirmation e-mail is transmitted to the generated e-mail address. That is, the guidance information may be transmitted before the transmission of a confirmation e-mail and the subsequent confirmation of registration by the user.

Further, in the transmission of the confirmation e-mail, when a plurality of e-mail addresses can be generated from the telephone number according to a predetermined rule, confirmation e-mails can be transmitted to those e-mail addresses. In this case, the URL 212 shown in FIG. 28(a) is different for each e-mail. That is, each URL 212 can be corresponded to each e-mail address generated from the telephone number according to a predetermined rule. In this case, the portable telephone terminal 2 receives an e-mail transmitted to the e-mail address which coincides with the actual e-mail address assigned to the portable telephone terminal 2, among the transmitted e-mails. Then, when the user clicks the URL 212 portion of the received confirmation e-mail 212, an access request is transmitted to the Web page providing means 204. The guidance means 202 can identify the actual e-mail address assigned to the portable telephone terminal 2, from the URL contained in the access request.

Actually, the e-mail address cannot be identified uniquely from the telephone number in some cases. For example, even in case that a range of telephone numbers is assigned to a single telephone company in the telephone number assignment list published from the Ministry of Posts and Telecommunications, a plurality of domain names may be used when the e-mail addresses are generated from the telephone numbers, in some cases when the telephone company divides the range of the telephone numbers into sub-ranges for local areas.

Further, an e-mail address is assigned to a telephone number purchased from a telephone company, when a contract is made. It is assumed that the e-mail address is initially generated as the combination of the telephone number and the domain name used in the telephone company. Nevertheless, the domain name used in the generation of the e-mail address from the telephone number is frequently changed because of reorganization, such as merger and acquisition, or by other reasons. In this case, in the same telephone company, the e-mail address of a longtime user can have the old domain name before the change, while the e-mail address of a new user can have the new domain name after the change. As such, in some cases, there can be a plurality of possibilities for the e-mail address assigned to a telephone number in the same telephone company and the same branch thereof. Even in such a case, confirmation e-mails are transmitted to all possible e-mail addresses generated from the telephone number, whereby one and only one e-mail securely reaches the portable telephone terminal 2.

In the present embodiment, the description has been made for the case that when the e-mail address of the user of the portable telephone terminal 2 can be generated from the telephone number of the portable telephone terminal 2 according to a predetermined rule, a voice message 209, that is, a voice message “If the beginning part of your e-mail address is ‘telephone number@’, please hang up the line within three seconds” is sent as guidance for initial registration. That is, guidance for termination of voice communication has been carried out in order to notify the timing of termination of voice communication of the telephone call. And then, when the user had terminated the voice communication within the timing information, that is, three seconds, an e-mail for registration confirmation has been transmitted. However, the invention is not restricted to this. Guidance for initial registration may be carried out such that “If the beginning part of your e-mail address is ‘telephone number@’, please press ‘1’. If the beginning part of your e-mail address is not ‘telephone number@’, please press ‘2’”. When the e-mail address can be generated from the telephone number according to a predetermined rule, the user of the portable telephone terminal 2 presses the key “1” in the portable telephone terminal 2. Otherwise, the user presses the key “2” in the portable telephone terminal 2. Then, when the key “1” is pressed, guidance is carried out such that the e-mail address is not necessary to input. In this case, regardless of whether the e-mail address to be notified from the user can be generated from the telephone number according to a predetermined rule or not, a confirmation e-mail is transmitted to the e-mail address generated from the telephone number according to a predetermined rule. This process in which a confirmation e-mail is transmitted to the e-mail address generated from the telephone number according to a predetermined rule does not cause any problem even when the e-mail address of the portable telephone terminal 2 cannot actually be generated from the telephone number according to a predetermined rule. Further, registration change may be carried out similarly. As such, guidance for initial registration may be carried out such that when the e-mail address to be notified from the user can be generated from the telephone number according to a predetermined rule, the user needs not to notify the e-mail address. Similarly, guidance for registration change may be carried out such that when the e-mail address to be notified from the user can be generated from the telephone number according to a predetermined rule, the user needs not to notify the e-mail address.

In the present embodiment, in case of unregistered status or registration change in the user information database 205, the e-mail address of the user has been obtained using an e-mail or a Web page. However, the invention is not restricted to this. The guidance means 202 may be provided with voice recognizing means, and then guidance may be carried out in order to cause the user to say the e-mail address during the voice communication of the telephone call from the user. Then, the voice message of the user is processed by voice recognition, whereby the e-mail address of the user of the portable telephone terminal 2 is obtained. In the guidance for such a case that the e-mail address is obtained by voice recognition, the domain names of popular telephone companies or providers may be sent by voice, and then the user may press a key in the portable telephone terminal 2 in order to select a domain name. According to such a method, recognition errors in the voice recognition can be reduced, and the e-mail address input is carried out faster. For example, the following voice message may be used in the voice guidance. “Please say the alpha-numerals before the @ mark of your e-mail address.” This voice message causes the user to say the alpha-numerals before the @ mark, in the e-mail address of the user. The voice message of the user is processed by voice recognition. After that, a voice guidance message is sent such that “If the portion after the @ mark of your e-mail address is zzz.ne.jp, please press ‘1’. If the portion after the @ mark of your e-mail address is yyy.ne.jp, please press ‘2’”. In response to the voice guidance, the user press a key in the portable telephone terminal 2. Then, the key signal from the portable telephone terminal 2 is detected, whereby the e-mail address portion after the @ mark of the e-mail address is identified. Other variations are also possible.

In the present embodiment, in the initial registration and the registration change, the telephone number and the e-mail address have been obtained from the input of the telephone number in a Web page by the user. However, the invention is not restricted to this. An e-mail may be used in place of the Web page.

That is, a form for telephone number registration is described in place of the URL 216 of the confirmation e-mail 215 shown in FIG. 29(a). The user describes the user's telephone number into the form, and then returns the e-mail to the e-mail address of the sender of the confirmation e-mail 215. According to this method also, the telephone number and the e-mail address can be registered in a form corresponded to each other in the initial registration and the registration change. An example of such a form is a message “Please write your e-mail address into the box <> below, and then return this e-mail. Your e-mail address→<>” described in the text of the e-mail. The user write the e-mail address and then returns the e-mail. The e-mail text is, for example, “Please write your e-mail address into the box <> below, and then return this e-mail. Your e-mail address→<uvw@xxx.ne.jp>”.

In the present embodiment, the description has been made for the case that the guidance is carried out by voice, e-mail, and Web page. However, the invention is not restricted to this. The guidance may be carried out by at least one or more of voice, e-mail, and Web page.

In the present embodiment, the description has been made for the case that the user information database 205 in which the telephone number and the e-mail address are stored in a form corresponded to each other is generated in advance, and that when receiving a telephone call from the user of the portable telephone terminal 2, the telephone number of the caller of the telephone call is acquired by number notifying service provided by the telephone company. Then, according to an instruction from the guidance means 202, the database managing means 203 searches the user information database 205 on the basis of the telephone number of the caller, and thereby determines whether the telephone number of the caller is already registered or not. Then, when the telephone number of the caller is determined as unregistered by the database managing means 203, the guidance means 202 carries out guidance for initial registration in order to cause the user of the portable telephone terminal 2 to notify the e-mail address. In contrast, when the telephone number of the caller is determined as registered by the database managing means 203, the guidance means 202 carries out guidance for registration change in order to cause the user to notify a new e-mail address for registration change after a predetermined time duration, such as three seconds, used by the user of the portable telephone terminal 2 for terminating the telephone call. Further, when the user has terminated the telephone call during the predetermined time duration, the guidance means 202 instructs the database managing means 203 to search the user information database 205 on the basis of the telephone number of the caller, and thereby transmits e-mail information to the obtained e-mail address. However, the invention is not restricted to this. The following approaches may be used.

That is, the user information database 205 in which the telephone number and the e-mail address are stored in a form corresponded to each other is generated in advance. When the telephone receiving means 7 receives a telephone call from the user of the portable telephone terminal 2, the telephone number acquiring means 8 acquires the telephone number of the caller of the telephone call. Then, the database managing means 203 searches the user information database 205 on the basis of the telephone number of the caller of the telephone call, thereby determines whether the telephone number of the caller is already registered or not, and then notifies the determination result to the guidance means 202. When the telephone number of the caller is determined as unregistered, the guidance means 202 carries out guidance for initial registration in order to cause the user of the portable telephone terminal 2 to notify the e-mail address. In contrast, when the telephone number of the caller is determined as registered, the guidance means 202 carries out guidance for registration change in order to cause the user to notify a new e-mail address for registration change after a predetermined time duration causing the user of the portable telephone terminal 2 to terminate the telephone call. Further, when the telephone number of the caller is determined as registered, regardless of whether the guidance for registration change has not yet begun, has already begun, or has already completed, when the user of the portable telephone terminal 2 has terminated the telephone call during the predetermined time duration, the guidance means 202 instructs the database managing means 203 to search the user information database 205 on the basis of the telephone number of the caller, and thereby transmits e-mail information to the obtained e-mail address.

In another approach, the user information database 205 in which the telephone number and the e-mail address are stored in a form corresponded to each other is generated in advance. When the telephone receiving means 7 receives a telephone call from the user of the portable telephone terminal 2, the telephone number acquiring means 8 acquires the telephone number of the caller of the telephone call. Then, the database managing means 203 searches the user information database 205 on the basis of the telephone number of the caller of the telephone call, thereby determines whether the telephone number of the caller is already registered or not, and then notifies the determination result to the guidance means 202. When the telephone number of the caller is determined as unregistered, the guidance means 202 carries out guidance for initial registration in order to cause the user of the portable telephone terminal 2 to notify the e-mail address. In contrast, when the telephone number of the caller is determined as registered, the guidance means 202 carries out guidance for registration change in order to cause the user to notify a new e-mail address for registration change after a predetermined time duration causing the user of the portable telephone terminal 2 to terminate the telephone call. Further, when the telephone number of the caller is determined as registered, and when the guidance for registration change is guidance for causing the user to notify a new e-mail address for registration change during the voice communication of the telephone call (for example, in case that the e-mail address is input by voice recognition), if the new e-mail address for registration change is not yet notified at the time when the user of the portable telephone terminal 2 has terminated the telephone call, the guidance means 202 gives an instruction to the database managing means 203. In response to the instruction, the database managing means 203 searches the user information database 205 on the basis of the telephone number of the caller, and thereby notifies the result to the guidance means 202. The guidance means 202 notifies the e-mail address notified from the database managing means 203, to the e-mail transmitting means 11, and at the same time, instructs the e-mail transmitting means 11 to transmit an e-mail to the notified e-mail address. In response to the instruction, the e-mail transmitting means 11 transmits an e-mail. In contrast, if the new e-mail address for registration change has been notified already at the time when the user of the portable telephone terminal 2 has terminated the telephone call, no e-mail is transmitted to the e-mail address older than the notified new e-mail address. Such an approach is also possible.

In further another approach, the user information database 205 in which the telephone number and the e-mail address are stored in a form corresponded to each other is generated in advance. When receiving a telephone call from the user of the portable telephone terminal 2, the telephone receiving means 7 notifies: the fact of receiving the telephone call; and the telephone number of the caller of the telephone call; to the guidance means 202 via the telephone number acquiring means 8. Then, the guidance means 202 gives an instruction to the database managing means 203. In response to the instruction, the database managing means 203 searches the user information database 205 on the basis of the telephone number of the caller of the telephone call, thereby determines whether the telephone number of the caller is already registered or not, and then notifies the determination result to the guidance means 202. When the telephone number of the caller is determined as unregistered, the guidance means 202 carries out guidance for initial registration in order to cause the user to notify the e-mail address. In contrast, when the telephone number of the caller is determined as registered, the guidance means 202 carries out guidance for registration change in order to cause the user to notify a new e-mail address for registration change without any time duration causing the user to terminate the telephone call. Further, when the telephone number of the caller is determined as registered, and when the user has terminated the telephone call, the guidance means 202 gives an instruction to the database managing means 203. In response to the instruction, the data base managing means 203 searches the user information database 205 on the basis of the telephone number of the caller, and thereby notifies the obtained e-mail address to the guidance means 202. The guidance means 202 instruct to the e-mail transmitting means 11 to transmit an e-mail to the notified e-mail address. In response to the instruction, the e-mail transmitting means 11 transmits an e-mail. Furthermore, when the telephone number of the caller is determined as registered, and when the guidance for registration change is guidance for causing the user to notify a new e-mail address for registration change during the voice communication of the telephone call (for example, in case that the e-mail address is input by voice recognition during the voice communication), if the new e-mail address for registration change has been notified already at the time when the user of the portable telephone terminal 2 has terminated the telephone call, the guidance means 202 instructs the e-mail transmitting means 11 not to transmit any e-mail to the e-mail address older than the notified new e-mail address. In response to this instruction, the e-mail transmitting means 11 does not transmit any e-mail to the e-mail address older than the notified new e-mail address. Such an approach is also possible.

(Embodiment 12)

Embodiment 12 is described below.

FIG. 25 shows the configuration of an information distribution system according to the present embodiment. The configuration of the information distribution system according to the present embodiment is the same as that of Embodiment 11.

The operation of the present embodiment in such a configuration is described below with focusing the attention on the difference from Embodiment 11.

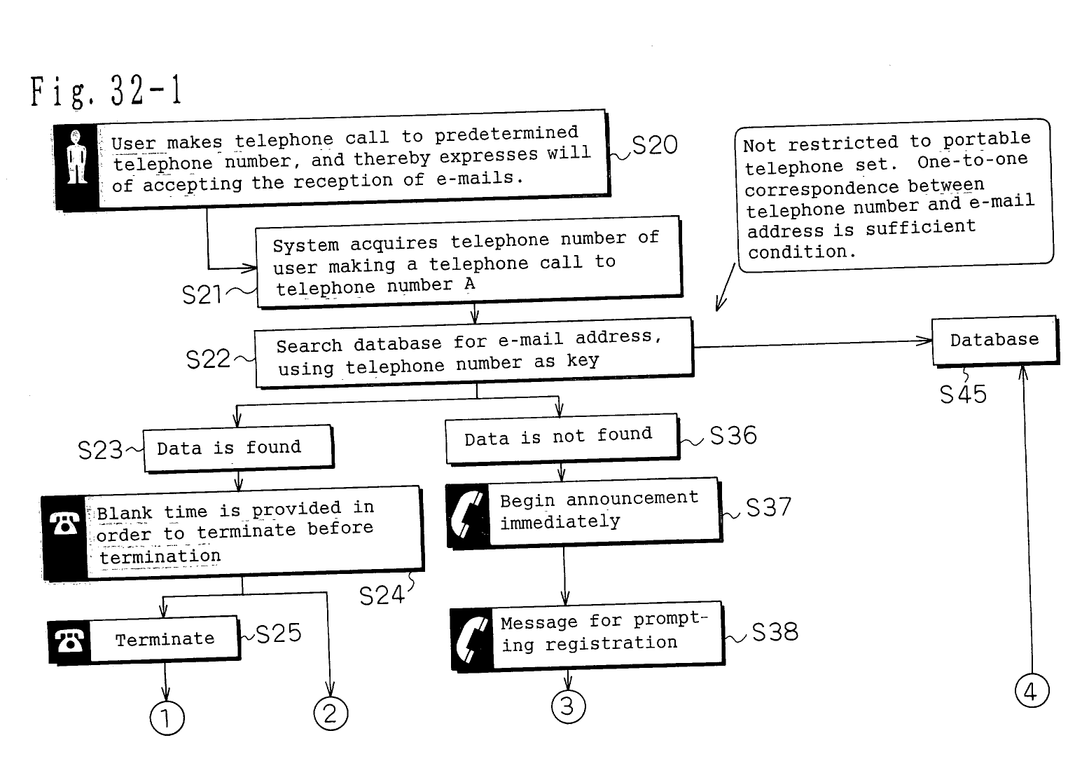

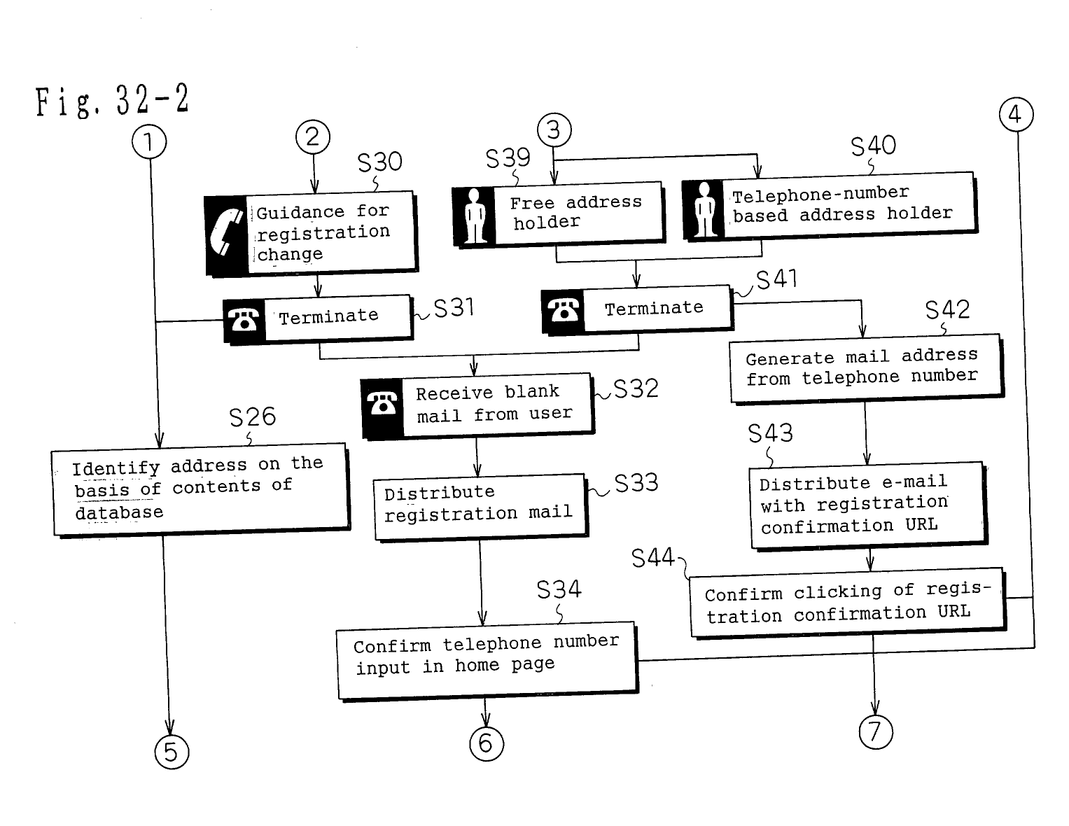

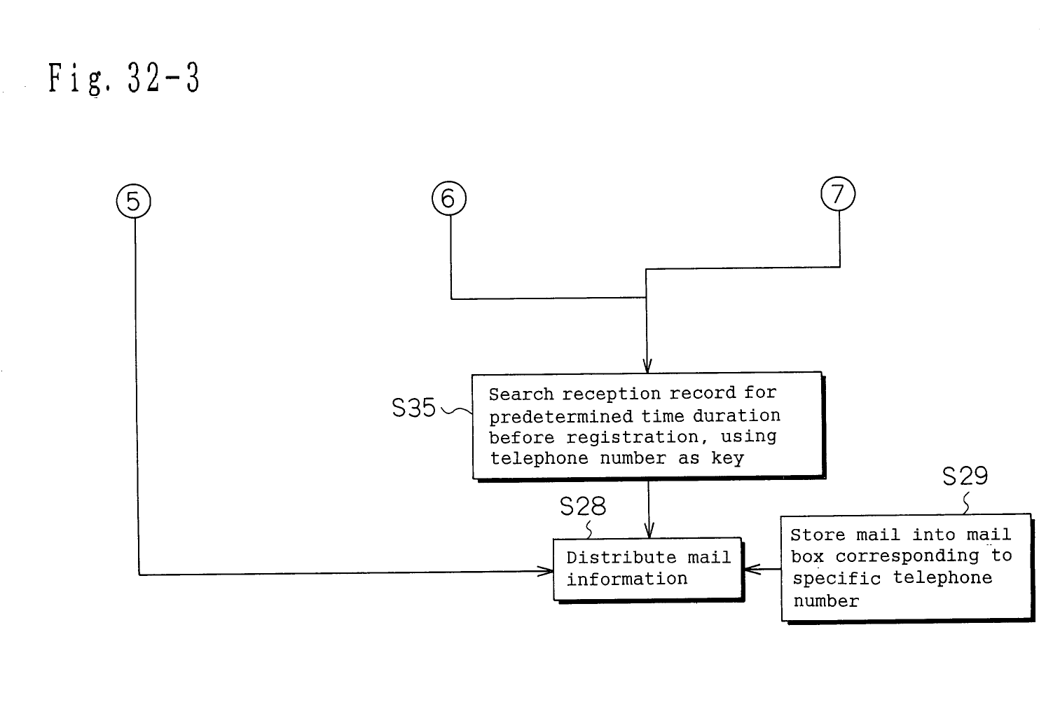

FIG. 32 is a flowchart for the information distribution system according to the present embodiment.

The user of the portable telephone terminal 2 makes a telephone call to a specific telephone number through which the telephone receiving means 7 of the guidance apparatus 201 receives the telephone call, whereby the user expresses the will of accepting the reception of information distributed by e-mail and the like (S29).

Thus, it is assumed that the user of the portable telephone terminal 2 makes a telephone call to the telephone number A through which the telephone receiving means 7 receives the telephone call. The telephone receiving means 7 detects the telephone call from the user of the portable telephone terminal 2, and thereby notifies this fact to the telephone number acquiring means 8. The telephone number acquiring means 8 acquires the telephone number of the portable telephone terminal 2, that is, the telephone number of the caller, by number notifying service provided by the telephone company. Then, the telephone number acquiring means 8 notifies the telephone number to the guidance means 202 (S21).

Then, the guidance means 202 notifies the telephone number of the caller to the database managing means 203, and at the same time, instructs the database managing means 203 to determine whether the telephone number of the caller is already registered or not. In response to this, the database managing means 203 searches the user information database 203, and thereby determines whether the telephone number of the caller is already registered or not (S22).

When the database managing means 203 determines that the telephone number is already registered, the procedure goes to S23. When not yet registered, the procedure goes to S36.

InS23, when the database managing means 203 determines that the telephone number is already registered, the database managing means 203 notifies the determination result of registered status to the guidance means 202.

When receiving the notification of registered status from the database managing means 203, the guidance means 202 wait for a predetermined time duration, for example, three seconds, for causing the user to terminate the telephone call (S24).

Described below at first is the case (S25) that the user has terminated the telephone call within a predetermined time duration after the telephone receiving means 7 has detected the telephone call. After that, described later is the case (S26) that the user did not terminate the telephone call within the predetermined time duration after the telephone receiving means 7 has detected the telephone call.

In S25, when the user has terminated the telephone call within a predetermined time duration after the telephone receiving means 7 has detected the telephone call, the procedure goes to S26.

In S26, the guidance means 202 notifies the telephone number of the portable telephone terminal 2 to the database managing means 203, and thereby inquires for the e-mail address corresponding to the portable telephone terminal 2.

Then, the guidance means 202 acquires the e-mail address of the portable telephone terminal 2 as the response from the database managing means 203. The guidance means 202 notifies the acquired e-mail address as well as the telephone number of the telephone destination of the telephone call from the portable telephone terminal 2, to the e-mail transmitting means 11, and thereby instructs the e-mail transmitting means 11 to transmit guidance information.

The e-mail transmitting means 11 reads out guidance information corresponding to the notified telephone number of the telephone destination, from the distributed information database 12, and thereby transmits the read-out guidance information to the notified e-mail address, by e-mail (S28).

The transmitted e-mail is stored in a mail box corresponding to the e-mail address of the portable telephone terminal 2, in the provider 5. The portable telephone terminal 2 downloads the e-mail stored in the mail box, whereby the e-mail reaches the portable telephone terminal 2. As such, the user of the portable telephone terminal 2 acquires the guidance information.

Next, described below is the case S30 that the user did not terminate the telephone call within the predetermined time duration after the telephone receiving means 7 has detected the telephone call.

In this case, the guidance means 202 controls the telephone receiving means 7 so as to go into voice communication of the telephone call, and thereby carries out voice guidance for registration change of the e-mail address in the state of voice communication. Here, the guidance for registration change is the same as that described in Embodiment 11.

Here, it is assumed that the user terminates the voice communication of the telephone call during the S30 operation (S31). Such a situation can occur, for example, when the user merely desires the distribution of guidance information and does not desire to change the e-mail address to a new e-mail address, but when the user has failed to terminate the telephone call within the predetermined time duration. In this case, when detecting the fact that the voice communication has been terminated by the user, the telephone receiving means 7 notifies the fact to the guidance means 202 via the telephone number acquiring means 8. When receiving the notification that the voice communication has been terminated, the guidance means 202 proceeds to S26. Thus, similarly to the above-mentioned case, the e-mail address of the portable telephone terminal 2 is identified in S26, and then guidance information is distributed in S28.

In case that the user did not terminate the voice communication of the telephone call in S31, the procedure goes to S32. In S32, the guidance means 202 carries out voice guidance using a voice message such as the voice message 211 shown in FIG. 27 and the voice message 222 shown in FIG. 30.

After the termination of the voice communication, in response to the guidance message such as the voice message 211 and the voice message 222, the user transmits an e-mail which is blank or contains arbitrary contents, to the e-mail address notified by the voice message 211 or the voice message 222 (S32).

When receiving the e-mail transmitted from the portable telephone terminal 2 of the user in S32, the e-mail receiving means 204 acquires the e-mail address of the portable telephone terminal 2 which is added in the header portion of the e-mail, and then notifies the e-mail address to the guidance means 202. On receiving the notification of the acquired e-mail address from the e-mail address acquiring means 8, the guidance means 202 instructs the e-mail transmitting means 11 to transmit a confirmation e-mail 215 shown in FIG. 29 to the e-mail address notified from the e-mail receiving means 214. In response to this, the e-mail transmitting means 11 transmits a confirmation e-mail 215 to the notified e-mail address. When receiving the transmit confirmation e-mail 215, the user clicks the URL 215 portion of the confirmation e-mail 215. Then, similarly to Embodiment 11, the portable telephone terminal 2 transmits an access request for accessing the Web page corresponding to the URL 215. On receiving the access request, the Web page providing means 214 transmits a telephone number inputting screen 217 shown in FIG. 29(b) to the portable telephone terminal 2 in response to the access request. The user inputs the telephone number 218 in the telephone number inputting screen 217 in the portable telephone terminal 2, and then clicks the transmission button 219. Then, the portable telephone terminal 2 transmits the telephone number to the Web page providing means 214. As such, when the telephone number is input in the Web page by acquiring the URL 216 and the telephone number, the Web page providing means 214 notifies the data to the guidance means 202. The guidance means 202 corresponds the e-mail address of the user and the telephone number input in the telephone number inputting screen 217 to each other using the URL 216, and then registers the data into the user information database 205 in a manner similar to that in Embodiment 11 (S34).

Then, the guidance means 202 instructs the database managing means 203 to search the call history database 206 of a specific time duration before the registration by using the acquired telephone number as the key among the acquired e-mail address and telephone number of the user. In response to this, the database managing means 203 notifies the telephone number of the telephone destination corresponding to a telephone number which coincides with the acquired telephone number; to the guidance means 202 (S35).

The guidance means 202 notifies the telephone number of the telephone destination and the e-mail address of the portable telephone terminal 2, to the e-mail transmitting means 11, and thereby instructs the e-mail transmitting means 11 to transmit guidance information. In S28, the guidance information is transmitted. The subsequent operation is the same as that described above.

Next, the operation subsequent to S36 is described below. In S36, the database managing means 203 determines the telephone number as unregistered.

In this case, the guidance means 202 carries out guidance for registration immediately without the above-mentioned predetermined time duration. That is, a voice message such as the voice message 207 shown in FIG. 27 is sent (S37).

Then, in S38, voice messages for prompting the registration, such as the voice message 209, the voice message 210, and the voice message 211, are sent (S38).

When the user is a free address holder, that is, when the e-mail address of the user cannot be generated from the telephone number according to a predetermined rule (S39) the operation in S32, S33, S34, S35, and S25 is carried out. The operation in these steps is the same as that described above.

In contrast, when the e-mail address of the user can be generated from the telephone number according to a predetermined rule, the operation in S42-S28 is carried out. The operation in these steps is the same as that described in Embodiment 11.

As such, the guidance information is transmitted.

In S31, the description has been made for the case that when the user has terminated the voice communication of the telephone call, the procedure goes to S26, and then the guidance information is transmitted by e-mail. However, in S35, it is assumed that when the user terminates the telephone call at any time before the registration of the telephone number and the e-mail address of the user is completed, the procedure goes to S26.

Meanwhile, the information distribution system according to the present embodiment can be used with various modifications. Examples of such modifications are described below systematically with classification into various items. In the following description, the items are hierarchically classified from higher categories to lower categories. A title is assigned to each item, and the beginning of the title is a combination of numerals indicating the hierarchy from the higher categories to the lower categories. That is, “1” indicates the highest category, while “1-1”, “1-2”, and the like indicates the one-step-lower categories.

(1 Basic System)

A basic system which provides the base for these modifications is described below.

Regarding the basic system, described below are 1-1 Generation of database, 1-2 Preparation of mail information, 1-3 Determination of user, 1-4 Prompt for data registration, 1-5 Delivery of mail information 1, and 1-6 Delivery of mail information 2. (1-1 Generation of Database)

A correspondence database for the telephone numbers and the e-mail addresses of respective users is generated. That is, the user information database 205 shown in FIG. 1 stores the telephone numbers and the e-mail addresses in a form corresponded to each other. By virtue of this, for example, the database managing means 203 can identify a corresponding e-mail address by using a telephone number as the key.

(1-2 Preparation of Mail Information)

Mail boxes are prepared for respective telephone numbers in order to store mails. That is, in the distributed information database 12, a mail box is prepared for each telephone destination through which the telephone receiving means 7 receives telephone calls. Each mail box stores guidance information corresponding to each telephone destination.

(1-3 Determination of User)

In a telephone call from the telephone set of a user to a specific telephone number, the telephone number of the user is readout using number notifying service. Then, using the telephone number as the key, the database managing means 203 determines the registered or unregistered status. The guidance means 202 changes response depending on the determination result.

(1-4 Prompt for Data Registration)

The guidance means 202 provides an easy registration system for unregistered persons in order to prompt for the registration in the database.

(1-5 Delivery of Mail Information 1)

In a telephone call from the telephone set of a user to the telephone number of a specific telephone destination, the telephone number of the user is read out, whereby the mail address is identified using a database such as the user information database 205. Then, corresponding guidance information is distributed.

(1-6 Delivery of Mail Information 2)

The record of use before data registration is saved in the call history database 206. Then, at the time of registration into the user information database 205, the call history database 206 is searched using, as the key, the telephone number to be registered in the user information database 205, whereby distributed is mail information corresponding to the telephone number of the specific telephone destination which has received the telephone call before registration.

(2 Response to Unregistered Person and Database Generation)

Database generation for unregistered persons is described below. Examples of the methods of database generation for unregistered persons include 2-1 Voice guidance method and 2-2 Voice guidance/DTMF (push signal) combined method.

(2-1 Voice Guidance Method)

(2-1-1 Immediate Voice Response)

When a telephone call from a user is detected, and when the user is determined as unregistered in the user information database 205, a voice guidance message is sent immediately. An example of such a voice guidance message is “The person who use this information distribution system needs registration. If your mail address is different from your telephone number, please send a mail to the following address. The address of destination is 0156@0156.co.jp. In response, we would send you a mail for registration. If your mail address is the same as your telephone number, please hang up the line immediately. In response, we would send you a mail for confirmation.”

(2-1-2 Response to Holder of Telephone Number Rule Address)

The following types of response are possible when the e-mail address of the user can be generated from a predetermined rule.

(2-1-2-1 Distribution of Confirmation Mail)

(2-1-2-1-1 Distribution Scheme by Address Identification)

On the basis of the data which permits the identification of the relation among the telephone number, the carrier, and the server name, a mail address is generated with the assumption that the telephone number is still the same. Then, confirmation mail is sent.

(2-1-2-1-2 Distribution Scheme by Virtual Mail Address)

According to the rules of all carriers (telephone companies or the branches thereof) each for generating an address from a telephone number, all possible mail addresses are generated with the assumption that the telephone number is still the same. Then, a plurality of confirmation mails are sent.

(2-1-2-1-3 Distribution Scheme by Combination of Address Identification and Virtual Mail Address)

On the basis of the rule data which permits the identification of the relation among the telephone number, the carrier, and the server name, a possibility range in the mail address is identified with the assumption that the telephone number is still the same. Then, all possible mail addresses are generated, whereby a plurality of confirmation mails are sent.

(2-1-2-2 Contents and Function of Confirmation Mail)

(2-1-2-2-1 Function of Confirmation)

Each confirmation mail is provided with a unique URL. Accordingly, when the URL is clicked, it is confirmed that the mail generated according to the telephone number rule has reached the user. Then, correspondence data for the mail address and the telephone number is generated.

(2-1-2-2-2 Directions for use and Security of Data)

In the confirmation mail, and in the home page linked from the attached URL, directions and conditions for use are described. Examples of such directions and conditions for use are “Once registered, mail information corresponding to each telephone number of destination is obtained merely by a telephone call (ringing only) in the subsequent occasions. Thus, no telephone charge occurs newly”, “The registration is common to all the telephone numbers of destination of the system. Accordingly, no further registration is necessary even when other telephone numbers of destination are used”, and “The information registered in the system, such as the telephone number and the mail address, are secured in the system, and never used for the other purposes”.

(2-1-3 Response to Holder of a Free-Setting Address)

(2-1-3-1 Case of Registration by Mail)

(2-1-3-1-1 Registration Mail Reply Scheme)

The mail address of the user is identified from a mail sent from the user, and then a mail for registration is transmitted. In this mail for registration, the address of the home page for inputting the telephone number is described. When the telephone number is input in the home page, the database is generated.

(2-1-3-1-2 Telephone-Number Inputting Scheme)

When the user sends a mail describing the telephone number, correspondence data for the mail address and the telephone number is generated.

(2-2 Voice Guidance/DTMF (Push Signal) Combined Method)

(2-2-1 Guidance Change by DTMF)

Guidance is carried out such that “If your mail address is still the same as your telephone number, please press ‘1’. Otherwise, please press ‘2’”.

(2-2-1-1 Holder of Telephone Number Rule Address)

The method for registration is announced.

(2-2-1-1-1 Identification of Address)

At the time when “1” is pressed, it is identified as a mail address generated from the telephone number. Then, on the basis of the data which permits the identification of the relation among the telephone number, the carrier, and the server name, a mail address is generated and registered.

(2-2-1-1-2 Confirmation of Virtual Mail Address)

At the time when “1” is pressed, it is identified as a mail address generated from the telephone number. Then, according to the rules of all carriers each for generating an address from a telephone number, all possible mail addresses are generated with the assumption that the telephone number is still the same. Then, a plurality of confirmation mails are sent, whereby registration is carried out after confirmation.

(2-2-1-1-3 Scheme by Combination of Address Identification and Virtual Mail Address)

At the time when “1” is pressed, it is identified as a mail address generated from the telephone number. Then, on the basis of the rule data which permits the identification of the relation among the telephone number, the carrier, and the server name, a possibility range in the mail address is identified with the assumption that the telephone number is still the same. Then, all possible mail addresses are generated, whereby a plurality of confirmation mails are sent.

(2-2-1-2 Response to Holder of Free-Setting Address)

(2-2-1-2-1 Case of Registration by Mail)

The method for registration is announced.

(2-2-1-2-1-1 Registration Mail Reply Scheme)

The mail address of the user is identified from a mail sent from the user, and then a mail for registration is transmitted. In this mail for registration, the address of the home page for inputting the telephone number is described. When the telephone number is input in the home page, the database is generated.

(2-2-1-2-1-2 Telephone-Number Inputting Scheme)

When the user sends a mail describing the telephone number, correspondence data for the mail address and the telephone number is generated.

(2-2-1-2-2 Case of Registration by Voice Input)

The method of voice input is announced sequentially.

(2b-2-1-2-2-1 Full Voice Input Scheme)

The mail address is input fully by voice.

(2-2-1-2-2-2 Scheme by Combination of Voice Input and DTMF)

The former portion (by user setting) of the address is input by voice. In order to reduce the amount of voice input, DTMF is used at the same time. The telephone company is selected, whereby the latter portion of the address is identified.

(3 Response to Registered User)

(3-1 Provision of Time-Out)

Registered users can receive mail information merely by making and soon terminating a telephone call. Further, no telephone charge occurs newly. Thus, time-out is set.

(3-2) Guidance for Registration Change)

After a waiting time, guidance for changing the registered address is announced. The method of registration change is similar to the initial response for a holder of a free-setting address.

(3-2-1-1 Case of Registration by Mail)

(3b-2-1-1-1 Mail Reply Scheme)

(3-2-1-1-2 Telephone-Number Inputting Scheme)

(3-2-1-2 Case of Registration by Voice Input)

(4 Save of Record of use Before Registration and Mail Distribution)

The record of the telephone call from a user before registration into the user information database is saved. After registration, the record is searched using the telephone number of the user as the key, whereby corresponding mail information is distributed.

(5 Change of Mail Information via Web)

(5-1 Registration of Mail Information)

Mail information to be distributed can be registered and changed in a dedicated Web through a personal computer and a portable telephone.

(5-2 Change of Mail Box and Reservation)

A plurality of mail boxes are prepared for storing mail information. By change the mailbox, mail information to be distributed is changed immediately. The function of reservation of such mail box change is also available with respect to the time of day, the day of month, and the day of week.

(6 Determination of Carrier and Change of Attached Home Page Address)

The carrier is determined from the telephone number, whereby the home page address attached to the mail is automatically changed correspondingly to the carrier.

The invention is a program which causes a computer to execute the operation of all or part of the steps (or processes, operations, effects, and the like) in the above-mentioned information distribution method according to the invention, and works in cooperation with the computer.

Further, the invention is a medium carrying a program for causing a computer to execute all or part of the operation of all or part of the steps of the above-mentioned information distribution method according to the invention, wherein: the medium is read out by a computer; and the read-out program works in cooperation with the computer.

Part of the means (or apparatuses, devices, circuits, sections, and the like) according the invention and part of the steps (or processes, operations, effects, and the like) according the invention indicate: a piece or pieces of means among a plurality of pieces of said means and a step or steps among a plurality of said steps; or alternatively, part of function in a piece of means and part of operation in a step, respectively.

The scope of the invention includes also a computer-readable recording medium in which a program according to the invention is recorded.

A mode of use of a program according to the invention may be that the program is recorded in a computer-readable recording medium and works in cooperation with a computer.

A mode of use of a program according to the invention maybe that the program is transmitted through a transmitting medium, read out by a computer, and works in cooperation with the computer.

Data structure according to the invention includes a database, a data format, a data table, a data list, and a data type.

The scope of recording media according to the invention includes a ROM and the like, while the scope of transmitting media according to the invention includes a transmitting medium such as the Internet, as well as light, radio waves, acoustic waves, and the like.

A computer according to the invention is not restricted to genuine hardware such as a CPU, and may be firmware, an OS, and a peripheral device.

As described above, a configuration according to the invention may be implemented by software or hardware.

### FIELD OF INDUSTRIAL USE

As seen from the above-mentioned description, the present invention permits: a system for providing desired information easily; an information distribution method; an information distribution system; a third apparatus; a medium; an information set; and a program.

The invention permits: a system having good usability for users and information distributors; an information distribution method; an information distribution system; a third apparatus; a medium; an information set; and a program.

The invention permits: a system capable of distributing area-specific information; an information distribution method; an information distribution system; a third apparatus; a medium; an information set; and a program.

The invention permits: a system capable of transmitting information for the safety of sufferers accurately and rapidly to the sufferers in case of a serious natural disaster; an information distribution method; an information distribution system; a third apparatus; a medium; an information set; and a program.

1. An information distribution method comprising the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said user has terminated said telephone call before the elapse of said predetermined time duration, searching said data base on the basis of said telephone number of said caller, and thereby transmitting e-mail information to the obtained e-mail address.

2. An information distribution method comprising the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

3. An information distribution method comprising the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said data base on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

4. An information distribution method comprising the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, without any predetermined time duration for causing said user to terminate said telephone call, carrying out registration change guidance for causing said user to notify a new e-mail address for registration change;
when said telephone number of said caller is determined as registered, and when said user has terminated said telephone call, searching said database on the basis of said telephone number of said caller, and thereby transmitting e-mail information to the obtained e-mail address; and
when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

5. An information distribution method According to any of claims 1-4 wherein:
when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; and
when said telephone number of said caller is determined as unregistered, and when said e-mail address has been already notified according to said predetermined method on the basis of said guidance, said telephone number of said telephone destination corresponding to the telephone number corresponding to said notified e-mail address is identified by searching said second database, whereby e-mail information depending on said telephone number of said telephone destination is transmitted to said notified e-mail address.

6. An information distribution system comprising:
a first apparatus for storing a database generated in advance for corresponding telephone numbers and e-mail addresses to each other;
a second apparatus, on receiving a telephone call from a user, for searching said database of said first apparatus on the basis of the telephone number of the caller of said telephone call, and thereby determining whether said telephone number of said caller is registered or unregistered; and
a third apparatus, when said telephone number of said caller is determined as unregistered, for carrying out initial registration guidance for causing said user to notify an e-mail address, further
when said telephone number of said caller is determined as registered, after a predetermined time duration for causing said user to terminate said telephone call, carrying out registration change guidance for causing said user to notify a new e-mail address for registration change, and further
when said user has terminated said telephone call before the elapse of said predetermined time duration, searching said database on the basis of said telephone number of said caller, and thereby transmitting e-mail information to the obtained e-mail address.

7. An information distribution system comprising:
a first apparatus for storing a database generated in advance for corresponding telephone numbers and e-mail addresses to each other;
a second apparatus, on receiving a telephone call from a user, for searching said database on the basis of the telephone number of the caller of said telephone call, and thereby determining whether said telephone number of said caller is registered or unregistered; and
a third apparatus, when said telephone number of said caller is determined as unregistered, for carrying out initial registration guidance for causing said user to notify an email address, further
when said telephone number of said caller is determined as registered, after a predetermined time duration for causing said user to terminate said telephone call, carrying out registration change guidance for causing said user to notify a new e-mail address for registration change, and further
when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

8. An information distribution system comprising:
a first apparatus for storing a database generated in advance for corresponding telephone numbers and e-mail addresses to each other;
a second apparatus, on receiving a telephone call from a user, for searching said database on the basis of the telephone number of the caller of said telephone call, and thereby determining whether said telephone number of said caller is registered or unregistered; and
a third apparatus, when said telephone number of said caller is determined as unregistered, for carrying out initial registration guidance for causing said user to notify an e-mail address, further
when said telephone number of said caller is determined as registered, after a predetermined time duration for causing said user to terminate said telephone call, carrying out registration change guidance for causing said user to notify a new e-mail address for registration change, and further
when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

9. An information distribution system comprising:
a first apparatus for storing a database generated in advance for corresponding telephone numbers and e-mail addresses to each other;
a second apparatus, on receiving a telephone call from a user, for searching said database on the basis of the telephone number of the caller of said telephone call, and thereby determining whether said telephone number of said caller is registered or unregistered; and
a third apparatus, when said telephone number of said caller is determined as unregistered, for carrying out initial registration guidance for causing said user to notify an e-mail address, further
when said telephone number of said caller is determined as registered, without any predetermined time duration for causing said user to terminate said telephone call, carrying out registration change guidance for causing said user to notify a new e-mail address for registration change, further
when said telephone number of said caller is determined as registered, and when said user has terminated said telephone call, searching said database on the basis of said telephone number of said caller, and thereby transmitting e-mail information to the obtained e-mail address, and further
when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

10. An information distribution method According to any of claims 6-9 comprising a fourth apparatus in which when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; wherein
when said telephone number of said caller is determined as unregistered, and when said e-mail address has been already notified according to said predetermined method on the basis of said guidance, said third apparatus identifies said telephone number of said telephone destination corresponding to the telephone number corresponding to said notified e-mail address by searching said second database, and thereby transmits e-mail information depending on said telephone number of said telephone destination said notified e-mail address.

11. A third apparatus comprising guidance means of:
on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;
when said telephone number of said caller is determined as registered, after a predetermined time duration for causing said user to terminate said telephone call, carrying out registration change guidance for causing said user to notify a new e-mail address for registration change; and
when said user has terminated said telephone call before the elapse of said predetermined time duration, searching said database on the basis of said telephone number of said caller, and thereby transmitting e-mail information to the obtained e-mail address.

12. A third apparatus comprising guidance means of:
on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

13. A third apparatus comprising guidance means of:
on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

14. A third apparatus comprising guidance means of:
on receiving a telephone call from a user, carrying out initial registration guidance for causing said user to notify an e-mail address, when the telephone number of the caller is determined as unregistered by a second apparatus for searching a database of a first apparatus storing said database generated in advance for corresponding telephone numbers and e-mail addresses to each other, on the basis of the telephone number of the caller of said telephone call, and thereby determining whether said telephone number of said caller is registered or unregistered;
when said telephone number of said caller is determined as registered, without any predetermined time duration for causing said user to terminate said telephone call, carrying out registration change guidance for causing said user to notify a new e-mail address for registration change;
when said telephone number of said caller is determined as registered, and when said user has terminated said telephone call, searching said database on the basis of said telephone number of said caller, and thereby transmitting e-mail information to the obtained e-mail address; and
when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

15. A third apparatus according to any one of claims 11-14, wherein said guidance means:
in said initial registration guidance, when said e-mail address to be notified from said user can be generated from said telephone number of said caller according to a predetermined rule, carries out guidance for termination of voice communication in order to notify the timing of termination of the voice communication of said telephone call; and
in contrast, when said e-mail address to be notified from said user cannot be generated from said telephone number of said caller according to said predetermined rule, carries out guidance for e-mail address input in order to cause said user to notify said e-mail address by a predetermined method.

16. A third apparatus according to any one of claims 11-14, wherein said guidance means:
in said registration change guidance, when said e-mail address to be notified from said user can be generated from said telephone number of said caller according to a predetermined rule, carries out guidance for termination of voice communication in order to notify the timing of termination of the voice communication of said telephone call; and
in contrast, when said e-mail address to be notified from said user cannot be generated from said telephone number of said caller according to said predetermined rule, carries out guidance for e-mail address input in order to cause said user to notify said e-mail address by a predetermined method.

17. A third apparatus according to claim 15 or 16, wherein when said e-mail address to be notified from said user can be generated from said telephone number of said caller according to said predetermined rule, said guidance means transmits a confirmation e-mail to said e-mail address depending on the information on said timing.

18. A third apparatus according to claim 15 or 16, wherein when said e-mail address to be notified from said user can be generated from said telephone number of said caller according to said predetermined rule, said guidance means does not transmit any confirmation e-mail, but generates said e-mail address from said telephone number of said caller according to said predetermined rule, and thereby registers said telephone number of said caller and said generated e-mail address into said database.

19. A third apparatus according to claim 18, wherein when registering into said database, said guidance means further transmits said e-mail information to said e-mail address.

20. A third apparatus according to any one of claims 11-14, wherein said initial registration guidance is carried out in order to inform that when said e-mail address to be notified from said user can be generated from said telephone number of said caller according to a predetermined rule, said e-mail address is not necessary to be notified.

21. A third apparatus according to any one of claims 11-14, wherein said registration change guidance is carried out in order to inform that when said e-mail address to be notified from said user can be generated from said telephone number of said caller according to a predetermined rule, said e-mail address is not necessary to be notified.

22. A third apparatus according to claim 20 or 21, wherein regardless of whether said e-mail address to be notified from said user can be generated from said telephone number of said caller according to said predetermined rule or not, said guidance means generates an e-mail address from said telephone number of said caller according to said predetermined rule, and thereby transmits a confirmation e-mail to the generated e-mail address.

23. A third apparatus according to any one of claims 11-14, wherein said initial registration guidance is carried out in order to cause said user to notify said e-mail address according to a predetermined method, regardless of whether said e-mail address to be notified from said user can be generated from said telephone number of said caller according to a predetermined rule or not.

24. A third apparatus according to any one of claims 11-14, wherein said registration change guidance is carried out in order to cause said user to notify said e-mail address according to a predetermined method, regardless of whether said e-mail address to be notified from said user can be generated from said telephone number of said caller according to a predetermined rule or not.

25. A third apparatus according to any one of claims 11-14, wherein when receiving said e-mail address notified according to said guidance, said guidance means transmits said e-mail information to the notified e-mail address.

26. A third apparatus according to claim 17 or 22, wherein in said transmission of said confirmation e-mail, when a plurality of e-mail addresses can be generated from said telephone number of said caller according to said predetermined rule, said guidance means transmits said confirmation e-mail to said plurality of e-mail addresses.

27. A third apparatus according to claim 17, 22, or 26, wherein in said transmission of said confirmation e-mail, said guidance means transmits said confirmation e-mail, and further transmits said e-mail information before or after the completion of the confirmation based on said confirmation e-mail.

28. A third apparatus according to any one of claims 11-27, wherein said guidance is carried out using at least one or more of a voice message, an e-mail, and a Web page.

29. A third apparatus according to any one of claims 11-24, wherein said predetermined method is the method of receiving said e-mail address by voice recognition of a voice message from said user.

30. A third apparatus according to any one of claims 11-24, wherein said predetermined method is the method of receiving said e-mail address by e-mail and/or Web page.

31. A third apparatus according to claim 30, wherein said predetermined method is the method in which: a first e-mail address is notified to said user; and then, when said user has transmitted a first e-mail having blank contents or arbitrary contents to said first e-mail address, a second e-mail is transmitted to the e-mail address of the sender added in the received first e-mail.

32. A third apparatus according to claim 31, wherein said second e-mail contains, as an attachment, the address of a predetermined Web page corresponding to said e-mail address of said sender of said first e-mail, and wherein
said predetermined method is the method in which: after said transmission of said second e-mail, when said user having received said second e-mail inputs a telephone number by accessing said predetermined Web page according to said address of said predetermined Web page, said e-mail address of said sender is identified on the basis of said address of said predetermined Web page contained in the access request issued for said access; and then
said input telephone number and said e-mail address of said sender are registered into said database.

33. A third apparatus according to claim 31, wherein said predetermined method is the method in which after said transmission of said second e-mail, when said user having received said second e-mail replies an e-mail to which a telephone number is attached, said telephone number attached to said replied e-mail and the e-mail address of the sender added in said replied e-mail are registered in a form corresponded to each other into said database.

34. A third apparatus according to any one of claims 11-24, wherein in said transmission of said confirmation e-mail, said guidance means: transmits said confirmation e-mail with attaching the address of a predetermined Web page corresponding to said telephone number of said caller; and then
when said user having received said confirmation e-mail issues an access request to said predetermined Web page, identifies said telephone number of said caller on the basis of said address of said predetermined Web page contained in said access request, and then registers said identified telephone number of said caller and an e-mail address generated from said telephone number of said caller according to a predetermined rule in a form corresponded to each other into said database.

35. A third apparatus according to any one of claims 11-24, wherein after said transmission of said confirmation e-mail, when said user having received said confirmation e-mail transmits a reply e-mail in response to said confirmation e-mail, said guidance means identifies said telephone number of said caller from the e-mail address of the sender added in said reply e-mail, according to said predetermined rule, and then
registers said identified telephone number and said e-mail address of said sender into said database.

36. A third apparatus according to any one of claims 11-35 comprising a fourth apparatus in which when there are a plurality of telephone destinations, and when e-mail information is transmitted depending on the telephone numbers of said telephone destinations, at each time when any one of said telephone destinations receives a telephone call from said user, the telephone number of the caller of said telephone call and the telephone number of the telephone destination having received said telephone call are stored in a form corresponded to each other in a second database for a predetermined time duration; wherein
when said telephone number of said caller is determined as unregistered, and when said e-mail address has been already notified according to said predetermined method on the basis of said guidance, said guidance means identifies said telephone number of said telephone destination corresponding to the telephone number corresponding to said notified e-mail address by searching said second database, and thereby transmits e-mail information depending on said telephone number of said telephone destination said notified e-mail address.

37. A computer-processable medium carrying a program for causing a computer to execute, in the information distribution method according to claim 1, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said user has terminated said telephone call before the elapse of said predetermined time duration, searching said database on the basis of said telephone number of said caller, and thereby transmitting e-mail information to the obtained e-mail address.

38. A computer-processable medium carrying a program for causing a computer to execute, in the information distribution method according to claim 2, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

39. A computer-processable medium carrying a program for causing a computer to execute, in the information distribution method according to claim 3, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

40. A computer-processable medium carrying a program for causing a computer to execute, in the information distribution method according to claim 4, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, without any predetermined time duration for causing said user to terminate said telephone call, carrying out registration change guidance for causing said user to notify a new e-mail address for registration change;
when said telephone number of said caller is determined as registered, and when said user has terminated said telephone call, searching said database on the basis of said telephone number of said caller, and thereby transmitting e-mail information to the obtained e-mail address; and
when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

41. A program for causing a computer to execute, in the information distribution method according to claim 1, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said user has terminated said telephone call before the elapse of said predetermined time duration, searching said database on the basis of said telephone number of said caller, and thereby transmitting e-mail information to the obtained e-mail address.

42. A program for causing a computer to execute, in the information distribution method according to claim 2, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, regardless of whether said registration change guidance has not yet begun, has already begun, or has already completed, when said user has terminated said telephone call, searching said database on the basis of said telephone number of said caller, and thereby transmitting e-mail information to the obtained e-mail address.

43. A program for causing a computer to execute, in the information distribution method according to claim 3, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, after a predetermined time duration for causing said user to terminate said telephone call, carrying out registration change guidance for causing said user to notify a new e-mail address for registration change; and
when said telephone number of said caller is determined as registered, and when said registration change guidance is guidance for causing said user to notify a new e-mail address for registration change during the voice communication of said telephone call, if said new e-mail address for registration change is not yet notified at the time when said user has terminated said telephone call, searching said database on the basis of said telephone number of said caller and thereby transmitting e-mail information to the obtained e-mail address, in contrast, if said new e-mail address for registration change is already notified at the time when said user has terminated said telephone call, not transmitting said e-mail information to the e-mail address older than said notified e-mail address.

44. A program for causing a computer to execute, in the information distribution method according to claim 4, all or part of the steps of:
generating a database for corresponding telephone numbers and e-mail addresses to each other, in advance;
on receiving a telephone call from a user, searching said database on the basis of the telephone number of the caller of said telephone call, and thereby determining whether said telephone number of said caller is registered or unregistered;
when said telephone number of said caller is determined as unregistered, carrying out initial registration guidance for causing said user to notify an e-mail address;
when said telephone number of said caller is determined as registered, without any predetermined time duration for causing said user to terminate said telephone call, carrying out registration change guidance for causing said user to notify a new e-mail address for registration change;
when said telephone number of said caller is determined as registered, and when said user has terminated said telephone call, searching said database on the basis of said telephone number of said caller, and thereby transmitting e-mail information to the obtained e-mail address; and
when said telephone number of said caller is determined as registered, and when said registration change guidance is guidance for causing said user to notify a new e-mail address for registration change during the voice communication of said telephone call, if said new e-mail address for registration change is already notified at the time when said user has terminated said telephone call, not transmitting said e-mail information to the e-mail address older than said notified e-mail address.

45. A system comprising:
an info-communication terminal for carrying out info-communications through a telephone network; and
information distributing means of distributing first information to an e-mail address corresponding to said info-communication terminal; wherein
when said info-communication terminal makes a telephone call to a predetermined telephone number,
said information distributing means distributes said first information by e-mail to said e-mail address corresponding to said info-communication terminal generated from the telephone number of said info-communication terminal according to a predetermined rule.

46. A system according to claim 45 comprising e-mail address generating means of generating said e-mail address corresponding to said info-communication terminal from said info-communication terminal according to said predetermined rule.

47. A system according to claim 45 or 46 comprising receiving means of receiving said telephone call from said info-communication terminal to said predetermined telephone number.

48. A system comprising information distributing means of, when an info-communication terminal for carrying out info-communications through a telephone network makes a telephone call to a predetermined telephone number, distributing first information to an e-mail address corresponding to said info-communication terminal generated from the telephone number of said info-communication terminal according to a predetermined rule.

49. A system comprising e-mail address generating means of, when an info-communication terminal for carrying out info-communications through a telephone network makes a telephone call to a predetermined telephone number, generating an e-mail address corresponding to said info-communication terminal from the telephone number of said info-communication terminal according to a predetermined rule, wherein
first information is distributed to said generated e-mail address.

50. A system comprising receiving means of receiving a telephone call, when an info-communication terminal for carrying out info-communications through a telephone network makes said telephone call to a predetermined telephone number, wherein:
an e-mail address corresponding to said info-communication terminal is generated from the telephone number of said info-communication terminal according to a predetermined rule; and
first information is distributed to said generated e-mail address.

51. A system comprising:
e-mail address generating means of, when an info-communication terminal for carrying out info-communications through a telephone network makes a telephone call to a predetermined telephone number, generating an e-mail address corresponding to said info-communication terminal from the telephone number of said info-communication terminal according to a predetermined rule; and
information distributing means for distributing first information to said generated e-mail address.

52. A system comprising:
receiving means of receiving a telephone call, when an info-communication terminal for carrying out info-communications through a telephone network makes said telephone call to a predetermined telephone number; and
e-mail address generating means of generating an e-mail address corresponding to said info-communication terminal from the telephone number of said info-communication terminal according to a predetermined rule; wherein
first information is distributed to said generated e-mail address.

53. A system comprising:
receiving means of receiving a telephone call, when an info-communication terminal for carrying out info-communications through a telephone network makes said telephone call to a predetermined telephone number; and
information distributing means of distributing first information to an e-mail address corresponding to said info-communication terminal generated from the telephone number of said info-communication terminal according to a predetermined rule.

54. A system of an info-communication terminal comprising:
telephone calling means of making a telephone call to a predetermined telephone number; and
e-mail acquiring means of acquiring first information; wherein
when said telephone calling means makes a telephone call to a predetermined telephone number,
said first information is distributed by e-mail to an e-mail address corresponding to said info-communication terminal generated from the telephone number of said info-communication terminal according to a predetermined rule.

55. A system comprising information providing means of providing the browse address of an Internet information providing site which provides information on a predetermined item, as second information to an info-communication terminal via said Internet, wherein:
when said info-communication terminal makes a telephone call to a predetermined telephone number, an e-mail address corresponding to said info-communication terminal is generated from the telephone number of said info-communication terminal according to a predetermined rule, and then first information is distributed to said generated e-mail address;
said distributed first information describes a browse address used for accessing said system; and
said info-communication terminal accesses an information distribution server on the basis of said first information.

56. A system according to any one of claims 45-55 wherein:
a plurality of e-mail addresses are generated corresponding to said info-communication terminal; and
said first information is distributed to said plurality of e-mail addresses.

57. A system according to any one of claims 45-56, wherein the amount and/or the contents of said first information are changed depending on the telephone number of said info-communication terminal, said predetermined rule, or said e-mail address.

58. A system according to any one of claims 45-57, wherein said e-mail address of said info-communication terminal is determined using also a first table for corresponding the telephone number and the e-mail address of said info-communication terminal to each other.

59. A system according to claim 58, wherein when said distribution of said first information was successful, generated is a second table for corresponding said e-mail address and the telephone number of said info-communication terminal corresponding to said e-mail address to each other.

60. A system according to claim 59 wherein:
said e-mail address corresponding to said telephone number of said info-communication terminal is acquired by searching said first table and/or said second table, and then said first information is distributed to said acquired e-mail address; and
when said e-mail address corresponding to said telephone number of said info-communication terminal cannot be acquired by searching said first table and/or said second table, the e-mail address of said info-communication terminal is generated from said telephone number of said info-communication terminal according to a predetermined rule, and then said first information is distributed to said generated e-mail address.

61. A system according to claim 59, wherein after said first information is distributed to said e-mail address generated according to said predetermined rule, said e-mail address corresponding to said telephone number of said info-communication terminal is acquired by searching said first table and/or said second table, and then said first information is distributed also to said acquired e-mail address.

62. A system according to claim 59 wherein:
said e-mail address corresponding to said telephone number of said info-communication terminal is acquired by searching said first table and/or said second table; and
said first information is distributed to said acquired e-mail address and said e-mail address generated according to said predetermined rule.

63. A system according to any one of claims 58-62 wherein:
said e-mail address corresponding to said telephone number of said info-communication terminal is acquired by searching said first table or said second table, and then said first information is distributed to said acquired e-mail address; and
when said distribution of said first information to said e-mail address was unsuccessful, said e-mail address is deleted from said first table or said second table.

64. A system according to any one of claims 58-63, wherein when said distribution of said first information to said e-mail address generated according to said predetermined rule was successful, and when said e-mail address is thereby registered into said first table and/or said second table, and further when an e-mail address corresponding to said telephone number of said info-communication terminal is already registered in said first table and/or said second table, said e-mail address presently registered is updated into said e-mail address to which said distribution of said first information was successful.

65. A system according to any one of claims 45-64 wherein:
there are a plurality of said predetermined telephone numbers; and
said info-communication terminal selects desired said first information by selecting a telephone number to which a telephone call is made among said plurality of telephone numbers.

66. A system according to claim 65, wherein said plurality of telephone numbers can be specified by selection numbers.

67. A system according to any one of claims 45-66 wherein:
said info-communication terminal can be connected to the Internet; and
said first information describes the browse address used for accessing said Internet information providing site which provides information on a predetermined item.

68. A system according to claim 67, wherein
said first information is in a hierarchical form, and wherein
when there are a plurality of predetermined telephone numbers:
each of said plurality of predetermined telephone numbers is corresponded to each of said hierarchical first information items;
a portion of said first information describes said predetermined telephone number used for obtaining said first information in the lower hierarchy; and
the other portion of said first information describes the browse address used for accessing said Internet information providing site.

69. A system according to any one of claims 45-66, wherein said first information describes information on a predetermined item.

70. A system according to any one of claim 65 or 66, wherein all or part of said first information describes all or part of said plurality of telephone numbers.

71. A system according to claim 70 wherein:
said first information is in a hierarchical form;
each of said plurality of predetermined telephone numbers is corresponded to each of said hierarchical first information items;
a portion of said first information describes said predetermined telephone number used for obtaining said first information in the lower hierarchy; and
the other portion of said first information describes information on a predetermined item.

72. A system according to any one of claims 45-66 wherein:
said info-communication terminal can be connected to the Internet;
said first information describes the browse address used for accessing an information distribution server which provides, as second information to said info-communication terminal via the Internet, the browse address of said Internet information providing site which provides information on a predetermined item;
said info-communication terminal access said information distribution server on the basis of said first information; and
said second information is provided from said information distribution server to said info-communication terminal.

73. A system according to claim 72, wherein said second information is provided to said info-communication terminal by e-mail.

74. A system according to claim 72, wherein said second information is provided to said info-communication terminal by Web page.

75. A system according to any one of claims 72-74, wherein said first information and/or said second information are in a hierarchical form.

76. A system according to any one of claims 45-67, 69, and 72-75 comprising voice guidance means of sending a voice guidance message when said info-communication terminal makes a telephone call to said predetermined telephone number, wherein
said info-communication terminal selects desired first information according to said voice guidance message.

77. A system according to claim 47, 50, 52, or 53 wherein:
said receiving means acquires the telephone number of said info-communication terminal on the basis of said telephone call from said info-communication terminal according to number notifying service; and
an e-mail address corresponding to said info-communication terminal is generated from said acquired telephone number.

78. A system according to claim 77, wherein when a predetermined time duration has been elapsed after a telephone call from said info-communication terminal is received, said receiving means replies to said telephone call, and after that, terminates the voice communication.

79. A computer-processable medium carrying a program and/or data for causing a computer to execute all or part of the function of all or part of said means and said info-communication terminal of said system according to any one of claims 45-78.

80. An information set composed of a program and/or data for causing a computer to execute all or part of the function of all or part of said means and said info-communication terminal of said system according to any one of claims 45-78.
